(19) United States
(12) Patent Application Publication
(10) Pub. No.: US 2024/0253309 A1
(43) Pub. Date: Aug. 1, 2024

(54) Methods for three-dimensional printing

(71) Applicant: Robert Karklinsh, Aljada (AE)

(72) Inventor: Robert Karklinsh, Aljada (AE)

(21) Appl. No.: 18/097,464

(22) Filed: Jan. 16, 2023

(51) Int. Cl. B29C 64/336; B29C 64/118; B33Y 10/00; B33Y 40/00

(52) U.S. Cl. CPC B29C 64/336; B29C 64/118; B33Y 10/00; B33Y 40/00; B29K 2075/00

(57) ABSTRACT

Methods for additive manufacturing of objects comprising a polymeric foam are disclosed and comprise extruding a mixture of a base polymer and a foaming agent that are provided in the form of at least one feedstock material, the mixture produced by admixing the base polymer and the foaming agent within a polymer processing space of an extruder by an independent mixing rotor, and further comprise sequentially depositing multiple layers of the mixture to form a three-dimensional object. Heating of the mixture to cause activation of the foaming agent and formation of the polymeric foam may be done during the extrusion process or afterward by a separate heating step.

### FIELD OF THE INVENTION

Without limiting the scope of the invention, its background is described in connection with additive manufacturing methods, and more particularly in connection with three-dimensional or 3D printing of polymeric foams.

### BACKGROUND OF THE INVENTION

Despite the widespread use of extrusion-based additive manufacturing for the production of articles from a broad range of polymers, its use for the production of articles from low-density polymeric foams, that is with relative densities below 0.4, is practically absent. This is due to the lack of both processes and materials that make it possible to obtain low-density polymeric foams with stable properties in a wide range of process throughputs.

Most known extrusion-based processes for three-dimensional or 3D printing of polymeric foams use filaments or granules as raw materials. These processes introduce chemical blowing agents into filaments or granules to obtain polymeric foams with relative densities generally above 0.4. Obtaining lower densities can be achieved by using thermally expandable microspheres instead or in addition to chemical blowing agents. Because of the relatively low activation temperatures of thermally expandable microspheres and the degradation of their properties during prolonged exposure to heat, the direct introduction of thermally expandable microspheres into filaments or granules of many commonly used materials is problematic.

In low-throughput extrusion processes, inherent to desktop 3D printing, it is also highly problematic to achieve a substantially uniform spatial distribution of cells in resultant foams and further achieve a substantially uniform distribution of cell sizes therein. This is due to the fact that in such screw extrusion processes a low rotational speed of the screw elements (together with generally very small screw diameters) results in insufficient distributive and dispersive mixing, while the mixing capability of the known filament extrusion processes is non-existent. This is also due to the fact that it is problematic to deliver a foaming agent at an accurately controlled rate to a polymer processing space of low-throughput extruders using standard methods of delivery such as gravimetric or volumetric feeders because such extruders have strict limitations on their mass, dimensions and cost.

Standard deposition rate control methods of extrusion-based 3D printing, where the deposition rate is controlled by controlling the volumetric flow rate, are poorly applicable to polymeric foams. Extrusion of polymeric foams, especially containing expanded microspheres, is highly dependent on process history. Thus, it is impossible to quickly change its volumetric flow rate while keeping the properties of the foam stable.

The state-of-the-art describes using granules coated with thermally expandable microspheres for industrial extrusion and injection molding processes for the manufacture of foamed articles. U.S. Pat. No. 7,202,284 discloses using of granules consisting of a core in the form of thermoplastic polyurethane, thermally expandable microspheres, and a binder that fastens the microspheres to the core. However, this patent only teaches to obtain granules with a highly uneven coated layer that are produced by mixing all the components at an elevated temperature, cooling, and breaking the resulting briquette. Such granules may be prone to premature separation of the coated layer in the feed section of an extruder and may possess a highly nonuniform distribution of the microspheres among granules, thus practically precluding their use to obtain low-density polymeric foams with stable properties in a wide range of process throughputs.

A screw extruder comprising an independently operated dynamic mixer is also generally known in the art. U.S. Pat. No. 4,749,279 describes one example of an extruder comprising a mixing rotor having independent drive means. However, this patent does not teach how to apply such an extruder to 3D printing of polymeric foams.

Certain systems and methods for non-planar 3d printing are also known in the art. U.S. Ser. No. 10/005,126, for example, describes a system and method in which the height differences arising in non-planar 3d printing are removed by applying a correction factor based on the slope of the nominal path. This allows adjusting the vertical position of the nozzle. Such a method may have a limitation of producing print defects in sections containing points of slope discontinuity which naturally arise in three-dimensional models containing sharp height transitions.

The need, therefore, exists for improved methods of three-dimensional printing.

### SUMMARY

The object of the present invention is to provide methods for additive manufacturing of objects, in particular objects comprising a polymeric foam.

In one aspect, the present invention provides a method of additive manufacturing of an object comprising a polymeric foam by sequentially depositing a plurality of layers. The method further comprises providing an extruder having an independent mixing rotor. The method further comprises feeding a base polymer provided in the form of granules and/or a filament and at least one foaming agent to the extruder, wherein the at least one foaming agent is provided in the form of at least one feedstock material selected from a group consisting of: foaming granules, masterbatch granules, and masterbatch filament. The method further comprises admixing the base polymer and the foaming agents by an independent mixing rotor to form a substantially homogeneous mixture of the base polymer and the foaming agents within the polymer processing space of the extruder. The method further comprises activating the at least one foaming agent by heating the mixture within the polymer processing space of the extruder. The method further comprises extruding the polymeric foam by the extruder and depositing the extruded polymeric foam on a deposition surface to form a layer of the three-dimensional object.

In another aspect, the foaming granules are provided comprising a core and a shell at least partially encapsulating the core. The core may further comprise the base polymer and the shell may further comprise the at least one foaming agent. Alternatively, or in addition, the core may further comprise the at least one foaming agent and the shell may further comprise a base polymer. The shell may further comprise the foaming agent in the form of solid particles and a binder system binding the particles to the core.

In another aspect, the present invention provides a method of admixing the base polymer and the foaming agents within the polymer processing space of an extruder by an independent mixing rotor without producing substantial deviations in the discharge pressure. The method may further involve activating the at least one foaming agent within the polymer processing space without producing substantial deviations in the discharge pressure.

In another aspect, the present invention provides a method involving subjecting a stream of the mixture within the polymer processing space of the extruder to a pressure drop rate immediately before the outlet of at least 1 MPa/sec. The method may further include extruding the polymeric foam from the outlet and depositing the polymeric foam on a deposition surface to form a layer of a three-dimensional object.

In another aspect, the present invention provides a method of additive manufacturing of an expanded object comprising a polymeric foam by sequentially depositing a plurality of layers. The method further comprises providing an extruder having an independent mixing rotor. The method further comprises feeding a base polymer provided in the form of granules and/or filament and at least one foaming agent to the extruder, wherein the at least one foaming agent is provided in the form of at least one feedstock material selected from a group consisting of: foaming granules, masterbatch granules, and masterbatch filament. The method further comprises admixing the base polymer and the foaming agents by an independent mixing rotor to form a substantially homogeneous mixture of the base polymer and the foaming agents within the polymer processing space of the extruder. The method further includes extruding the mixture containing at least one partially activated and/or non-activated foaming agent, depositing the extruded mixture on a deposition surface to form a layer of an as-printed object, and a step of activating the foaming agent after deposition by external heating thereby expanding the as-printed object to form the resultant expanded object.

In another aspect, the present invention provides a method comprising a step of controlling the deposition rate by controlling the speed of relative movement between a nozzle and a build surface whilst keeping the extrusion volumetric flow rate substantially constant.

In further aspects of the invention, a method for fabricating a three-dimensional object by sequentially depositing multiple layers of a deposition material may include the following steps:
(a) slicing a computerized model of the three-dimensional object into a finite number of layers comprising at least one non-planar layer;
(b) calculating a nominal tool path for the at least one non-planar layer;
(c) depositing the extruded material on a deposition surface by moving the nozzle relative to the deposition surface to form a non-planar layer of the three-dimensional object;
wherein the horizontal position of the nozzle is adjusted relative to the nominal tool path in direction and by distance dependent on whether the nozzle moves uphill or downhill such that to remove differences in thicknesses between the non-planar layer of the computerized model and the non-planar layer of the three-dimensional object caused by tilt of the nozzle relative to the deposition surface.

In further yet aspect of the invention, a method for fabricating a three-dimensional object by sequentially depositing multiple layers of a deposition material may comprise the following steps:
(a) slicing a computerized model of the three-dimensional object into a finite number of layers, wherein the at least one condition is true selected from a group consisting of: maximum layer thickness among all layers is different from the minimum layer thickness among all layers, maximum line width among all layers is different from the minimum line width among all layers.
(b) calculating a tool path and the deposition rate along the tool path as dependent on layer thickness and line width, the tool path comprising at least a first point and a second point, wherein the calculated deposition rate at the second point is higher that the calculated deposition rate at the first point;
(c) extruding the deposition material through an outlet of an extruder nozzle and depositing the extruded deposition material on a deposition surface by moving the extruder nozzle relative to the deposition surface along the tool path to form a layer of the three-dimensional object;
wherein the volumetric flow rate at the outlet of the extruder nozzle while at the first point is substantially equal to the volumetric flow rate at the outlet of the extruder nozzle while at the second point; and
wherein a controller is provided and configured to adjust the movement speed of the extruder nozzle at the second point to be lower than the movement speed thereof at the first point to thereby remove the difference between the deposition rate at the second point and the calculated deposition rate at the second point.

The following listing of exemplary aspects supports and is supported by the disclosure provided herein.

Aspect 1. A method for additive manufacturing of a three-dimensional object by sequentially depositing a plurality of layers, the method comprising:
providing at least one base polymer and at least one foaming agent, in the form of at least one feedstock material;
admixing the at least one base polymer and the at least one foaming agent by a rotating independent mixing rotor of an extruder to form a mixture comprising the at least one base polymer and the at least one foaming agent within a polymer processing space of the extruder;
activating the at least one foaming agent by heating the mixture within the polymer processing space of the extruder to a temperature exceeding the activation temperature of the foaming agent, thereby producing a polymeric foam; and
extruding the polymeric foam through an outlet of the extruder and depositing the extruded polymeric foam on a deposition surface to form a layer of the three-dimensional object;
wherein the independent mixing rotor operates independently and the rotational speed of the independent mixing rotor is higher than 0.3 revolutions per second;
wherein the at least one foaming agent that is activated is selected from a group consisting of: thermally expandable microspheres, chemical blowing agent; and provided in the form of the at least one feedstock material selected from a group consisting of: foaming granules, masterbatch granules, and masterbatch filament.

Aspect 2. The method as in aspect 1, wherein the base polymer is selected from a group consisting of: thermoplastic polyurethane, thermoplastic polyether block amide.

Aspect 3. The method as in aspect 1, wherein the rotational speed of the independent mixing rotor is lower than 120 revolutions per second.

Aspect 4. The method as in aspect 1, wherein the rotational speed of the independent mixing rotor is in a range from 1 revolution per second to 60 revolutions per second.

Aspect 5. The method as in aspect 1, wherein the at least one selected foaming agent that is activated is thermally expandable microspheres.

Aspect 6. The method as in aspect 5, wherein a mass fraction of the expandable microspheres in the mixture is in a range from 2 wt % to 15 wt %.

Aspect 7. The method as in aspect 5, wherein a mass fraction of the expandable microspheres in the mixture is no more than 25 wt %.

Aspect 8. The method as in aspect 6, wherein a mass fraction of the expandable microspheres in the foaming granules is in a range from 2 wt % to 15 wt %.

Aspect 9. The method as in aspect 7, wherein a mass fraction of the expandable microspheres in the foaming granules is no more than 25 wt %.

Aspect 10. The method as in aspect 1, wherein the at least one selected foaming agent that is activated is a chemical blowing agent emitting gas at decomposition temperature.

Aspect 11. The method as in aspect 1, wherein the independent mixing rotor is rotatably mounted within a mixing chamber.

Aspect 12. The method as in aspect 11, wherein at least one stream of the at least one feedstock material in a downstream direction towards the mixing chamber is established by at least one pressure generating mechanism of the extruder.

Aspect 13. The method as in aspect 12, wherein a fluid phase of the at least one stream comprising the base polymer is established by melting the base polymer with temperature controls units thermally coupled to the polymer processing space of the extruder.

Aspect 14. The method as in aspect 13, wherein the at least one foaming agent is admixed with the fluid phase by the rotating independent mixing rotor within the mixing chamber to form a stream of the mixture.

Aspect 15. The method as in aspect 14, wherein the rotational speed of the independent mixing rotor is lower than 120 revolutions per second.

Aspect 16. The method as in aspect 14, wherein the stream of the mixture is subjected to a pressure drop rate of at least 1 MPa/sec immediately before the outlet of the extruder.

Aspect 17. The method as in aspect 1, wherein the at least one selected foaming agent that is activated is provided in the form of the foaming granules comprising a core and a shell at least partially encapsulating the core.

Aspect 18. The method as in aspect 17, wherein the core comprises the at least one base polymer and the shell comprises a carrier material and the foaming agent dispersed in the carrier material.

Aspect 19. The method as in aspect 17, wherein the shell comprises the at least one base polymer and the core comprises a carrier material and the foaming agent dispersed in the carrier material.

Aspect 20. The method as in aspect 17, wherein the core comprises the at least one base polymer and the shell comprises the foaming agent in the form of solid particles and further comprises a binder system binding the particles to the core.

Aspect 21. The method as in aspect 20, wherein the shell substantially encapsulates the core.

Aspect 22. The method as in aspect 20, wherein the shell thickness is in a range from 0.01 mm to 1 mm.

Aspect 23. The method as in aspect 20, wherein a mass fraction of the binder system in the foaming granules is no more than 11 wt %.

Aspect 24. The method as in aspect 1, wherein the masterbatch granules and the at least one feedstock material comprising the at least one base polymer are fed into separate inlets of the extruder, the at least one selected foaming agent that is activated is provided in the form of the masterbatch granules.

Aspect 25. The method as in aspect 1, wherein the masterbatch filament and the at least one feedstock material comprising the at least one base polymer are fed into separate inlets of the extruder, the at least one selected foaming agent that is activated is provided in the form of the masterbatch filament.

Aspect 26. The method as in aspect 1, wherein a relative density of the deposited polymeric foam is in a range from 0.09 to 0.56.

Aspect 27. The method as in aspect 26, wherein a volumetric flow rate of extrusion is in a range from 0.2 cm³/min to 20 cm³/min.

Aspect 28. The method as in aspect 26, wherein a volumetric flow rate of extrusion is in a range from 0.2 cm³/min to 5 cm³/min.

Aspect 29. The method as in aspect 1, wherein a relative density of the deposited polymeric foam is in a range from 0.14 to 0.4

Aspect 30. The method as in aspect 29, wherein a volumetric flow rate of extrusion is in a range from 0.2 cm³/min to 20 cm³/min.

Aspect 31. The method as in aspect 29, wherein a volumetric flow rate of extrusion is in a range from 0.2 cm³/min to 5 cm³/min.

Aspect 32. The method as in aspect 1, wherein a relative density of the deposited polymeric foam is in a range from 0.14 to 0.35.

Aspect 33. The method as in aspect 32, wherein a volumetric flow rate of extrusion is in a range from 0.2 cm³/min to 20 cm³/min.

Aspect 34. The method as in aspect 32, wherein a volumetric flow rate of extrusion is in a range from 0.2 cm³/min to 5 cm³/min.

Aspect 35. The method as in aspect 1, wherein a relative density of the deposited polymeric foam is in a range from 0.14 to 0.3.

Aspect 36. The method as in aspect 35, wherein a volumetric flow rate of extrusion is in a range from 0.2 cm³/min to 20 cm³/min.

Aspect 37. The method as in aspect 35, wherein a volumetric flow rate of extrusion is in a range from 0.2 cm³/min to 5 cm³/min.

Aspect 38. The method as in aspect 1, wherein a relative density of the deposited polymeric foam is in a range from 0.14 to 0.25.

Aspect 39. The method as in aspect 38, wherein a volumetric flow rate of extrusion is in a range from 0.2 cm³/min to 20 cm³/min.

Aspect 40. The method as in aspect 38, wherein a volumetric flow rate of extrusion is in a range from 0.2 cm³/min to 5 cm³/min.

Aspect 41. The method as in aspect 5, wherein a relative density of the deposited polymeric foam is in a range from 0.09 to 0.56.

Aspect 42. The method as in aspect 41, wherein a volumetric flow rate of extrusion is in a range from 0.2 cm³/min to 20 cm³/min.

Aspect 43. The method as in aspect 42, wherein the rotational speed of the independent mixing rotor is in a range from 1 revolution per second to 60 revolutions per second.

Aspect 44. The method as in aspect 41, wherein a volumetric flow rate of extrusion is in a range from 0.2 cm³/min to 5 cm³/min.

Aspect 45. The method as in aspect 44, wherein the rotational speed of the independent mixing rotor is in a range from 1 revolution per second to 60 revolutions per second.

Aspect 46. The method as in aspect 5, wherein a relative density of the deposited polymeric foam is in a range from 0.14 to 0.4.

Aspect 47. The method as in aspect 46, wherein a volumetric flow rate of extrusion is in a range from 0.2 cm³/min to 20 cm³/min.

Aspect 48. The method as in aspect 47, wherein the rotational speed of the independent mixing rotor is in a range from 1 revolution per second to 60 revolutions per second.

Aspect 49. The method as in aspect 46, wherein a volumetric flow rate of extrusion is in a range from 0.2 cm³/min to 5 cm³/min.

Aspect 50. The method as in aspect 49, wherein the rotational speed of the independent mixing rotor is in a range from 1 revolution per second to 60 revolutions per second.

Aspect 51. The method as in aspect 5, wherein a relative density of the deposited polymeric foam is in a range from 0.14 to 0.35.

Aspect 52. The method as in aspect 51, wherein a volumetric flow rate of extrusion is in a range from 0.2 cm³/min to 20 cm³/min.

Aspect 53. The method as in aspect 52, wherein the rotational speed of the independent mixing rotor is in a range from 1 revolution per second to 60 revolutions per second.

Aspect 54. The method as in aspect 51, wherein a volumetric flow rate of extrusion is in a range from 0.2 cm³/min to 5 cm³/min.

Aspect 55. The method as in aspect 54, wherein the rotational speed of the independent mixing rotor is in a range from 1 revolution per second to 60 revolutions per second.

Aspect 56. The method as in aspect 5, wherein a relative density of the deposited polymeric foam is in a range from 0.14 to 0.3.

Aspect 57. The method as in aspect 56, wherein a volumetric flow rate of extrusion is in a range from 0.2 cm³/min to 20 cm³/min.

Aspect 58. The method as in aspect 57, wherein the rotational speed of the independent mixing rotor is in a range from 1 revolution per second to 60 revolutions per second.

Aspect 59. The method as in aspect 56, wherein a volumetric flow rate of extrusion is in a range from 0.2 cm³/min to 5 cm³/min.

Aspect 60. The method as in aspect 59, wherein the rotational speed of the independent mixing rotor is in a range from 1 revolution per second to 60 revolutions per second.

Aspect 61. The method as in aspect 5, wherein a relative density of the deposited polymeric foam is in a range from 0.14 to 0.25.

Aspect 62. The method as in aspect 61, wherein a volumetric flow rate of extrusion is in a range from 0.2 cm³/min to 20 cm³/min.

Aspect 63. The method as in aspect 62, wherein the rotational speed of the independent mixing rotor is in a range from 1 revolution per second to 60 revolutions per second.

Aspect 64. The method as in aspect 61, wherein a volumetric flow rate of extrusion is in a range from 0.2 cm³/min to 5 cm³/min.

Aspect 65. The method as in aspect 64, wherein the rotational speed of the independent mixing rotor is in a range from 1 revolution per second to 60 revolutions per second.

Aspect 66. The method as in aspect 2, wherein the at least one selected foaming agent that is activated is thermally expandable microspheres.

Aspect 67. The method as in aspect 66, wherein a relative density of the deposited polymeric foam is in a range from 0.09 to 0.56.

Aspect 68. The method as in aspect 67, wherein a volumetric flow rate of extrusion is in a range from 0.2 cm³/min to 20 cm³/min.

Aspect 69. The method as in aspect 68, wherein the rotational speed of the independent mixing rotor is in a range from 1 revolution per second to 60 revolutions per second.

Aspect 70. The method as in aspect 67, wherein a volumetric flow rate of extrusion is in a range from 0.2 cm³/min to 5 cm³/min.

Aspect 71. The method as in aspect 70, wherein the rotational speed of the independent mixing rotor is in a range from 1 revolution per second to 60 revolutions per second.

Aspect 72. The method as in aspect 66, wherein a relative density of the deposited polymeric foam is in a range from 0.14 to 0.4.

Aspect 73. The method as in aspect 72, wherein a volumetric flow rate of extrusion is in a range from 0.2 cm³/min to 20 cm³/min.

Aspect 74. The method as in aspect 73, wherein the rotational speed of the independent mixing rotor is in a range from 1 revolution per second to 60 revolutions per second.

Aspect 75. The method as in aspect 72, wherein a volumetric flow rate of extrusion is in a range from 0.2 cm³/min to 5 cm³/min.

Aspect 76. The method as in aspect 75, wherein the rotational speed of the independent mixing rotor is in a range from 1 revolution per second to 60 revolutions per second.

Aspect 77. The method as in aspect 66, wherein a relative density of the deposited polymeric foam is in a range from 0.14 to 0.35.

Aspect 78. The method as in aspect 77, wherein a volumetric flow rate of extrusion is in a range from 0.2 cm³/min to 20 cm³/min.

Aspect 79. The method as in aspect 78, wherein the rotational speed of the independent mixing rotor is in a range from 1 revolution per second to 60 revolutions per second.

Aspect 80. The method as in aspect 77, wherein a volumetric flow rate of extrusion is in a range from 0.2 cm³/min to 5 cm³/min.

Aspect 81. The method as in aspect 80, wherein the rotational speed of the independent mixing rotor is in a range from 1 revolution per second to 60 revolutions per second.

Aspect 82. The method as in aspect 66, wherein a relative density of the deposited polymeric foam is in a range from 0.14 to 0.3.

Aspect 83. The method as in aspect 82, wherein a volumetric flow rate of extrusion is in a range from 0.2 cm³/min to 20 cm³/min.

Aspect 84. The method as in aspect 83, wherein the rotational speed of the independent mixing rotor is in a range from 1 revolution per second to 60 revolutions per second.

Aspect 85. The method as in aspect 82, wherein a volumetric flow rate of extrusion is in a range from 0.2 cm³/min to 5 cm³/min.

Aspect 86. The method as in aspect 85, wherein the rotational speed of the independent mixing rotor is in a range from 1 revolution per second to 60 revolutions per second.

Aspect 87. The method as in aspect 66, wherein a relative density of the deposited polymeric foam is in a range from 0.14 to 0.25.

Aspect 88. The method as in aspect 87, wherein a volumetric flow rate of extrusion is in a range from 0.1 cm³/min to 20 cm³/min.

Aspect 89. The method as in aspect 88, wherein the rotational speed of the independent mixing rotor is in a range from 1 revolution per second to 60 revolutions per second.

Aspect 90. The method as in aspect 87, wherein a volumetric flow rate of extrusion is in a range from 0.2 cm³/min to 5 cm³/min.

Aspect 91. The method as in aspect 90, wherein the rotational speed of the independent mixing rotor is in a range from 1 revolution per second to 60 revolutions per second.

Aspect 92. The method as in aspect 5, wherein the deposited polymeric foam has a maximum cell size of less than 180 microns.

Aspect 93. The method as in aspect 5, wherein the deposited polymeric foam has a maximum cell size of less than 150 microns.

Aspect 94. The method as in aspect 5, wherein the deposited polymeric foam has an average cell size of less than 100 microns.

Aspect 95. The method as in aspect 5, wherein the deposited polymeric foam has an average cell size of less than 70 microns.

Aspect 96. The method as in aspect 1, wherein at least one layer of the three-dimensional object includes a non-foamed polymeric material.

Aspect 97. The method as in aspect 1, wherein the base polymer is selected from a group consisting of: thermoplastic polyurethane, thermoplastic polyether block amide, polylactide.

Aspect 98. The method as in aspect 1, wherein the base polymer is selected from a group consisting of: thermoplastic polyurethane, thermoplastic polyamide, thermoplastic polyester, thermoplastic polyether block amide, a copolymer of at least one of these polymers.

Aspect 99. A method for additive manufacturing of an expanded three-dimensional object comprising a polymeric foam, the method comprising:
providing at least one base polymer and at least one foaming agent, in the form of at least one feedstock material;
admixing the at least one base polymer and the at least one foaming agent by a rotating independent mixing rotor of an extruder to form a mixture comprising the at least one base polymer and the at least one foaming agent within a polymer processing space of the extruder;
extruding the mixture through an outlet of the extruder and depositing the extruded mixture on a deposition surface to form a layer of an as-printed three-dimensional object;
sequentially depositing a plurality of layers to form the as-printed three-dimensional object; and
heating the as-printed three-dimensional object to activate the at least one foaming agent contained therein to volumetrically expand the as-printed three-dimensional object and form the polymeric foam therein, thereby producing the expanded three-dimensional object;
wherein the independent mixing rotor operates independently and the rotational speed of the independent mixing rotor is higher than 0.3 revolutions per second;
wherein the at least one foaming agent that is activated is selected from a group consisting of: thermally expandable microspheres, chemical blowing agent; and provided in the form of the at least one feedstock material selected from a group consisting of: foaming granules, masterbatch granules, and masterbatch filament.

Aspect 100. The method as in aspect 99, wherein the base polymer is selected from a group consisting of: thermoplastic polyurethane, thermoplastic polyamide, thermoplastic polyester, thermoplastic polyether block amide, a copolymer of at least one of these polymers.

Aspect 101. The method as in aspect 99, wherein the rotational speed of the independent mixing rotor is lower than 120 revolutions per second.

Aspect 102. The method as in aspect 99, wherein the rotational speed of the independent mixing rotor is in a range from 1 revolution per second to 60 revolutions per second.

Aspect 103. The method as in aspect 99, wherein the independent mixing rotor is rotatably mounted within a mixing chamber.

Aspect 104. The method as in aspect 103, wherein at least one stream of the at least one feedstock material in a downstream direction towards the mixing chamber is established by at least one pressure generating mechanism of the extruder.

Aspect 105. The method as in aspect 104, wherein a fluid phase of the at least one stream comprising the base polymer is established by melting the base polymer with temperature controls units thermally coupled to the polymer processing space of the extruder.

Aspect 106. The method as in aspect 105, wherein the at least one foaming agent is admixed with the fluid phase by the rotating independent mixing rotor within the mixing chamber to form a stream of the mixture.

Aspect 107. The method as in aspect 106, wherein the rotational speed of the independent mixing rotor is lower than 120 revolutions per second.

Aspect 108. The method as in aspect 99, wherein the at least one selected foaming agent that is activated is provided in the form of foaming granules comprising a core and a shell at least partially encapsulating the core.

Aspect 109. The method as in aspect 108, wherein the core comprises the at least one base polymer and the shell comprises a carrier material and the foaming agent dispersed in the carrier material.

Aspect 110. The method as in aspect 108, wherein the shell comprises the at least one base polymer and the core comprises a carrier material and the foaming agent dispersed in the carrier material.

Aspect 111. The method as in aspect 108, wherein the core comprises the at least one base polymer and the shell comprises the foaming agent in the form of solid particles and further comprises a binder system binding the particles to the core.

Aspect 112. The method as in aspect 111, wherein the shell substantially encapsulates the core.

Aspect 113. The method as in aspect 111, wherein the shell thickness is in a range from 0.01 mm to 1 mm.

Aspect 114. The method as in aspect 111, wherein a mass fraction of the binder system in the foaming granules is no more than 11 wt %.

Aspect 115. The method as in aspect 99, wherein the masterbatch granules and the at least one feedstock material comprising the at least one base polymer are fed into separate inlets of the extruder, the at least one selected foaming agent that is activated is provided in the form of the masterbatch granules.

Aspect 116. The method as in aspect 99, wherein the masterbatch filament and the at least one feedstock material comprising the at least one base polymer are fed into separate inlets of the extruder, the at least one selected foaming agent that is activated is provided in the form of the masterbatch filament.

Aspect 117. The method as in aspect 99, where a ratio of the volumetric expansion is in a range from 1 to 8.

Aspect 118. The method as in aspect 99, where a ratio of the volumetric expansion is in a range from 1 to 2.9.

Aspect 119. The method as in aspect 99, wherein a volumetric flow rate of extrusion is in a range from 0.2 cm³/min to 20 cm³/min.

Aspect 120. The method as in aspect 119, where a ratio of the volumetric expansion is in a range from 1 to 2.9.

Aspect 121. The method as in aspect 99, wherein a volumetric flow rate of extrusion is in a range from 0.2 cm³/min to 5 cm³/min.

Aspect 122. The method as in aspect 121, where a ratio of the volumetric expansion is in a range from 1 to 2.9.

Aspect 123. The method as in aspect 99, wherein the polymeric foam has a maximum cell size of less than 150 microns.

Aspect 124. The method as in aspect 99, wherein the polymeric foam has an average cell size of less than 100 microns.

Aspect 125. The method as in aspect 99, wherein the polymeric foam has an average cell size of less than 70 microns.

Aspect 126. The method as in aspect 99, wherein the at least one selected foaming agent that is activated is thermally expandable microspheres.

Aspect 127. The method as in aspect 99, wherein the at least one selected foaming agent that is activated is a chemical blowing agent emitting gas at decomposition temperature.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended aspects, taken in conjunction with the accompanying drawings. Understanding that these drawings depict only several embodiments in accordance with the disclosure and are, therefore, not to be considered limiting of its scope, the disclosure will be described with additional specificity and detail through the use of the accompanying drawings.

FIG. 1 is a block diagram of a 3D printing system suitable for 3D printing of polymeric foams.

FIGS. 2A and 2B show examples of extruders suitable to be used in the 3D printing system of FIG. 1.

FIGS. 3A, 3B, and 3C show other examples of extruders suitable to be used in the 3D printing system of FIG. 1.

FIGS. 4A, 4B, and 4C show respectively a perspective, top, and cross-sectional view of an exemplary model with tool paths marked thereon.

FIGS. 4D, 4E, 4F, and 4G show various cross-sectional views of the non-planar deposition process.

FIG. 5 shows a flow chart of an exemplary algorithm for calculating a tool path for non-planar deposition process.

FIG. 6A shows an exemplary deposition process with the nozzle depositing the printing material on a deposition surface while traveling along thereof.

FIG. 6B is a graph illustrating a change in the line height along the path of the nozzle.

FIG. 6C is a graph illustrating an example of a speed profile for the deposition process of FIG. 6A with substantially constant extrusion volumetric flow rate.

FIGS. 7A and 7B are SEM images of cross sections of the part produced in Example 3.

FIGS. 8A and 8B are SEM images of cross sections of the part produced in Example 4.

FIGS. 9A and 9B are SEM images of cross sections of the part produced in Example 5.

FIGS. 10A and 10B are SEM images of cross sections of the part produced in Example 6.

FIGS. 11A and 11B are SEM images of cross sections of the part produced in Example 7.

FIGS. 12A and 12B are SEM images of cross sections of the part produced in Example 8.

FIGS. 13A and 13B are SEM images of cross sections of the part produced in Example 12.

FIGS. 14A and 14B are SEM images of cross sections of the part produced in Example 13.

FIGS. 15A and 15B are SEM images of cross sections of the part produced in Example 14.

FIG. 16 is an exemplary footwear article of Example 15.

### DETAILED DESCRIPTION

The present invention provides methods and systems for additive manufacturing of objects and particularly objects comprising a polymeric foam. Embodiments of the present invention may include processing one or more raw materials by an additive manufacturing process into an object, wherein the raw materials include a base polymer and a foaming agent that are provided in the form of at least one feedstock material; and wherein the additive manufacturing process comprises a step of extrusion-based 3D printing with said feedstock materials. The extrusion-based 3D printing is well known under abbreviations such as FDM, FFF, and FGF. As used herein, the term “feedstock material” refers to a raw material in the form selected from a group consisting of: a filament, granules; or to a composition of raw materials, the composition being in the form selected from a group consisting of: a filament, granules. In this document, a feedstock material that is a composition of raw materials is considered to be a raw material itself. In this document, the term “filament” refers to a raw material or a composition of raw materials in a continuous feed shape such as a rod, a wire, a strand, a filament (as it is being used in the art). A filament may be flexible or rigid. A filament may have a transverse cross-section of various geometries, such as cylindrical, ellipsoidal, square, or any of a variety of shapes. Without limitation, filaments with equivalent circular diameters in a range from 0.5 to 10 mm (preferably in a range from 1.5 mm to 4 mm) can be used in the methods of the present invention. In this document, the term “granules” refers to particles with equivalent spherical diameters greater than or equal to 0.2 mm (to differentiate them from powders). Granules may have various geometries, such as cubic, trapezoidal, cylindrical, ellipsoidal, spherical, or any of a variety of shapes. Without limitation, granules with the equivalent spherical diameters in a range from about 0.2 to about 10 mm (preferably in a range from about 0.8 to about 6 mm) can be used in the methods of the present invention. In this document, saying that a raw material is provided in the form of a feedstock material means that a portion or the whole amount of the raw material is provided as a component of the feedstock material (including a case when the feedstock material is the raw material). In this document, saying that one or more raw materials are provided in the form of at least one feedstock material means that a portion or the whole amount of each said raw material is provided as a component of at least one said feedstock material (including a case when the feedstock material is said raw material). In embodiments, a raw material may be provided in other forms such as in the form of liquid, in the form of powder, in the form of slurry or the like.

The methods of the present invention can accommodate polymeric foams with relative densities in a range from about 0.09 to about 1, and in particular in a range from about 0.09 to about 0.56, and in particular in a range from about 0.14 to about 0.4. In this document, polymeric foams with relative densities at or below about 0.4 are referred to as “low-density foams.” Relative density measurements of foams, for the purpose of this invention, use the matrix material of the foam as the reference. The present invention may accommodate volumetric flow rates of the extrusion in a range from about 0.05 cm³/min to about 0.1 m³/min, and in particular in a range from about 0.1 to about 20 cm³/min, and in particular in a range from about 0.2 to about 5 cm³/min. In this document, unless otherwise stated, the volumetric flow rate refers to volume of material extruded per unit of time, and the mass flow rate refers to mass of material extruded per unit of time. The range of volumetric flow rates from about 0.1 to about 20 cm³/min and the range of relative densities from about 0.09 to about 0.56 are found especially beneficial for 3D printing using desktop 3D printing systems. The range of flow rates from about 0.2 to about 5 cm³/min and the range of relative densities from about 0.14 to about 0.4 are found especially beneficial for fabrication of footwear articles. In this document, extrusion-based 3D printing with volumetric flow rates at or below 20 cm³/min is referred to as “desktop 3D printing”.

The present invention teaches methods that are applicable to relative densities and volumetric flow rates in the specified ranges in a sense that they allow for extrusion-based three-dimensional (3D) printing of objects within the specified ranges of the volumetric flow rate, the objects comprising a polymeric foam with substantially homogeneous properties and with relative density within the specified ranges. The properties may include relative density, cell density, average cell size and the like.

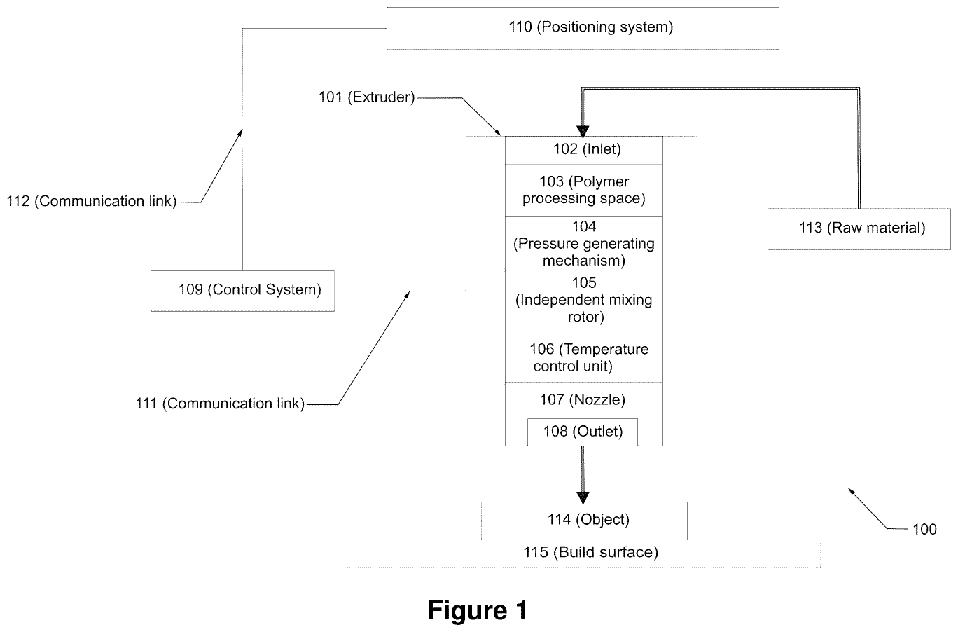

FIG. 1 is a block diagram of a 3D printing system 100 according to one set of embodiments. The 3D printing system 100 includes an extruder 101 (in this document also referred to as printhead). The extruder 101 includes an inlet 102 adapted to receive one or more raw materials 113. Raw material 113 may be provided in the form of a feedstock material (that is in the form selected from a group consisting of: a filament, granules). Alternatively, or in addition, raw material 113 may be provided in the form of liquid, in the form of powder, in the form of slurry or the like. The extruder 101 may comprise a plurality of inlets 102. For example, a first inlet 102 may be adapted to receive raw material 113 provided in the form of granules which may be blown into the first inlet 102 from a storage container by applying air pressure inside a flexible tube connecting the storage container and the extruder 101; while a second inlet 102 may be adapted to receive raw material 113 provided in the form of a filament which is pushed into the second inlet 102 through a flexible tube connecting a filament source with the extruder 101 by a filament feeder (in this document also referred to as filament drive mechanism). The extruder 101 further comprises a nozzle 107 that includes an outlet 108 fluidly connected to the inlet 102, the outlet 108 designed to release a resultant stream of solidifying material, herein referred to as deposition material, from the extruder 101. For example, the deposition material may be a thermoplastic resin. For example, the deposition material may be a thermosetting resin, such as a photocurable thermosetting resin. For example, the deposition material may be a polymeric foam, such as a polymeric foam having a thermoplastic resin and/or a thermosetting resin in the composition of the matrix material. For embodiments, where the nozzle 107 has multiple exit orifices configured to release the deposition material from the extruder 101, it is understood that they together form a single outlet 108. The extruder 101 may have a plurality of nozzles. For example, the extruder 101 may have two nozzles 107 having outlets 108 configured to release different deposition materials. The 3D printing system 100 may further include a build surface 115 on which an object 114 to be formed as hereinafter set forth. For example, the build surface 115 may be a flat surface of a base member of the 3D printing system 100 (not shown). Alternatively, the build surface 115 may be a surface that does not belong to a member of the 3D printing system. For example, the build surface 115 may be formed by a portion of a surface on which the 3D printing system 100 rests. For example, the build surface 115 may be formed by a surface of an auxiliary object, such as a shoe last, placed inside the 3D printing system 100.

The 3D printing system 100 further includes a positioning system 110 configured to position the nozzle 107 relative to the build surface 115. A variety of positioning systems are known in the art and suitable for use as the positioning system 110. For example, the positioning system 110 may include a Cartesian coordinate positioning system or X-Y-Z positioning system employing a number of linear controls to move independently in the X-axis, the Y-axis, and the Z-axis. Alternatively, or in addition, Delta positioning systems may be usefully employed. Alternatively, or in addition, robotic manipulators may be usefully employed. More generally, any positioning system 110 suitable for controlled positioning of the nozzle 107 relative to the build surface 115 may be usefully employed. For example, the nozzle 107 may be operably coupled to the positioning system 110 such that the positioning system 110 position the nozzle 107. The build surface 115 may also or instead be operably coupled to the positioning system 110 such that the positioning system position the build surface 115. Or some combinations of these techniques may be employed, such as by moving the nozzle 107 up and down for Z-axis control, and moving the build surface 115 within the X-Y plane to provide X-axis and Y-axis control. In some implementations, the positioning system may translate the build surface 115 along one or more axes, and/or may rotate the build surface 115. The positioning system 110 may include a number of electric motors to independently control position of the nozzle 107 or the build surface 115 along each axis, e.g., an X-axis, a Y-axis, and a Z-axis. More generally, the positioning system 110 may include various combinations of stepper motors, encoded DC motors, gears, belts, pulleys, worm gears, threads, and the like. Any such arrangement suitable for controllably positioning the nozzle 107 or the build surface 115 may be adapted to use with the 3D printing system 100.

The 3D printing system 100 further includes a control system 109. The 3D printing system 100 may further include a communication link 111 that links the control system 109 with the extruder 101 to establish communication between the control system 109 and the extruder 101. The 3D printing system 100 may further include a communication link 112 that links the control system 109 with the positioning system 110 to establish communication between the control system 109 and the positioning system 110. The control system 109 may be configured to control the extrusion and the relative motion of the nozzle 107 relative to the build surface 115 to fabricate the object 114 on the build surface 115 by sequentially depositing a plurality of layers of the deposition material, wherein the deposition of a layer of the deposition material includes extruding the deposition material towards a deposition surface while moving the nozzle 107 relative to the build surface 115 to deposit the deposition material on the deposition surface. The control system 109 may execute instructions generated based on a three-dimensional model or any other digital representation of the object 114, the instructions defining the 3D printing process. The instructions may be generated externally and input to the control system 109. Alternatively, or in addition, the instructions may be generated by the control system 109 itself. For example, instructions may define the movement path of the nozzle 107 relative to the build surface 115, further referred as tool path. The tool path may be predefined. Alternatively, or in addition, a portion of the tool path may be generated and/or adjusted dynamically during the 3D printing process. The control system 109 may be a distributed system consisting of a plurality of subsystems. For example, the control system 109 may comprise a cloud-based subsystem, for example, configured to generate high-level instructions based on a three-dimensional model of the object 114. The control system 109 may further comprise a path planning subsystem connected to the cloud-based system over a wired or wireless interface, the path planning subsystem may interpret the high-level instructions received from the cloud-based system by generating low-level instructions corresponding to the tool path for motors of the positioning system 110 and transfer them to the positioning system 110 over the communication link 112. The control system 109 may be implemented using one or more controllers, mounted statically or for movement, interconnected over wired or wireless communication links.

During the three-dimensional printing process, if the deposition material is deposited on the build surface 115 (for example, the currently deposited layer is the first from the build surface 115), the term “deposition surface” refers to the build surface 115. Otherwise, the term “deposition surface” refers to a surface of a previously deposited deposition material. For example, during deposition of a layer of a deposition material, deposition surface may be formed by a surface of a previously deposited layer of the deposition material. As another example, a nozzle 107 of a first extruder 101 may deposit a first deposition material onto a deposition surface formed by a second deposition material earlier deposited by a nozzle 107 of a second extruder 101.

The extruder 101 further comprises an enclosed polymer processing space 103 fluidly connecting at least one inlet 102 with at least one outlet 108, the polymer processing space 103 configured to allow advancement of one or more streams therein in a downstream direction from the inlet 102 toward the outlet 108. The extruder 101 may have a plurality of polymer processing spaces 103. For example, the extruder 101 may have two polymer processing spaces 103 that are not fluidly connected to each other and configured to allow advancement of streams of different raw materials 113; the extruder 101 may further comprise two nozzles 107, each having an outlet 108 that is fluidly connected to a separate inlet 102 with a separate polymer processing 103. As used herein, the term “stream” in context of one or more raw materials refers to an amount of said raw materials and/or their derivatives (including different forms or states of said raw materials) within the polymer processing space 103 that flows in the downstream direction from one or more inlets 102 towards one or more outlets 108. As used herein, the term “stream” in context of one or more derivatives of raw materials refers to an amount of said derivatives and/or their derivatives within the polymer processing space 103 that flows in the downstream direction from one or more inlets 102 towards one or more outlets 108. When particular raw materials or derivatives of raw materials are not clear from the context, the term “stream” refers to stream of at least one raw material and/or its derivatives selected from all raw materials processed by extruder 101. A stream may comprise other streams. For example, a stream may comprise a first stream of a first raw material and a second stream of a second raw material which are intermixed into a single fluid phase. Streams may change their state during the flow. For example, a stream of thermoplastic granules may change its state from solid to liquid under heating. Streams may be combined and divided.

The extruder 101 further comprises at least one pressure-generating mechanism 104 configured to establish a stream of at least one raw material 113 within the polymer processing space 103 in a downstream direction from the inlet 102 towards the outlet 108. Establishing a stream of granules presupposes compressing the granules and conveying or pushing them in the downstream direction. Establishing a stream of a filament presupposes pushing it through the inlet 102 into the polymer processing space 103. The pressure-generating mechanism 104 may be a positive displacement pump, a dynamic pump, a drag flow pump, Weissenberg effect pump, a pressurized vessel or the like. The extruder 101 may comprise a plurality of pressure-generating mechanisms 104, possibly of different types, configured to establish streams of possibly different raw materials 113. The pressure-generating mechanism 104 may be connected to the control system 109 (for example, a motor of the pressure-generating mechanism may be connected to the control system 109) via the communication link 111 for providing control over the mass flow rate and/or the volumetric flow rate of streams established by the pressure-generating mechanism 104.

In embodiments where the raw material 113 is provided in the form of granules, the pressure-generating mechanism 104 may be selected from a group consisting of: a screw extrusion mechanism, a disk extrusion mechanism, a progressive cavity extrusion mechanism, a vane extrusion mechanism, a planetary extrusion mechanism, a ram extrusion mechanism.

Screw extrusion mechanisms are well known from the art. For example, the screw extrusion mechanism may be a single-screw extrusion mechanism and may include a screw and a motor (e.g., a stepper motor or an encoded DC motor) operably connected to the screw, the screw configured to rotate about a rotational axis within a barrel to establish a stream of granules within a portion of the polymer processing space 103 between the screw and the barrel. The single-screw extrusion mechanism may have a grooved barrel. In embodiments, the barrel may have one or more grooves formed in its inner surface that extend substantially helically or axially with respect to the rotational axis. Alternatively, or in addition, the barrel may have one or more slots extending substantially axially with respect to the rotational axis and respectively one or more limiting members disposed in the slots that limit the depth of the grooves. The limiting members may be actuated such that to adjust the depth of the grooves. As another example, the screw extrusion mechanism may be a twin-screw extrusion mechanism and may include two intermeshing or non-intermeshing screws operably connected to one or more motors, the screws configured to rotate within a barrel, each screw rotates about a rotational axis parallel or at an angle to the rotational axis of the other screw, to establish a stream of granules within a portion of the polymer processing space 103 between the screws and the barrel and between each screw and the barrel. As another example, the screw extrusion mechanism may be a tri-screw (triple screw) extrusion mechanism and may include three intermeshing or non-intermeshing screws defining at least two different pairs of adjacent screws, the screws operably connected to one or more motors, the screws configured to rotate within a barrel, each screw rotates about a rotational axis parallel or at an angle to the rotational axes of the other two screws, to establish a stream of granules within a portion of the polymer processing space 103 between each screw and the barrel and between the adjacent screws and the barrel. As another example, the screw extrusion mechanism may be a planetary extrusion mechanism and may include a sun screw operably connected to a motor and may further include one or more planetary rotors, the sun screw having a toothed section surrounded by a toothed inner surface of the barrel, the planetary rotors disposed between the section and the inner surface and configured to roll around the section as the sun screw rotates about a rotational axis leading to a complex motion of rotation of the planetary rotors about their central axes that orbit around the rotational axis of the sun screw as it rotates; the sun screw and the planetary rotors are configured to rotate within a barrel to establish a stream of granules within a portion of the polymer processing space between the sun screw and the barrel. It should be noted that the planetary extrusion mechanism may be also a single-screw extrusion mechanism or a twin-screw extrusion mechanism or tri-screw extrusion mechanism when respectively the sun screw is the screw of a single-screw extrusion mechanism or one of the two screws of a twin-screw extrusion mechanism or one of the three screws of a tri-screw extrusion mechanism.

Disk extrusion mechanisms are well known. For example, the disk extrusion mechanism may be a scroll extrusion mechanism (also referred to in the art as a flat screw extrusion mechanism) comprising a barrel and a disk (further referred to as scroll), at least one of the barrel and the scroll operably connected to a motor and configured to rotate about a rotational axis to establish a stream of granules between the scroll and the barrel. The scroll may have one or more grooves spirally turned around a rotational axis in its surface facing the barrel. Alternatively, or in addition, the scroll may have one or more grooves extending radially formed in its surface facing the barrel. The discharge port may be formed in the center of the scroll. Alternatively, or in addition, the discharge port may be formed in the barrel. The scroll extrusion mechanism may have a grooved barrel. For example, the barrel may have one or more grooves in its surface facing the scroll. For example, the grooves may be arranged annularly around the discharge port of the barrel located opposite to the center of the scroll and extend spirally or radially towards the periphery of the barrel. The stream of granules may be established in direction from the periphery of the disk towards the discharge port along the grooves of the scroll or the barrel. The scroll may have an elongated central portion protruding along the rotational axis. The central portion may be cylindrically or conically shaped with respect to the rotational axis. The central portion may have a helical passageway formed around the rotation axis. The barrel may have an elongated cavity surrounding the central portion, the cavity extending from the surface facing the scroll along the rotational axis towards a discharge end of the barrel. The discharge port may be formed in the discharge end of the barrel. The helical passageway may be fluidly connected with the groove of the scroll or may be its extension; and configured to further advance the stream towards the discharge end of the barrel. The central portion and the barrel may be configured to operate as a single-screw extrusion mechanism providing additional pressure buildup and/or additional plasticization of the stream.

Progressive cavity extrusion mechanisms are relatively new in the art but they share the same working principle with progressive cavity pumps already well known from the art. For example, the progressive cavity extrusion mechanism may be a single-rotor progressive cavity extrusion mechanism and may comprise one substantially helical rotor operably connected to a motor and configured to rotate within a substantially helical inner cavity of a stator about a central axis of the rotor while the rotation about the central axis due to structural constraints of the inner cavity causes the rotor and the central axis to rotate about a second axis. The shape of the rotor and the shape of the stator may lead to a plurality of cavities being formed between the rotor and the stator that are displaced axially as the rotor rotates to establish a stream of granules between the rotor and the stator. In embodiments, the rotor may comprise a segment formed by circular shape having its center on a line that spirals about the central axis at a constant eccentric offset. In embodiments, said segment of the rotor may be surrounded by a segment of the inner cavity of the stator in the form of a two-start helical thread which extends in the same direction as that of the rotor thread, but each thread of the two-start configuration has a pitch length double that of the rotor. The single-rotor progressive cavity extrusion mechanism may be a single eccentric rotor extrusion mechanism and may comprise the rotor having one or more cylindrical or straight segments eccentric with respect to the central axis. In embodiments, the rotor may have multiple alternatively disposed helical segments and straight segment, and the inner cavity of the stator may have multiple alternatively disposed helical segments and straight segments corresponding with that of the rotor. The motion of the rotor causes the volume of a cavity between the straight segment of the rotor and the stator to periodically change alternatively along the axial direction and the radial direction exerting pulsed volume deformation on granules in the cavity when cyclically compressed and released, thus compressing the granules and pushing them in the downstream direction within the polymer processing space 103. As another example, the progressive cavity extrusion mechanism may be a twin-rotor progressive cavity extrusion mechanism and may comprise two intermeshing substantially helical rotors operably connected to one or more motors, the rotors configured to rotate within an inner cavity of a stator in opposite directions about their central axes. The shape of the rotors may lead to a plurality of cavities being formed between the rotors and the stator that are axially displaced as the rotors rotate to establish a stream of granules between the rotors and the stator. The twin-rotor progressive cavity extrusion mechanism may be a biaxial eccentric rotor extrusion mechanism and may comprise the two rotors having one or more cylindrical or straight segments eccentric with respect to their central axes. In embodiments, the rotors may have multiple alternatively disposed helical segments and straight segments, axially aligned between the rotors. The rotors may be engaged with their adjacent helical segments. The motion of the rotors causes the volume of a cavity between the adjacent straight segments of the rotors and the stator to periodically change exerting pulsed volume deformation on granules in the cavity when cyclically compressed and released, thus compressing the granules and pushing them in the downstream direction within the polymer processing space 103. As another example, the progressive cavity extrusion mechanism may be a tri-rotor progressive cavity extrusion mechanism and may comprise three substantially helical rotors defining at least two different pairs of adjacent rotors, the rotors operably connected to one or more motors, the rotors configured to rotate within an inner cavity of a stator such that the adjacent rotors are intermeshing and rotate in opposite directions about their central axes. The shape of the rotors may lead to a plurality of cavities being formed between the adjacent rotors and the stator that are axially displaced as the rotors rotate to establish a stream of granules between the rotors of said pairs and the stator. The tri-rotor progressive cavity extrusion mechanism may be a tri-axial eccentric rotor extrusion mechanism and may comprise the three rotors having one or more cylindrical or straight segments eccentric with respect to their central axes. In embodiments, the rotors may have multiple alternatively disposed helical segments and straight segments, axially aligned between the rotors. The adjacent rotors may be engaged with their adjacent helical segments. The resultant motion of the rotors causes the volume of a cavity between the adjacent straight segments of the rotors and the stator to periodically change exerting pulsed volume deformation on granules in the cavity when cyclically compressed and released, thus compressing the granules and pushing them in the downstream direction within the polymer processing space 103.

Vane extrusion mechanisms are relatively new in the art but they share the same working principle with vane pumps already well known from the art. The vane extrusion mechanism may comprise a stator and a rotor eccentrically rotatably mounted within an inner cavity of the stator, wherein a plurality of slots is formed along the circumference of the rotor. A plurality of vanes may be arranged in the slots. The inner cavity of the stator may be divided with baffles into one or more chambers that are fluidly connected in series. A plurality of spaces between the stator and the rotor is formed. When the rotor rotates about a rotational axis, a pair of the vanes on the diameter of the rotor make reciprocating radial movements within the rectangular slot due to the outer top surface of the vane being restricted by the inner surface of the stator; consequently, the volume of the enclosed spaces increases and decrease periodically; whereas when the volume decreases, the granules are compacted and discharged from the stator or into the next chamber of the stator, thus establishing a stream of granules between the rotor and the stator.

Ram extrusion mechanisms are well known and may comprise a ram or plunger slidably mounted within a barrel and configured to be moved by a motor, pneumatics or hydraulics against granules to compress the granules and push them in the downstream direction within the polymer processing space 103 to establish a stream of granules.

In embodiments where the raw material 113 is provided in the form of a filament, the pressure-generating mechanism 104 may be a filament drive mechanism. The filament drive mechanisms are well known. For example, the filament drive mechanism may comprise at least one drive wheel operably connected to a motor, the drive wheel configured to rotate about an axis and frictionally engage the filament to thereby push the filament through the inlet 102. The drive wheel may have teeth or grooves arranged circumferentially around the axis and configured to engage the filament. Alternatively, or in addition, the filament drive mechanism may comprise one or more threaded rods operably connected to a motor and configured to rotate about an axis and frictionally engage the filament to thereby push the filament through the inlet 102. In some embodiments, the threaded rods may be arranged annularly around the filament and configured to rotate about their thread axes and frictionally engage the filament to thereby push the filament though the inlet 102. The threaded rods may further have their thread axes positioned at an angle relative to the central axis of the filament passageway. The threaded rods may have their upper and lower ends supported in an annular mounting that is rotated about the central axis of the filament by the motor. The threaded rods may be rotated about the central axis of the filament as the result of the rotation of the mounting and may be further rotated about their thread axes as the result of the rotational about the central axis and engagement with the filament.

The pressure-generating mechanism 104 may be moved with the nozzle 107 relative to the build surface 115 or it may be fixed relative to the build surface 115. An example of the fixed pressure-generating mechanism 140 may be a Bowden-type filament drive mechanism which pushes a filament through a flexible tube connecting the pressure-generating mechanism 104 to a member of the extruder 101 comprising the nozzle 107 that is moved relative to the build surface 115.

The extruder 101 further comprises one or more temperature control units 106 thermally coupled to the polymer processing space 103 and configured to heat and/or cool streams within the polymer processing space 103. These may include electrical heaters coupled with temperature sensors. Temperature control units 106 may also include passageways for temperature control fluid, and the like. The temperature control units 106 may be configured to maintain a set temperature profile along the polymer processing space. The control system 109 may be connected to the temperature control units 106 thereby providing control over the set temperatures and/or over actual temperatures. For example, the control system 109 may control the actual temperatures by adjusting the power of the temperature control units 106 to thereby remove differences between the set temperatures and the actual temperatures.

The extruder 101 may further comprise at least one mixing rotor having one or more surfaces forming a portion of the polymer processing space 103 boundary, wherein the mixing rotor is configured to rotate about a rotational axis (the rotational axis may move in space, for example, if the mixing rotor performs a complex motion) to mix at least one stream within a passageway of the polymer processing space 103, wherein the passageway is wholly or partially bounded by said surfaces, and wherein the mixing rotor is operably connected to a motor (e.g., a stepper motor or a DC motor) providing the rotational power to the mixing rotor. Said passageway is further referred to as mixing passageway (boundaries of the mixing passageway may change dynamically with the rotation of the mixing rotor). If all streams of granules (possibly melted by the time they enter the mixing passageway) received by the mixing passageway are established by at least one ram extrusion mechanism or if all streams of feedstock materials received by the mixing passageway are streams of filaments, any said mixing rotor rotating about the rotational axis is said to operate independently. Otherwise, said mixing rotor is said to operate independently if and only if all streams of granules (possibly melted by the time they enter the mixing passageway) received by its mixing passageway are established by one or more pressure-generating mechanisms 104 and the mixing rotor rotates about the rotational axis at a higher rotational speed than the rotational speeds of all members of said pressure-generating mechanisms 104 selected from a group consisting of: the screw of a single-screw extrusion mechanism, the two screws of a twin-screw extrusion mechanism, the three screws of a tri-screw extrusion mechanism, the scroll (in case the scroll rotates) and the barrel (in case the barrel rotates) of a scroll extrusion mechanism, the sun screw and the planetary rotors (with respect to their rotation about their central axes) of a planetary extrusion mechanism, the rotor of a vane extrusion mechanism, the rotor (with respect to its rotation about its central axis) of a single-rotor progressive cavity extrusion mechanism, the two rotors (with respect to their rotation about their central axes) of a twin-rotor progressive cavity extrusion mechanism, the three rotors (with respect to their rotation about their central axes) of a tri-rotor progressive cavity extrusion mechanism; wherein at least one of said pressure-generating mechanisms 104 is selected from a group consisting of: a single-screw extrusion mechanism, a twin-screw extrusion-mechanism, a tri-screw extrusion mechanism, a scroll extrusion mechanism, a planetary extrusion mechanism, a vane extrusion mechanism, a single-rotor progressive cavity extrusion mechanism, a twin-rotor progressive cavity extrusion mechanism, a tri-rotor progressive cavity extrusion mechanism. Said mixing rotor that is capable of operating independently is said to be independent mixing rotor. The extruder 101 may comprise one or more independent mixing rotors 105. The control system 109 may be connected to the motor via the communication link 111 thereby providing control over the rotational speed of the independent mixing rotor 105.

The 3D printing system 100 may include a plurality of extruders 101, which may be configured for different raw materials 113. For example, the 3D printing system may include a first extruder 101 configured to receive and process raw material 113 in the form of granules containing a foaming agent to deposit a first polymeric foam; the 3D printing system may further include a second extruder 101 configured to receive and process raw material 113 in the form of filament containing a foaming agent to deposit a second polymeric foam. The 3D printing system may further include one or more regular extruders not having an independent mixing rotor and configured to receive and process raw materials. For example, the regular extruder may be further configured to deposit parts of the object 114 from a non-foamed deposition material. Alternatively, or in addition, the third extruder may be configured to deposit a non-foamed deposition material next to the object 114 to support overhanging parts of the object 114 comprising the first and the second polymeric foams.

A first example of a foaming agent used for the purpose of this invention is thermally expandable microspheres. Thermally expandable microspheres, herein also referred to as “expandable microspheres” or “microspheres”, are a well-known type of foaming agents. Such microspheres may generally include a spherical shell formed by a gas-tight polymer (consisting of, for example, acrylonitrile) encapsulating a tiny droplet of a (cyclo)aliphatic hydrocarbon, such as isopentane. Any thermally expandable microspheres can be used in the present invention. However, microspheres containing hydrocarbons, and in particular, aliphatic or cycloaliphatic hydrocarbons, may be preferred. As used herein, the term “hydrocarbon” includes non-halogenated and partially or fully halogenated hydrocarbons. When the microspheres are heated to an activation temperature sufficient to soften the shell and vaporize the (cyclo)aliphatic hydrocarbon encapsulated in it (for example, from a temperature of about 100° C. to about 230° C.), the resulting gas expands the shell and increases the volume of the microspheres. As used herein, the term “activation temperature” for the thermally expandable microspheres means a temperature when the expansion starts given external conditions that they are subjected to. For example, the activation temperature of the microspheres may depend on the pressure that the microspheres are subjected to. When external conditions are not clear from the context, the activation temperature of microspheres refers to a temperature when the expansion of the microspheres starts at atmospheric pressure. In this document, activation of thermally expandable microspheres refers to their expansion (therefore, partially activated foaming agent that is expandable microspheres refers to the microspheres in a partially expanded state meaning that they can further be expanded; and activating a foaming agent that is expandable microspheres means expanding the microspheres, possibly from a partially expanded state to a more expanded state). In an expanded state, without limitation, the microspheres may have a diameter up to about 7 times larger than their original diameter. As a result, without limitation, their expanded volume may be up to about 350 times larger than their original volume in the unexpanded state. Depending on the polymer matrix used, it is possible to use microspheres with different activation temperatures. Thermally expandable microspheres are commercially available under various trade names. Examples of such microspheres are Advancell EM microspheres from Sekisui (Japan), as well as EXPANCEL-DU microspheres, which are sold by the Swedish AKZO Nobel Industries.

A second example of a foaming agent used for the purpose of this invention is chemical blowing agent. A substance that emits gas at the activation (decomposition) temperature—(nitrogen, carbon dioxide, carbon monoxide, etc.) can be used as chemical blowing agent. As used herein, the term “activation temperature” for a chemical blowing agent means its decomposition temperature given external conditions that it is subjected to. For example, the activation temperature of a chemical blowing agent may depend on whether special chemical substances referred to in the art and in this document as “kickers” are employed together with the chemical blowing agent. Kickers may reduce the activation temperature of a chemical blowing agent by the way of a chemical reaction. When external conditions are not clear from the context, the activation temperature of a chemical blowing agent refers to the decomposition temperature of the chemical blowing agent at atmospheric pressure and in absence of kickers. In this document, activation of a chemical blowing agent refers to its decomposition (therefore, partially activated foaming agent that is a chemical blowing agent refers to the chemical blowing agent in a partially decomposed state meaning that it can be further decomposed with gas release; and activating a foaming agent that is a chemical blowing agent means decomposing the chemical blowing agent, possibly from a partially decomposed state to a more decomposed state). Examples of chemical blowing agents are salts, amides and esters of azodicarboxylic acid, ammonium hydrogen carbonate, sodium hydrogencarbonate, calcium carbonate, calcium hydrogen carbonate, citric acid and its salts, malonic acid and its salts, dinitrosopentamethylenetetramine, and others.

In embodiments, raw materials may include combinations of various foaming agents. For example, raw materials may comprise a combination of one or more grades of thermally expandable microspheres and/or one or more chemical blowing agents.

As used herein, a polymer with the largest mass fraction in the composition of the matrix material of the polymeric foam is referred to as a base polymer. If there are more than one such polymers (plurality of polymers having equal mass fractions in the composition of the matrix material that are larger than mass fractions of all other polymers in the composition of the matrix material), each of them is referred to as a base polymer. For example, polymeric foams suitable for use according to the present invention may have a thermoplastic base polymer. Without limitation, examples of base polymers of the present invention may include thermoplastic polyurethanes, thermoplastic polyamides, thermoplastic polyesters, thermoplastic polyether block amides, as well as any of their copolymers.

Suitable exemplary thermoplastic polyurethanes may include thermoplastic polyester-polyurethanes, polyether-polyurethanes, and polycarbonate-polyurethanes.

Thermoplastic polyurethanes (TPUs) and the processes for their production are generally well known. By way of example, TPUs can be produced via reaction of (a) isocyanates with (b) compounds reactive toward isocyanates and having a molar mass of from about 500 to about 10000 and, if appropriate, (c) chain extenders having a molar mass of from about 50 to about 499, if appropriate, in the presence of (d) catalysts and/or of (e) conventional auxiliaries and/or conventional additives.

In general, the compounds reactive toward isocyanates may have two hydroxyl groups (diols) and may have a molar mass of from about 62 Daltons (the molar mass of ethylene glycol) to about 10,000 Daltons, although difunctional compounds having other isocyanate-groups (e.g., secondary amine) may also be used, generally in minor amounts, and a limited molar fraction of tri-functional and mono-functional isocyanate-reactive compounds may be used as well. The polyurethane may be linear. Including difunctional compounds with molar masses of about 400 or greater may introduce soft segments into the polyurethane. An increased ratio of soft segments to hard segments in the polyurethane may cause the polyurethane to become increasingly more flexible and eventually elastomeric. In certain aspects, such as when the 3D printed article is an outsole for an article of footwear, a rigid thermoplastic polyurethane or a combination of various suitable thermoplastic polyurethanes may be used as a base polymer. In various other aspects, such as when the 3D printed article is a midsole for footwear, an elastomeric thermoplastic polyurethane may be used as a base polymer.

Suitable thermoplastic polyurethanes may include thermoplastic polyester-polyurethanes, polyether-polyurethanes, and polycarbonate-polyurethanes. Non-limiting, suitable examples of these may include polyurethanes polymerized using as diol reactants polyesters diols prepared from diols and dicarboxylic acids or anhydrides, polylactone polyesters diols (for example polycaprolactone diols), polyester diols prepared from hydroxy acids that are monocarboxylic acids containing one hydroxyl group, polytetrahydrofuran diols, polyether diols prepared from ethylene oxide, propylene oxide, or combinations of ethylene oxide and propylene oxide, and polycarbonate diols such as polyhexamethylene carbonate diol and poly(hexamethylene-co-pentamethylene)carbonate diols. The elastomeric thermoplastic polyurethanes may be prepared by reaction of one of these polymeric diols (polyester diol, polyether diol, polylactone diol, polytetrahydrofuran diol, or polycarbonate diol), one or more polyisocyanates, and optionally one or more monomeric chain extension compounds. Chain extension compounds are compounds having two or more functional groups, preferably two functional groups, reactive with isocyanate groups. In embodiments, the elastomeric thermoplastic polyurethane may be substantially linear (i.e., substantially all of the reactants are di-functional).

Non-limiting examples of polyester diols used in forming the elastomeric thermoplastic polyurethane may include those prepared by the condensation polymerization of dicarboxylic compounds, their anhydrides, and their polymerizable esters (e.g. methyl esters) and diol compounds. In embodiments, most or all of the reactants may be di-functional, although small amounts of mono-functional, tri-functional, and higher functionality materials (perhaps up to a few mole percent) can be included. Suitable dicarboxylic acids may include, without limitation, glutaric acid, succinic acid, malonic acid, oxalic acid, phthalic acid, hexahydrophthalic acid, adipic acid, maleic acid, anhydrides of these, and mixtures thereof. Suitable polyols may include, without limitation, those with the extender selected from the group consisting of ethylene glycol, diethylene glycol, triethylene glycol, tetraethylene glycol, propylene glycol, dipropylene glycol, tripropylene glycol, tetrapropylene glycol, cyclohexanedimethanol, 2-ethyl-1,6-hexanediol, 1,4-butanediol, 1,5-pentanediol, 1,3-propanediol, butylene glycol, neopentyl glycol, and combinations thereof. Small amounts of triols or higher functionality polyols, such as trimethylolpropane or pentaerythritol, may sometimes be included. In embodiments, the carboxylic acid may include adipic acid and the diol may include 1,4-butanediol. Typical catalysts for the esterification polymerization may include protonic acids, Lewis acids, titanium alkoxides, and dialkyl tin oxides.

Hydroxy carboxylic acid compounds such as 12-hydroxy stearic acid may also be polymerized to produce a polyester diol. Such a reaction may be carried out with or without an initiating diol such as one of the diols already mentioned above.

Polylactone diol reactants may also be used in preparing elastomeric thermoplastic polyurethanes. The polylactone diols may be prepared by reacting a diol initiator, e.g., a diol such as ethylene or propylene glycol or another of the diols already mentioned above, with a lactone. Lactones that can be ring opened by active hydrogen such as, without limitation, ε-caprolactone, γ-caprolactone, β-butyrolactone, β-propriolactone, γ-butyrolactone, α-methyl-γ-butyrolactone, β-methyl-γ-butyrolactone, γ-valerolactone, δ-valerolactone, γ-decanolactone, δ-decanolactone, γ-nonanoic lactone, γ-octanoic lactone, and combinations of these can be polymerized. The lactone ring can be substituted with alkyl groups of 1-7 carbon atoms. In one aspect, lactone may be E-caprolactone. Useful catalysts include those mentioned above for polyester synthesis. Alternatively, the reaction can be initiated by forming a sodium salt of the hydroxyl group on the molecules that will react with the lactone ring.

Tetrahydrofuran may be polymerized by a cationic ring-opening reaction using such counterions as SbF6-, AsF6-, PF6-, SbC16-, BF4-, CF3SO3-, FSO3-, and ClO4-. Initiation may occur by the formation of a tertiary oxonium ion. The polytetrahydrofuran segment can be prepared as a “living polymer” and terminated by reaction with the hydroxyl group of a diol such as any of those mentioned above.

Aliphatic polycarbonates may be prepared by polycondensation of aliphatic diols with dialkyl carbonates, (such as diethyl carbonate), cyclic glycol carbonates (such as cyclic carbonates having five- and six-member rings), or diphenyl carbonate, in the presence of catalysts like alkali metal, tin catalysts, or titanium compounds. or diphenyl carbonate. Another suitable way to make aliphatic polycarbonates may be by ring-opening polymerization of cyclic aliphatic carbonates catalyzed by organometallic catalysts. Polycarbonate diols can also be made by copolymerization of epoxides with carbon dioxide. Aliphatic polycarbonate diols may be prepared by the reaction of diols with dialkyl carbonates (such as diethyl carbonate), diphenyl carbonate, or dioxolanones (such as cyclic carbonates having five- and six-member rings) in the presence of catalysts like alkali metal, tin catalysts, or titanium compounds. Useful diols may include, without limitation, any of those already mentioned above. Aromatic polycarbonates may be prepared from the reaction of bisphenols, e.g., bisphenol A, with phosgene or diphenyl carbonate.

The polymeric diol, such as the polymeric polyester diols and polyether diols described above, that are used in making an elastomeric thermoplastic polyurethanes synthesis may have a number average molecular weight (determined, for example, by the ASTM D-4274 method) of from about 300 Daltons to about 8,000 Daltons, such as at least 300, at least 400, at least 500, at least 600, at least 800, at least 1,000, at least 2,000, at least 3,000, at least 4,000, and up to about 5,000 Daltons.

The synthesis of thermoplastic polyurethanes may be carried out by reacting one or more of the polymeric diols, one or more compounds having at least two (preferably two) isocyanate groups, and optionally one or more chain extension agents. The elastomeric thermoplastic polyurethanes may be linear and thus the polyisocyanate component may be substantially di-functional. Useful diisocyanate compounds used to prepare the elastomeric thermoplastic polyurethanes, may include, without limitation, methylene bis-4-cyclohexyl isocyanate, cyclohexylene diisocyanate (CHDI), isophorone diisocyanate (IPDI), m-tetramethyl xylylene diisocyanate (m-TMXDI), p-tetramethyl xylylene diisocyanate (p-TMXDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, 1,4-methylene bis-(cyclohexyl isocyanate), 2,4-tolylene (“toluene”) diisocyanate and 2,6-tolylene diisocyanate (TDI), 2,4′-methylene diphenyl diisocyanate (MDI), 4,4′-methylene diphenyl diisocyanate (MDI), o-, m-, and p-xylylene diisocyanate (XDI), 4-chloro-1,3-phenylene diisocyanate, naphthylene diisocyanates including 1,2-naphthylene diisocyanate, 1,3-naphthylene diisocyanate, 1,4-naphthylene diisocyanate, 1,5-naphthylene diisocyanate, and 2,6-naphthylene diisocyanate, 4,4′-dibenzyl diisocyanate, 4,5′-diphenyldiisocyanate, 4,4′-diisocyanatodibenzyl, 3,3′-dimethoxy-4,4′-biphenylene diisocyanate, 3,3′-dimethyl-4,4′-biphenylene diisocyanate, 1,3-diisocyanatobenzene, 1,4-diisocyanatobenzene, and combinations thereof. One particularly useful example is diphenylmethane diisocyanate (MDI).

Useful active hydrogen-containing chain extension agents generally contain at least two active hydrogen groups, for example, diols, dithiols, diamines, or compounds having a mixture of hydroxyl, thiol, and amine groups, such as alkanolamines, aminoalkyl mercaptans, and hydroxyalkyl mercaptans, among others. The molecular weight of the chain extenders may range from about 60 to about 400 g/mol. Alcohols and amines may be used in some aspects. Typical examples of useful diols that are used as polyurethane chain extenders may include, without limitation, 1,6-hexanediol, cyclohexanedimethanol (sold as CHDM by Eastman Chemical Co.), 2-ethyl-1,6-hexanediol, 1,4-butanediol, ethylene glycol and lower oligomers of ethylene glycol including diethylene glycol, triethylene glycol, and tetraethylene glycol; propylene glycol and lower oligomers of propylene glycol including dipropylene glycol, tripropylene glycol and tetrapropylene glycol; 1,3-propanediol, neopentyl glycol, dihydroxyalkylated aromatic compounds such as the bis(2-hydroxyethyl)ethers of hydroquinone and resorcinol; p-xylene-α,α′-diol; the bis(2-hydroxyethyl)ether of p-xylene-α,α′-diol; m-xylene-α,α′-diol, and the bis(2-hydroxyethyl)ether; 3-hydroxy-2,2-dimethylpropyl 3-hydroxy-2,2-dimethylpropanoate; and mixtures thereof. Suitable diamine extenders include, without limitation, p-phenylenediamine, m-phenylenediamine, benzidine, 4,4′-methylenedianiline, 4,4′-methylenibis (2-chloroaniline), ethylene diamine, and combinations of these. Other typical chain extenders may include amino alcohols such as ethanolamine, propanolamine, butanolamine, and combinations of these. In embodiments, the extenders may include ethylene glycol, diethylene glycol, triethylene glycol, tetraethylene glycol, propylene glycol, dipropylene glycol, tripropylene glycol, tetrapropylene glycol, 1,3-propylene glycol, 1,4-butanediol, 1,6-hexanediol, and combinations of these.

In addition to the above-described di-functional extenders, a small amount of tri-functional extenders such as trimethylolpropane, 1,2,6-hexanetriol, and glycerol, and/or mono-functional active hydrogen compounds such as butanol or dimethyl amine, may also be present. The amount of tri-functional extenders and/or mono-functional compounds employed may be a few equivalent percent or less based on the total weight of the reaction product and active hydrogen-containing groups employed.

The reaction of the polyisocyanate(s), polymeric diol(s), and optionally chain extension agent(s) may be conducted by heating the components, generally in the presence of a catalyst. Typical catalysts for this reaction may include organotin catalysts such as stannous octoate or dibutyl tin dilaurate. Generally, the ratio of polymeric diol, such as polyester diol, to the extender can be varied within a relatively wide range depending largely on the desired hardness of the elastomeric thermoplastic polyurethanes. For example, the equivalent proportion of polyester diol to extender may be within a range from about 1:0 to about 1:12, such as at least 1:0, at least 1:1, at least 1:2, at least 1:3, at least 1:4, at least 1:5, at least 1:6, at least 1:7, at least 1:8, at least 1:9, at least 1:10, at least 1:11, and up to 1:12. In embodiments, the diisocyanate(s) employed may be proportioned such that the overall ratio of equivalents of isocyanate to equivalents of active hydrogen containing materials may be within a range from 0.95:1 to 1.10:1, such as at least 0.95:1, at least 0.98:1, at least 1:1, at least 1.02:1, and up to 1.04:1. The polymeric diol segments may typically be from about 25 weight percent to about 65 weight percent of the elastomeric thermoplastic polyurethanes, such as at least 25, at least 30, at least 35, at least 40, at least 45, at least 50, at least 55, at least 60, and up to about 65 weight percent of the elastomeric thermoplastic polyurethanes.

In various aspects, the thermoplastic polyurethane elastomer used for the purpose of this invention may include a long-chain polyol. In a still further aspect, the long-chain polyol may be selected from a polyether polyol, a polyester polyol, a polycarbonate polyol, a polyolefin polyol, a polyacryl polyol, and any copolymer thereof. In a yet further aspect, the long-chain polyol may be a polyether polyol, a polyester polyol, and any copolymer thereof. In embodiments, the long-chain polyol may be a polyether polyol. In other embodiments, the long-chain polyol maybe a polyester polyol. In further aspects, the long-chain polyol may have a number-average molecular weight of not less than about 500 Daltons. In still further aspects, the long-chain polyol may have a number-average molecular weight of about 500 Daltons to about 10,000 Daltons; such as at least 500, at least 600, at least 700, at least 800, at least 900, at least 1,000, at least 1,500, at least 2,000, at least 2,500, at least 3,000, at least 4,000, at least 5,000, at least 6,000, at least 7,000, at least 8,000, at least 9,000, and up to about 10,000 Daltons.

A thermoplastic polyurethane that is more rigid may be synthesized in the same way but with a lower content of the polymeric diol segments. A rigid thermoplastic polyurethane may, for example, include from about 0 to about 25 weight percent of the polyester, polyether, or polycarbonate diol segments. The synthesis of rigid polyurethanes is generally known in the art and described in many references.

The thermoplastic polyurethanes used as the polymer matrix in the present invention may be characterized by a Shore hardness in a range from about 20 A to about 90 D. In other embodiments, thermoplastic polyurethanes with a hardness of about 40 A to about 70 D may be used. In yet further embodiments, thermoplastic polyurethanes with a hardness of about 60 A to about 100 A may be used.

The TPUs can be produced by the known processes continuously, for example, using reactive extruders, or the belt process, by the one-shot method or the prepolymer method, or produced in batches by a known prepolymer process. The components reacting in these processes can be mixed in succession or simultaneously, whereupon the reaction immediately begins.

In the extruder process, structural components may be introduced individually or in the form of a mixture into the extruder, e.g. at temperatures from 100 to 280° C., in some embodiments from 140 to 250° C., and reacted. The resultant TPU may be extruded, cooled, and pelletized. It can, if appropriate, be advisable to heat-condition the resultant TPU before further processing at temperatures ranging from 80 to 120° C., in some embodiments from 100 to 110° C., for a period from about 1 to about 24 hours.

In various aspects of the present invention, thermoplastic polyamides can be used as a base polymer. Suitable polyamides for use as polymer matrix can be obtained by polycondensation of carboxylic acids with diamines. Examples of dicarboxylic acids that can be used may include 1,4-cyclohexanedicarboxylic acid, butanedioic, adipic, azelaic, suberic, sebacic, dodecanedioic, octadecanedicarboxylic, terephthalic and isophthalic acids, as well as dimerized fatty acids. As diamines, ethylenediamine, tetramethylenediamine, pentamethylenediamine, hexamethylenediamine or decamethylenediamine, 1,4-cyclohexanediamine, m-xylylenediamine or any other of the already mentioned diamines can be used.

Suitable polyamides for use as a polymeric matrix can be prepared by ring-opening polymerization of a cyclic lactam such as s-caprolactam or w-laurolactam. Suitable polyamides for use as a polymeric matrix can be prepared by polycondensation of aminocarboxylic acids such as 6-aminocaproic acid, 9-aminononanoic acid, 11-aminoundecanoic acid, or 12-aminododecanoic acid.

Suitable polyamides for use as the polymer matrix may be a polyamide-polyether copolymer (polyether blockamide, hereinafter referred to as PEBA). These copolymers can be obtained in the following three ways:
1) polycondensation of polyamide blocks with diamino groups at the ends of the chain with polyoxyalkylene blocks with dicarboxylic groups at the ends of the chain;
2) polyamide blocks with dicarboxylic groups at the ends of the chain with polyoxyalkylene blocks with diamino groups at the ends of the chain, obtained, for example, by cyanoethylation and hydrogenation of aliphatic polyether diols;
3) polyamide blocks with a dicarboxylic chain at the ends with polyetherdiols, the resulting products being polyetheretheramides in this particular case.

According to the first method, polyamide blocks may be obtained by the condensation of a dicarboxylic acid, in particular those having 4 to 20 carbon atoms, such as at least 4, at least 5, at least 6, at least 8, at least 10, at least 12, at least 14, at least 16, at least 18, and up to 20 carbon atoms, and an aliphatic or aromatic diamine, in particular those having 2 to 20 carbon atoms, such as at least 4, at least 5, at least 6, at least 8, at least 10, at least 12, at least 14, at least 16, at least 18, and up to 20 carbon atoms.

Dicarboxylic acids that can be used include 1,4-cyclohexanedicarboxylic acid, butanedioic, adipic, azelaic, suberic, sebacic, dodecanedicarboxylic, octadecanedicarboxylic, terephthalic and isophthalic acids, as well as dimerized fatty acids.

Examples of diamines may include tetramethylenediamine, hexamethylenediamine, 1,10-decamethylenediamine, dodecamethylenediamine, trimethylhexamethylenediamine and isomers. bis(4-aminocyclohexane)methane, bis(3-methyl-4-aminocyclohexane)methane and 2-2-bis(3-methyl-4-aminocyclohexane)propane, p-amino-di-cyclohexylmethane, isophoronediamine, 2.6-bis(aminomethyl)-norbornane and piperazine.

Polyamide blocks PA 4.12, PA 4.14, PA 4.18, PA 6.10, PA 6.12, PA 6.14, PA 6.18, PA 9.12, PA 10.10, PA 10.12, PA 10.14, and PA 10.18 are mainly used for the synthesis of PEBA according to the first method. In the PA X.Y notation, X is the number of carbon atoms contained in the parent diamine chain and Y is the number of carbon atoms contained in the parent dicarboxylic acid chain.

According to the second synthesis method, polyamide blocks may result from the condensation of one or more α, ω-aminocarboxylic acids and/or one or more lactams containing from 6 to 12 carbon atoms in the presence of a diamine or a dicarboxylic acid having from 4 to 12 carbon atoms. Examples of suitable lactams may include caprolactam, 1-aza-2-cyclooctanone and lauryl lactam. Examples of α, ω-aminocarboxylic acids may include aminocaproic, amino-7-heptanoic, amino-11-undecanoic, and amino-12-dodecanoic acids.

The second type of polyamide blocks may include blocks of PA 11 (polyundecanamide), PA 12 (polydodecanamide) or PA 6 (polycaprolactam). In the PA X notation, X is the number of carbon atoms contained in the chain of the original diamine.

According to a third synthesis method, polyamide blocks may be formed by the condensation of at least one α, ω-aminocarboxylic acid (or lactam), at least one diamine, and at least one dicarboxylic acid.

In this case, blocks of polyamide PA may be obtained by the polycondensation method.
1) linear or aromatic aliphatic diamine or diamines containing X carbon atoms; 2) dicarboxylic acid or acids containing Y carbon atoms; as well as
3) a comonomer or comonomers selected from lactams and α, ω-aminocarboxylic acids containing Z carbon atoms, and equimolar mixtures of at least one diamine having X1 carbon atoms and at least one dicarboxylic acid having Y1 carbon atoms, where (X1, Y1) is different from (X, Y),
wherein the comonomer or comonomers (3), in the presence of a chain terminator selected from dicarboxylic acids, may be added in a weight ratio of up to 50% to the other starting monomers (1 and 2).

Dicarboxylic acid (2) may be used as a chain terminator, introducing it in excess compared to the stoichiometric ratio to diamine or diamines.

To obtain a polyamide block according to the third method, aminocaproic, amino-7-heptanoic, amino-11-undecanoic and amino-12-dodecanoic acids can be used as an aliphatic α, ω-aminocarboxylic acid. Caprolactam, 1-aza-2-cyclooctanone and lauryl lactam may be used as examples of lactam. Hexamethylenediamine, dodecamethylenediamine and trimethylhexamethylenediamine can be cited as examples of aliphatic diamines. 1,4-cyclohexyldicarboxylic acid may be mentioned as an example of cycloaliphatic dibasic acids. As examples of aliphatic dibasic acids, one can use butanedioic, adipic, azelaic, suberic, sebacic, dodecanedioic acids, polyoxyalkylenes α, ω-diacids, and dimerized fatty acids. These dimerized fatty acids may have a dimer content of at least 98% and may be hydrogenated. As examples of aromatic dibasic acids, one can mention terephthalic and isophthalic acids. As examples of cycloaliphatic diamines, one can mention the isomers of bis (4-aminocyclohexane) methane, bis (3-methyl-4-aminocyclohexane) methane and 2-2-bis-(3-methyl-4-aminocyclohexane) propane and para-amino-dicyclohexylmethane. Other commonly used diamines may be isophorone diamine, 2,6-bis(aminomethyl)norbornane, and piperazine.

The following can be mentioned as examples of polyamide blocks of the third type:
a. PA 6.6/6 where 6.6 denotes hexamethylenediamine units condensed with adipic acid and 6 denotes units formed by condensation of caprolactam;
b. PA 6.6/6.10/11/12 where 6.6 is adipic acid condensed hexamethylenediamine, 6.10 is sebacic acid condensed hexamethylenediamine, 11 is aminoundecanoic acid condensed hexamethylenediamine and 12 is lauryl lactam condensed hexamethylenediamine.

Designations PA X/Y, PA X/Y/Z, etc. refer to copolyamides in which X, Y, Z, etc. are homopolyamide units such as those described above.

The polyamide blocks of the copolymer used in the invention may include the polyamide blocks PA 6, PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14.1, PA 10.14.1 10.18, PA 10.36, PA 10.T, PA 12.4, PA 12.9, PA 12.10, PA 12.12, PA 12.13, PA 12.14, PA 12.16, PA 12.18, PA 12.36, PA 12.T or mixtures or copolymers thereof.

Polyether blocks in the copolymer consist of alkylene oxides, in particular, they can be PEG (polyethylene glycol) blocks, i.e. consisting of units of ethylene oxide, and/or blocks of PPG (propylene glycol), i.e. consisting of units of propylene oxide, and/or blocks of PO3G (polytrimethylene glycol), i.e. consisting of glycol polytrimethylene ether units and/or PTMG blocks, i.e. consisting of tetramethylene glycol units, also called polytetrahydrofuran units. PEBA copolymers can contain several types of polyethers in their chain, while polyethers can be block or random.

It is also possible to use blocks obtained by the oxyethylation of bisphenols, such as, for example, bisphenol A.

The polyether blocks may also be composed of ethoxylated primary amines.

The flexible polyether blocks may contain amino-terminated polyoxyalkylene blocks, and such blocks can be prepared by cyanoacetylation of aliphatic α,ω-dihydroxylated polyoxyalkylene blocks called polyetherdiols.

Polyetherdiol blocks may be either used as such and copolycondensed with carboxyl-terminated polyamide blocks or they may be aminated to form polyether diamines and condensed with carboxyl-terminated polyamide blocks.

Examples of commercially available polyfyrblockamides can be PEBAX® sold by Arkema, Vestamid® sold by Evonik®, Grilamid® sold by EMS, Pelestat® sold by Sanyo.

In various aspects, thermoplastic polyesters, in particular, polylactides (hereinafter, polylactides may be referred to under the abbreviation PLA) can be used as a polymeric matrix.

The term PLA refers to a range of polymers derived from lactic acid. Depending on its composition, PLA can be an amorphous, semi-crystalline, or crystalline polymer. The raw material for PLA production is a renewable resource, which causes an increased interest in this class of polymers.

The starting monomer for PLA production occurs in two stereoisomers, namely L-lactic acid and D-lactic acid. The polylactides thus comprise a certain proportion of L-lactic acid monomers and a certain proportion of D-lactic acid monomers. The ratio between L- and D-lactic acid monomers in PLA determines its properties. This ratio is also known as “D value” or “D content”, which is the percentage of D-lactic acid monomers in the polylactide. Commercially available polylactides typically have an L:D ratio of 100:0 to 75:25; in other words, the D content is 0 to 25% or 0 to 0.25. When PLA contains more than 12% D-lactic acid, the polymer based on it cannot crystallize and is therefore completely amorphous. When the content of D is not more than 5%, PLA is a semi-crystalline polymer. The crystallinity of PLA can be determined using differential scanning calorimetry (DSC). The term “semi-crystalline” means that the polymer is capable of crystallizing as well as melting. Thus, it can be argued that the lower the D content, the higher the crystallinity of PLA. The D content is usually determined using gas liquid chromatography (GLC) after complete hydrolysis of the polymer. Another standard method is detection by optical rotation.

As a polymer matrix in the described invention, both amorphous and semi-crystalline, and crystalline polylactides can be used. Examples of commercially available PLAs are the polylactides available from NatureWorks© LLC, Minnetonka, MN, USA Ingeo under the brand names 4032D, 2003D, and 4060D (with 1.4%, 4.3% and 12.0% D-lactide, respectively).

In one set of embodiments, a foaming agent is provided in the form of granules comprising a base polymer and the foaming agent. As used herein, such granules are referred to as “foaming granules”. Foaming granules may comprise a plurality of foaming agents. A mass fraction of the foaming agents in foaming granules may be in a range from 0.1 wt % to 95 wt % (preferably from 2 wt % to 35 wt %). Preferably, to ensure a substantially accurate feed rate of the foaming agents and therefore to ensure substantially accurate control of the volumetric flow rate of the extruder and deposited foam density during the 3D printing process, foaming granules with a substantially constant mass fraction of the foaming agents between granules may be used.

According to this set of embodiments, foaming granules may comprise a core and a shell at least partially encapsulating the core. In this document, such foaming granules are referred to as encapsulated foaming granules. Cores can have various geometries, such as cubic, trapezoidal, cylindrical, ellipsoidal, spherical, or any of a variety of shapes. In embodiments, cores with equivalent spherical diameters in a range from about 0.2 to about 10 mm (preferably in a range from about 0.8 to about 6 mm) can be used. Preferably, the shell may cover at least ¾ of the surface of the core. In this document, if the shell covers at least ¾ of the surface of the core, the shell is said to substantially encapsulate the core. The thickness of the shell may be in a range from about 0.001 mm to about 4 mm (preferably from about 0.01 to about 3 mm).

Further according to this set of embodiments, the core of encapsulated foaming granules may comprise a base polymer; and the shell of encapsulated foaming granules may comprise a carrier polymeric material, also referred to as carrier material, and one or more foaming agents dispersed in the carrier material. Alternatively, or in addition, the core may comprise a carrier material and one or more foaming agents dispersed in the carrier material and the shell may comprise a base polymer. Without limitation, carrier materials suitable for the use according to the present invention may be thermoplastic resins. Preferably, thermoplastic resins with substantially low melt viscosity at 10-20 degrees Celsius below the activation temperature of the foaming agent with the lowest activation temperature among the foaming agents contained in such encapsulated foaming granules may be used as the carrier material to facilitate better compounding without activation of the foaming agents during the production of such encapsulated foaming granules. For example, for a foaming agent with the activation temperature of 200 degrees Celsius, the carrier material may have the melt flow rate (MFR) of no less than 10 g/10 min measured at 190 degrees and 10 Kg load. Preferably, the carrier material may be taken from the same type of thermoplastics as the base polymer. For example, a plasticized base polymer may be employed as the carrier material. In general, any polymer or polymeric composition can be used as the carrier material as long as it can be processed by extrusion together with the base polymer and as long as it provides sufficient bonding to the base polymer for preventing premature separation from the base polymer during feeding and/or extrusion. In preferred embodiments, such encapsulated foaming granules are produced by co-extrusion wherein the base polymer is co-extruded with a composition comprising the carrier material, and further comprising the foaming agents. In preferred embodiments, encapsulated foaming granules produced by co-extrusion have a cylindrical shape and either a shell comprising the carrier polymeric material and the foaming agents covers a cylindrical core comprising the base polymer or a shell comprising the base polymer covers a cylindrical core comprising the carrier polymeric material and the foaming agents. In encapsulated granules produced by co-extrusion, the shell may cover the curved surface of the cylindrical core and possibly none of the cylinder bases. Preferably, the thickness of the shell of encapsulated foaming granules produced by co-extrusion may be in range from 0.1 mm to 3 mm.

Alternatively, or in addition, the core of encapsulated foaming granules may comprise a base polymer; and the shell of encapsulated foaming granules may comprise one or more foaming agents in the form of solid particles and a binder system that binds the foaming agent particles to the core. Preferably, a mass fraction of the foaming agents in such encapsulated foaming granules may be no more than 25 wt %. A mass fraction of the binder system in the composition of such encapsulated foaming granules may be no more than 35 wt % (preferably no more than 15 wt %). Preferably, the thickness of the shell of such encapsulated foaming granules may be in a range from 0.01 mm to 1 mm. Polymers or mixtures of polymers may be used as the binder system, such as, for example: polyurethanes, polyacrylates, polyamides, polyesters, epoxy polymers, EVA, polyvinyl alcohol, polyvinyl acetate, polyethylene glycol, polyisocyanates, etc. It should be noted that other substances and/or their mixtures can be used as the binder system if it provides sufficient adhesion of the foaming agent particles to the core to exclude premature separation of the foaming agent particles from the core during extrusion. The binder system may be obtained via a reaction of monomers and/or oligomers in the process of manufacturing of such encapsulated foaming granules. Such encapsulated foaming granules may be produced by coating the cores with particles of the foaming agents dispersed in a dispersion medium. In some embodiments, the coating may be applied by a drum coater. In some embodiments, the coating may be applied by a fluidized bed method. Examples of dispersion mediums may be polymeric dispersions, including polyurethane aqueous dispersions, acrylic aqueous dispersions, epoxy aqueous dispersions, or mixtures thereof. Other examples of dispersion mediums include polymeric melts. Other examples of dispersion mediums include polymeric solutions. The use of cores of spherical or ellipsoidal shape and substantially uniform dimensions may be advantageous.

Alternatively, or in addition, foaming granules may comprise a mixture of a base polymer and one or more foaming agents. Such foaming granules are further referred to as premixed granules. The mixture may further comprise a carrier material to facilitate better compounding of the base polymer and the foaming agents. Preferably, thermoplastic resins with substantially low melt viscosity at 10-20 degrees Celsius below the activation temperature of the foaming agent with the lowest activation temperature among the foaming agents contained in the premixed granules may be used as the carrier material to facilitate better compounding without activation of the foaming agents during the production of the premixed granules. For example, for a foaming agent with the activation temperature of 200 degrees Celsius, the carrier material may have the melt flow rate (MFR) of no less than 10 g/10 min measured at 190 degrees and 10 Kg load. Preferably, the carrier material may be taken from the same type of thermoplastics as the base polymer. For example, a plasticized base polymer may be employed as the carrier material. In general, any polymer or polymeric composition can be used as the carrier material as long as it can be processed by extrusion together with the base polymer. In some embodiments, a foaming agent used in premixed granules may be a physical foaming agent. Examples of physical foaming agents include volatile organic compounds, in particular alkanes, for example, the isomers of butane, pentane, heptane, and octane. It is particularly preferable to coat premixed granules saturated with a physical foaming agent with a gas-tight polymeric coating

Foaming granules may further comprise additives such as kickers, surfactants, solvents, plasticizers, stabilizers, pigments, dyes, fillers, and the like. For example, the additives may be used to enhance the properties of polymeric foam, the properties of the extrusion process, the distribution of foaming agents, and the manufacturability of foaming granules. The additives can be introduced by dispersing them in a binder system, admixing them with a carrier material or directly admixing them with a base polymer by any known methods, for example, by methods discussed above. A mass fraction of the additives (excluding foaming agents) in foaming granules may be in a range from 0 wt % to 30 wt % (preferably from 0 wt % to 10 wt %).

In embodiments, a foaming agent may be provided in the form of masterbatch granules. As used herein, the term “masterbatch granules” refers to granules comprising the at least one foaming agent and a carrier material. Preferably, thermoplastic resins with substantially low melt viscosity at 10-20 degrees Celsius below the activation temperature of the foaming agent with the lowest activation temperature among the foaming agents contained in the masterbatch granules may be used as the carrier material to facilitate a uniform distribution of the foaming agents within the carrier material during the production of the masterbatch granules without activation of the foaming agents during the production. For example, for a foaming agent with the activation temperature of 200 degrees Celsius, the carrier material may have the melt flow rate (MFR) of no less than 10 g/10 min measured at 190 degrees and 10 Kg load. Preferably, the carrier material is taken from the same type of thermoplastics as the base polymer. For example, a plasticized base polymer may be employed as the carrier material. In general, any polymer or polymeric composition can be used as the carrier material as long as it can be processed by extrusion together with the base polymer and as long as it provides sufficient strength to the masterbatch granules for preventing premature breakdown of the masterbatch granules during feeding and/or extrusion. A mass fraction of the foaming agents in the masterbatch granules may be in a range from 5 wt % to 95 wt % (preferably from 30 wt % to 80 wt %). Masterbatch granules may have various geometries, such as cubic, trapezoidal, cylindrical, ellipsoidal, spherical, or any of a variety of shapes. In embodiments, masterbatch granules with the equivalent spherical diameters in a range from about 0.2 to about 10 mm (preferably in a range from about 0.8 to about 6 mm) can be used.

In embodiments, a foaming agent may be provided in the form of masterbatch filament. As used herein, the term “masterbatch filament” refers to a filament comprising at least one foaming agent and a carrier material. The carrier material may be the same carrier material discussed above in connection with masterbatch granules. For example, a plasticized base polymer may be employed as the carrier material. In general, any polymer or polymeric composition can be used as the carrier material as long as it can be processed by extrusion together with the base polymer and as long as it provides sufficient strength to the masterbatch filament for preventing premature breakdown of the masterbatch filament during feeding. A mass fraction of the foaming agents in the masterbatch filaments may be in a range from 5 wt % to 95 wt % (preferably from 30 wt % to 80 wt %). Without limitation. the diameter of the masterbatch filament may be in a range from 0.5 to 10 mm (preferably in a range from 1.5 to 4 mm). Masterbatch filaments may have a transverse cross-section of various geometries, such as cylindrical, ellipsoidal, square, or any of a variety of shapes. In embodiments, without limitation, masterbatch filaments with the equivalent circular diameters in a range from about 0.5 to about 10 mm (preferably in a range from about 1.5 mm to about 4 mm) can be used.

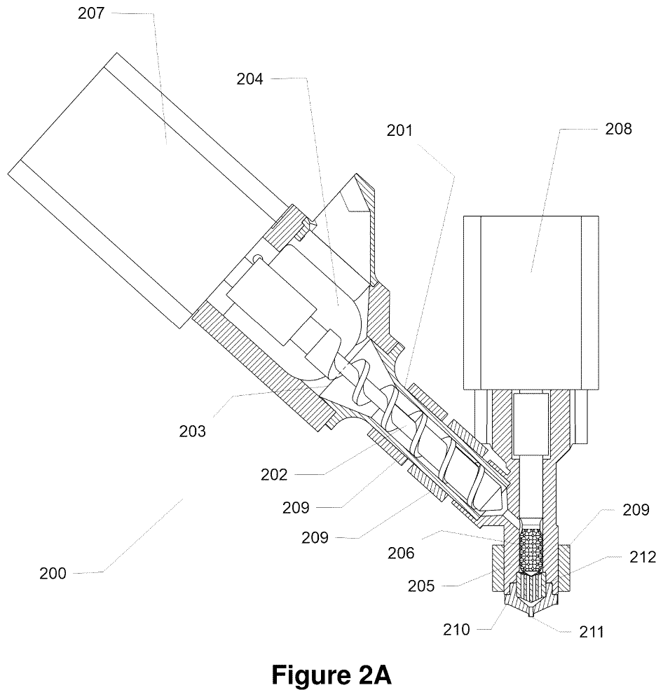

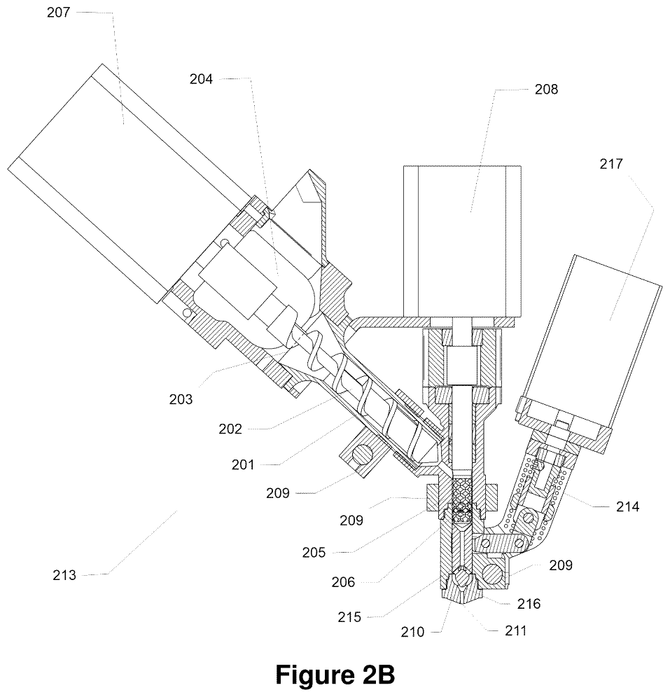

The present invention provides, according to one set of embodiments, a method that involves processing raw materials including at least one foaming agent provided in the form of foaming granules by a 3D printing system described in connection with FIG. 1. One advantage of using the foaming granules is that the foaming agents can be distributed more evenly in the volume of raw materials which is beneficial for desktop 3D printing of polymeric foams where a large volume of a granule relative to the volume of the polymer processing space generally precludes producing polymeric foams with substantially stable properties from granules where only a minority of granules comprise the foaming agent. In this set of embodiments, it is preferable to maintain a mass fraction of the foaming granules among the raw materials that are being processed at a level above 50 wt %, more preferably above 90 wt %. It is preferable to use an extruder (as described in connection with FIG. 1) with a pressure-generating mechanism capable of positive displacement conveying in contrast to dragging conveying to establish a stream of granules, such as the foaming granules and/or granules of the base polymer. Positive displacement conveying in this document should be understood as conveying by displacing a trapped volume within the polymer processing space of an extruder and/or conveying by exerting normal contact forces on granules where friction forces oppose conveying rather than drive it (for example, conveying mechanism in a single-screw extrusion mechanism with grooved barrel and in a scroll extrusion mechanism with grooved barrel). One advantage of such pressure-generating mechanism for 3D printing is that it may provide a substantially constant mass flow rate of the stream independent of the viscosity of the stream and the back pressure enabling accurate control of the mass flow rate that is necessary, although not sufficient, for further control of the volumetric flow rate and the density of a polymeric foam required for 3D printing. To facilitate positive displacement conveying, in preferred embodiments, the pressure-generating mechanism for establishing the stream is selected from a group consisting of: a single-screw extrusion mechanism with grooved barrel, an intermeshing twin-screw extrusion mechanism, an intermeshing tri-screw extrusion mechanism, a scroll extrusion mechanism with grooved barrel, a vane extrusion mechanism, a progressive cavity extrusion mechanism. An example of an extruder 200 (consistent with description of extruder 101 in connection with FIG. 1) intended for use in a 3D printing system (as described in connection with FIG. 1) for this set of embodiments is shown in FIG. 2A. The extruder 200 shown in FIG. 2A uses a single-screw extrusion mechanism with grooved barrel 201 to establish the stream, but it should be understood by those skilled in the art that any pressure-generating mechanism selected from a group consisting of: a single-screw extrusion mechanism, a twin-screw extrusion mechanism, a tri-screw extrusion mechanism, a scroll extrusion mechanism, a vane extrusion mechanism, a progressive cavity extrusion mechanism, a ram extrusion mechanism; may be employed instead or in addition as long as it provides positive displacement conveying of the foaming granules. The extruder 200 may include a barrel 201 having one or more grooves (not shown) provided in the inner surface of the barrel 201 and further having an inlet 203 configured to receive granules, such as the foaming granules and/or granules of the base polymer. The extruder 200 may include a compartment 204 for containing the granules to be fed into the barrel 201 through inlet 203. Mounted for rotation within the barrel 201 may be a screw 202 operably connected to a motor 207 providing rotational power to the screw 202. The motor 207 may be connected to the control system of the 3D printing system which may be further configured to control the feed rate of the granules by adjusting the rotational speed of the screw 202. The barrel 201, the screw 202 and the motor 207 may constitute the pressure-generating mechanism. The extruder 200 may further include a mixing chamber 205 fluidly connected with the barrel 201. The mixing chamber 205 and the barrel 201 can be separate parts assembled as shown in FIG. 2A. Alternatively, mixing chamber 205 and barrel 201 can make up a single part or assembly unit. Screw 202 may be configured to compress the granules and establish a stream of pelletized or melted granules in a downstream direction from the inlet 203 toward the mixing chamber 205. The extruder 200 may further comprise a nozzle 210 located downstream of the mixing chamber 205, the nozzle 210 comprising an outlet 211 fluidly connected with the inlet 203, the outlet 211 configured to release the stream from the polymer processing space of the extruder 200. For embodiments, where the nozzle 210 has multiple exit orifices configured to release the stream from the polymer processing space of the extruder 200, it is understood that they together form the outlet 211. The extruder 200 may further comprise a breaker plate 212 located downstream of the mixing chamber 205 and upstream of the outlet 211. The breaker plate 212 can be a separate part as shown in FIG. 2A. Alternatively, the breaker plate 212 can make up a single part or assembly unit with the mixing chamber 205 or the nozzle 210.

The extruder 200 comprises an independent mixing rotor 206 mounted for rotation about a rotational axis (the rotational axis may move in space, for example, if the independent mixing rotor 206 performs a complex motion) within the mixing chamber 205. Pressure-generating mechanisms providing positive displacement conveying generally cannot at the same time provide sufficient plasticization and mixing for desktop 3D printing of polymeric foams because of low rotational speeds of their rotating members such as the screw 202 inherent to desktop 3D printing. One advantage of using the independent mixing rotor 206 is that it can provide quality distributive and/or dispersive dynamic mixing even at flow rates inherent to desktop 3D printing, such as in a range from 0.2 cm³/min to about 20 cm³/min, where static mixing generally cannot be usefully employed because of low energy of the flow. Another advantage of using the independent mixing rotor 206 is that it may be used to control plasticization and mixing of streams independently from the mass flow rate of extrusion. Preferably, the independent mixing rotor 206 may be operably connected to a dedicated motor 208 providing the rotational power. Alternatively, the independent mixing rotor 206 may be operably connected to the motor 207 providing the rotational power through a step-up gearbox. The independent mixing rotor 206 may have any form suitable for mixing. For example, the independent mixing rotor 206 may have a shaft and mixing elements extending radially from the shaft, such as a pineapple mixer, a pin mixer or the like. The independent mixing rotor 206 may be surrounded by a stator and may be further configured to interact with it. The stator may be formed by the mixing chamber 205 or it can be a separate part. For example, the independent mixing rotor 206 may be rotated inside a stator having pins, extending inwardly into the polymer processing space of the extruder 200, the independent mixing rotor 206 having mixing element extending outwardly towards the stator that pass or “wipe” the pins periodically when the independent mixing rotor 206 is rotating providing high shear mixing in regions between the mixing elements and the pins. As another example, the independent mixing rotor 206 may constitute the sun rotor of a planetary mixer. In embodiments, a planetary mixer may comprise the independent mixing rotor 206 having a teething on its outer surface and may be surrounded by a stator having a teething on its inner surface. Between the independent mixing rotor 206 and the stator there may be one or more planetary rotors disposed configured to roll around the independent mixing rotor 206 as it rotates. As another example, the independent mixing rotor 206 may constitute a cavity transfer mixer. In embodiments, the inner surface of the mixing chamber 205 may have one or more circumferentially extending rows of cavities and the outer surface of the independent mixing rotor 206 that faces the inner surface of the mixing chamber 205 may have one or more circumferentially extending rows of cavities that axially overlap with the rows provided in the inner surface of the mixing chamber 205. As another example of a cavity transfer mixer, the independent mixing rotor 206 may be surrounded by a floating sleeve having an inner surface facing the outer surface of the independent mixing rotor 206 and an outer surface facing the inner surface of mixing chamber 205. There may be further a plurality of annularly extending rows of flow channels formed by the outer surface of the sleeve separated by outwardly extending rings. The independent mixing rotor 206 may further have a plurality of annularly extending rows of cavities separated by outwardly extending rings which engage the inner surface of the floating sleeve; the cavities in fluid communication with the flow channels through a plurality of apertures which extend through the sleeve. As another example, the independent mixing rotor may 206 may comprise a plurality of deflector elements distributed within the mixing chamber 205, possibly intersecting the rotational axis of the independent mixing rotor (e.g., the independent mixing rotor 206 having a portion along the rotational axis comprised entirely of deflector elements), each deflector element defining a surface which is inclined to the rotational axis such that a stream is deflected by the surface in a direction transverse to that axis. The deflector elements may divide streams passing through the mixing passageway of the independent mixing rotor 206 into smaller streams, may further divide the smaller streams into even smaller streams and so forth. Streams may be recombined upstream thereby providing distributive mixing, meanwhile the rotation of the independent mixing rotor 206 may provide dispersive mixing. The independent mixing rotor 206 may be a disk having a plurality of mixing elements extending axially from the disk. More generally, any form of the independent mixing rotor 206 suitable for distributive and/or dispersive mixing may be employed. There may be one or more independent mixing rotors 206 mounted for rotation within the polymer processing space. For example, two independent mixing rotors 206 may rotate in close proximity providing a high shear mixing in regions between their facing surfaces. As another example of a plurality of independent mixing rotors 206, the sun rotor and the planetary rotors of a planetary mixer may all be independent mixing rotors 206.

Preferably, the independent mixing rotor 206 is configured to rotate without producing substantial deviations in the discharge pressure which is especially beneficial to 3D printing of polymeric foams. This can be achieved by using a configuration of the independent mixing rotor 206 which does not contribute to the discharge pressure. For example, the surfaces of the mixing elements that exert non-zero pressure along the axis of rotation of the independent mixing rotor 206 in the downstream direction of the polymer processing space may be balanced by surfaces of the mixing elements that exert equal non-zero pressure along the axis of rotation of the independent mixing rotor 206 in the upstream direction of the polymer processing space such that the total pressure contributed to the discharge pressure is approximately zero. For example, in preferred embodiments, the rotating independent mixing rotor 206 may have a shaft with a central axis coinciding with the axis of rotation and further have cylindrical pins extending radially from the shaft.

Temperature control units 209 may be positioned along barrel 201, mixing chamber 205, and the nozzle 210; and may be used to maintain a set temperature profile along the polymer processing space. These may include electrical heaters coupled with temperature sensors. Temperature control units 209 may also include passageways for temperature control fluid, and the like. Temperature control units 209 may be connected to the control system (shown in FIG. 1) of the 3D printing system and can be used to heat and/or cool a stream of pelletized or fluid materials within polymer processing space to facilitate melting of the stream, and/or facilitate activation of the foaming agent contained in the stream, and/or control compression of the granules, and/or control a degree of activation of the foaming agent, and/or control the viscosity of the stream, etc.

The extruder 200 may further comprise a control valve. An example of such extruder 213 is shown in FIG. 2B. The example of extruder 213 shown in FIG. 2B has the same elements as the extruder 200 described in connection with FIG. 2A except having a control valve 214. The control valve 214 may be configured to vary the size of a flow passage downstream of the independent mixing rotor 206. States of the control valve with different sizes of the flow passage are further referred to as positions of the control valve. Preferably, the control valve may be of the needle valve type. The control valve 214 may be of other types, such as ball valve type, butterfly valve type, globe valve type, etc. The control valve 214 may comprise a plunger 215 as a movable part, and a seat 216. Other examples of the movable part include a ball, a vane, a plug, etc. Without limitation, the seat may make up a single part or assembly unit with other parts of the extruder 213. For example, the seat 216 and the nozzle 210 may make up a single part as shown in FIG. 2B. The movable part may be configured to be positioned relative to the seat 216 such that the size of the flow passage between the movable part and the seat 216 is varied by the positioning of the movable part. The control valve 214 may be actuated by an electrical motor 217 operably connected to the movable part and configured to adjust the position of the movable part relative to the seat 216. In embodiments, the control valve 214 may be actuated by other actuators such piezoelectric actuator, solenoid, pneumatic actuator, hydraulic actuator, and combinations thereof. The control valve 214 may be connected to the control system of the 3D printing system that may be also connected to the positioning system of the 3D printing system configured to create a relative motion of the extruder 213 relative to the build surface (shown in FIG. 1). The control valve 214 may be used to adjust the flow of the stream from the outlet 211 depending on the position of the nozzle 210 relative to the build surface. For example, the control valve 214 may be configured to stop the flow before the extruder 213 performs a travel move during the 3D printing process.

The control valve 214 may be used to adjust the pressure in the polymer processing space and particularly adjust the pressure in the mixing chamber 205. For example, in embodiments where at least one foaming agent is thermally expandable microspheres, the control valve 214 may be configured to reduce the size of the flow passage such that the pressure in the mixing chamber 205 is increased to a level where the microspheres may be admixed at a temperature sufficiently high for mixing (i.e. temperature where the melt of the base polymer has sufficiently low viscosity for efficient dynamic mixing by the rotating independent mixing rotor 206) without excessive expansion of the microspheres. As another example, in embodiments where at least one foaming agent is a chemical blowing agent, the control valve 214 may be used to increase the solubility of the decomposition products of the chemical blowing agent in the melt of the base polymer by increasing the pressure in the mixing chamber 205. As another example, in embodiments where at least one foaming agent is thermally expandable microspheres, the control valve 214 may be used to control the density of the extruded polymeric foam by adjusting the pressure in the mixing chamber 205 thereby adjusting the degree of expansion of the microspheres in the extruded polymeric foam.

In embodiments, the extruder 200 may comprise one or more pressure sensors (not shown) connected to the control system of the 3D printing system and configured to measure the pressure within the polymer processing space of the extruder 200. Readings from the pressure sensors may be used by the control system to adjust the mass flow rate of the stream of the granules, for example, by adjusting the rotational speed of the motor 207, to level off pressure fluctuations within the polymer processing space, which naturally arise from non-uniformity of granule sizes, non-uniformity of concentrations of the foaming agents in foaming granules, fluctuations of the contact pressure during the 3D printing process, etc. Alternatively, or in addition, in embodiments where the extruder 200 comprises a control valve, readings from the pressure sensors may be used by the control system to further level off pressure fluctuations by adjusting the position of the control valve.

A stream of pelletized or melted foaming granules and possibly other granules in the downstream direction toward the mixing chamber 205 and further toward the outlet 211 may be established by the screw 202 rotating within the barrel 201. The method further describes establishing a fluid phase of the stream, the fluid phase comprising a melt of the base polymer, by heating the stream with temperature control units 209 and/or by heating the stream with the rotating independent mixing rotor 206 providing frictional or shear heating of the stream, thereby melting the base polymer contained in the steam. In embodiments where the foaming granules comprise a binder system, the binder system contained in the stream may be melted with temperature control units 209 and/or with the rotating independent mixing rotor 206 providing frictional or shear heating of the stream, and incorporated in the fluid phase. In embodiments where the foaming granules comprise a carrier material, the carrier material contained in the stream may be melted with temperature control units 209 and/or with the rotating independent mixing rotor 206 providing frictional or shear heating of the stream, and incorporated in the fluid phase. The fluid phase and the foaming agents may be admixed within the mixing chamber 205 by the rotating independent mixing rotor 206 to form a substantially homogeneous mixture of the foaming agents, the base polymer, and possibly the binder system, and possibly the carrier material within the stream. The mixture may comprise other components, for example, other raw materials and/or their derivatives. Those of ordinary skill in the art will determine a degree of homogeneity of the mixture to be considered substantial and will operate the independent mixing rotor 206 at sufficiently high rotational speed for producing such a mixture. The rotational speed of the independent mixing rotor 206 may be higher than 0.3 revolutions per second and may be higher than the rotational speed of the screw 202 (i.e., the independent mixing rotor 206 operates independently). The upper boundary on the rotational speed of the independent mixing rotor 206 is inherent to an implementation of the extruder 200 and should be understood by those skilled in the art. The rotational speed of the independent mixing rotor 206 may be higher than 0.3 revolutions per second and lower than 120 revolutions per second, preferably may be in a range from 1 revolution per second to 60 revolutions per second, more preferably may be in a range from 1 revolution per second to 25 revolutions per second. Rotational speeds of the independent mixing rotor higher than 60 revolutions per second would require an overly powerful motor 208 which is of little practical interest in context of desktop 3D printing which is the primary focus of this invention. Rotational speeds higher than 25 revolutions per second in some cases, particularly in extruders 200 with the independent mixing rotor 206 of a large diameter (more than 30 mm), may result in excessive viscous heating and/or damage to the base polymer and/or the foaming agent caused by an excessive shear stress that may be generated by such rotational speeds. A mass fraction of the foaming agents in the mixture may be no more than 25 wt % and preferably may be in a range from 2 wt % to 15 wt %. In this document, the mass fraction of the foaming agents in the mixture may refer to a mass fraction of the foaming agents as well as products of their activation (for example, gases produced by activation of a chemical blowing agent) in the mixture. The mass fraction of the foaming agents in the mixture may also refer to a mass fraction of the foaming agents in raw materials before they are fed to the extruder and processed into the mixture. Those skilled in the art may not differentiate between these meanings when no substantial mass escapes the polymer processing space other than from the outlet 211, otherwise preferring the former meaning. Without limitation, it was determined that the mass fraction of the foaming agents in the mixture for producing polymeric foams with relative densities in a range from 0.09 to 0.14 may be in a range from 25 wt % to 15 wt % respectively; the mass fraction of the foaming agents for producing polymeric foams with relative densities in a range from 0.14 to 0.21 may be in a range from 25 wt % to 8 wt % respectively, preferably in a range from 15 wt % to 8 wt % respectively; the mass fraction of the foaming agents for producing polymeric foams with relative densities in a range from 0.21 to 0.51 may be in a range from 15 wt % to 2 wt % respectively, preferably in a range from 8 wt % to 2 wt % respectively; the mass fraction of the foaming agents for producing polymeric foams with relative densities in a range from 0.51 to approximately 1 may be no more than 15 wt %, preferably no more than 8 wt %. Those skilled in the art may use the above values for producing a polymeric foam of some target density. Those skilled in the art may further increase the mass fraction to reduce density and/or reduce average cell size. Alternatively, those skilled in the art may further decrease the mass fraction to increase density and/or increase average cell size.

Temperature control units 209 may be used to heat the mixture to a temperature exceeding the activation temperature of the at least one foaming agent (heating the mixture to a temperature means heating at least a portion of the mixture to the temperature), therefore activating the at least one foaming agent to form a polymeric foam that is released from the polymer processing space through the outlet 211 of the nozzle 210. Preferably, the activation of the foaming agent does not produce substantial deviations in the discharge pressure which is especially beneficial to three-dimensional printing. This may be achieved by selecting the temperature profile such that most of the activation of the foaming agent happens after the mixture is homogenized to a level where the activation of the foaming agent does not produce substantial deviations in the discharge pressure. Alternatively, or in addition, the pressure within the mixing chamber 205 may be increased with the control valve 214 to facilitate later activation of the foaming agent. The later activation of the foaming agent improves homogenization by the time most of the activation of the foaming agent starts to happen and thereby reduces deviations of the discharge pressure. Those of ordinary skill in the art will determine a degree of the pressure deviations to be considered substantial and will set the temperature profile and optionally the position of the control valve 214 which level out these deviations.

The stream may be subjected to a pressure drop rate immediately before the outlet 211 of at least 1 MPa/sec (preferably at least 3 MPa/sec). The pressure drop rate immediately before the outlet 211 is exerted on some element of the stream located at a point of the polymer processing space of the extruder 200 may be calculated as the pressure at the point divided by the time until the element reaches the outlet 211. The pressure drop rate of at least 1 MPa/sec immediately before the outlet 211 can prevent excessive growth of the cells in the polymeric foam at a temperature of the nozzle 210 sufficiently high for the deposition of the polymeric foam during the 3D printing process. The pressure drop rate of at least 1 MPa/sec immediately before the outlet 211 can also keep the properties of the polymeric foam stable during the 3D printing process by isolating the pressure within the polymer processing space before the pressure drop from changes of the contact pressure under the nozzle 210. The changes in the contract pressure are inherent to the 3D printing process and happen because of travel moves and different overhang angles of the deposited material during the 3D printing process. A sufficiently high pressure drop rate immediately before the outlet 211 may be performed by adjusting the size of the flow passage of the control valve 214 where the flow passage is located at a distance not greater than 20 mm (preferably not greater than 10 mm) from the outlet 211. Those of ordinary skill in the art will find the position of the control valve which produces a sufficiently high pressure drop rate immediately before the outlet for a target volumetric flow rate of the extruder, for a target density of the polymeric foam and at a temperature of the nozzle 210 sufficiently high for deposition of the polymeric foam during the 3D printing process.

Alternatively, or in addition to producing the polymeric foam within the polymer processing space of the extruder 200, the method may include extruding the mixture containing at least one partially activated and/or non-activated foaming agent from the outlet 211 of the nozzle 210 and a step of activating the foaming agent after deposition by external heating (i.e., heating outside of the polymer processing space). In embodiments, devices configured to heat the deposited material with convection and/or infrared radiation may be used for external heating. For example, external heating may be performed by placing a 3D printed object comprising the mixture containing partially activated and/or non-activated foaming agent into a heating chamber at a temperature exceeding the activation temperature of the foaming agent and exceeding the glass transition temperature of the base polymer resulting in volumetric expansion of the 3D printed object. The ratio of volumetric expansion (ratio of the volume of the 3D printed object after expansion to the volume of the 3D printed object before expansion) may be in a range from 1 to 8, preferably in a range from 1 to 3. In this document, 3D printed object before expansion is referred to as as-printed object and 3D printed object after expansion is referred to as expanded object. The parameters of external heating, such as the duration of the external heating, the temperature within the heating chamber, the velocity of air within the heating chamber, the temperature ramp rate, etc., may be selected such that the foaming agents are activated throughout the volume of the 3D printed object before the geometry of the 3D printed object is distorted by sagging of the base polymer. Preferably, the 3D printed objects with wall thicknesses of not greater than 4 mm before expansion are subjected to shorter (not greater than 3 min) durations and higher temperatures (at least 10 degrees Celsius above the activation temperature) while the 3D printed objects with wall thicknesses above 4 mm before expansion are subjected to longer durations (at least 3 min) and low temperature ramp rates (not greater than 5 deg/min). Still, the external heating parameters are highly dependent on the base polymer, the foaming agent, and the geometry of a 3D object. Therefore, it is up to those of ordinary skill in the art to find the optimum settings. In embodiments comprising activation of the thermally expandable microspheres after deposition by external heating, it may be preferred to use microspheres having an activation temperature which can be reduced by at least 10 degrees Celsius (preferably by at least 20 degrees Celsius) to a second activation temperature by preheating them at a temperature below the initial activation temperature for some period of time. The feedstock materials comprising such microspheres may be extruded without activation at temperatures below the initial activation temperature and above the second activation temperature, where the viscosity of the stream can be sufficiently low for deposition. The microspheres may be preheated within the polymer processing space of the extruder 200 during the extrusion process and/or during external heating of the 3D printed object. The activation of the microspheres may be performed by external heating after the activation temperature of the microspheres reduces to the second activation temperature.

To facilitate the 3D printing of objects comprising a polymeric foam of variable density, the control system of the 3D printing system may further control the polymeric foam density during the 3D printing process in accordance with a predefined density map which assigns target densities to segments and/or points of a tool path. The control over the polymeric foam density may be performed by adjusting at least one parameter selected from a group consisting of: the set temperatures of the temperature control units 209, the size of the flow passage of the control valve 214, the feed rate of the foaming granules.

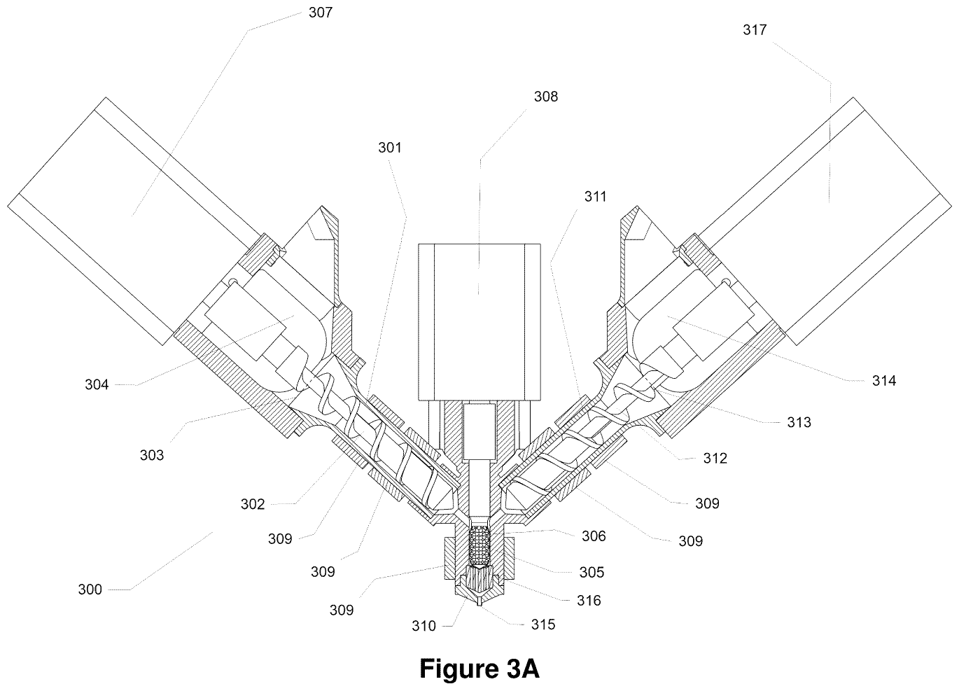

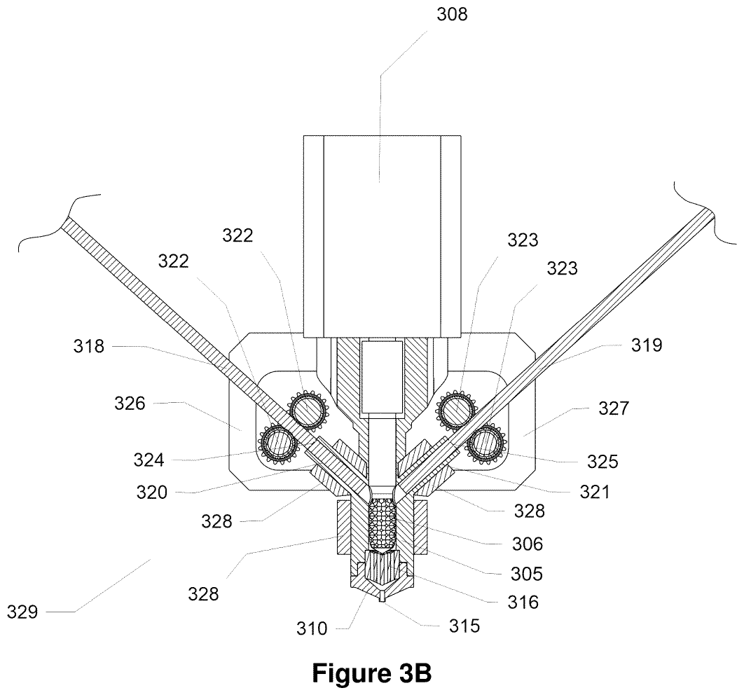

The present invention provides, according to one set of embodiments, a method that involves processing raw materials including at least one base polymer provided in the form of granules, further referred to as base granules, and further including at least one foaming agent provided in the form of masterbatch granules by a 3D printing system described in connection with FIG. 1. In this set of embodiments, it is preferable to establish a stream of the base granules and a stream of the masterbatch granules by separate pressure-generating mechanisms. As discussed in connection with FIG. 2A, it is preferable to use pressure-generating mechanisms capable of providing positive displacement conveying for establishing the streams. An example of an extruder 300 (consistent with description of extruder 101 in connection with FIG. 1) intended for use in a 3D printing system (as described in connection with FIG. 1) is depicted in FIG. 3A. The extruder 300 shown in FIG. 3A uses single-screw extrusion mechanisms with grooved barrels to establish the stream of the base granules and the stream of the masterbatch granules, but it should be understood by those skilled in the art that any pressure-generating mechanisms and their combinations selected from a group consisting of: a single-screw extrusion mechanism, a twin-screw extrusion mechanism, a tri-screw extrusion mechanism, a scroll extrusion mechanism, a vane extrusion mechanism, a progressive cavity extrusion mechanism, a ram extrusion mechanism; may be employed instead or in addition as long as they provide positive displacement conveying of the granules. The extruder 300 may include a barrel 301 having one or more grooves (not shown) provided in the inner surface of the barrel 301 and having an inlet 303 configured to receive the base granules and optionally other granules. The extruder 300 may include a compartment 304 for containing the granules to be fed into barrel 301 through inlet 303. Mounted for rotation within the barrel 301 may be a screw 302 operably connected to a motor 307. The motor 307 may be connected to the control system of the 3D printing system which may be further configured to control the feed rate of the base granules by adjusting the rotational speed of the screw 302. The barrel 301, the screw 302 and the motor 307 may constitute the pressure-generating mechanism for establishing the stream of base granules. The extruder 300 may further include a barrel 311 having one or more grooves (not shown) provided in the inner surface of the barrel 311 and having an inlet 313 configured to receive the masterbatch granules and optionally other granules. The extruder 300 may include a compartment 314 for containing the granules to be fed into barrel 311 through inlet 313. Mounted for rotation within the barrel 311 may be a screw 312 operably connected to a motor 317. The motor 317 may be connected to the control system of the 3D printing system which may be further configured to control the feed rate of the masterbatch granules. The barrel 311, the screw 312 and the motor 317 may constitute the pressure-generating mechanism for establishing the stream of masterbatch granules.

The system may further include a mixing chamber 305 fluidly connected with barrel 301 and barrel 311. Screw 302 may be configured to compress the base granules and establish a first stream of pelletized or melted base granules in a downstream direction from the inlet 303 toward the mixing chamber 305. Screw 312 may be configured to compress the masterbatch granules and establish a second stream of pelletized or melted masterbatch granules in a downstream direction from the inlet 313 toward the mixing chamber 305. The streams may be combined in the mixing chamber 305 as shown in FIG. 3A. In other embodiments, they can be combined upstream of the mixing chamber 305, for example when masterbatch granules are first fed into barrel 301 upstream of the mixing chamber 305. The extruder 300 further comprises a nozzle 310 located downstream of the mixing chamber 305, the nozzle 310 including an outlet 315 fluidly connected with the inlets 303 and 313, the outlet 315 configured to release the combined stream from the polymer processing space of the extruder 300. The extruder 300 may further comprise a breaker plate 316 located downstream of the mixing chamber 305 and upstream of the outlet 315. The breaker plate 316 can be a separate part as shown in FIG. 3A. Alternatively, the breaker plate 316 can make up a single part or assembly unit with the mixing chamber 305 or the nozzle 310.

As described above in connection with FIG. 2A, the extruder 300 comprises at least one independent mixing rotor 306 mounted for rotation within mixing chamber 305. Pressure-generating mechanisms providing positive displacement conveying generally cannot at the same time provide sufficient plasticization and mixing for desktop 3D printing of polymeric foams because of low rotational speeds of their rotating members such as the screws 302 and 312 inherent to desktop 3D printing. One advantage of using the independent mixing rotor 306 is that it can provide quality distributive and/or dispersive dynamic mixing even at flow rates inherent to desktop 3D printing, such as in a range from 0.2 cm³/min to about 20 cm³/min, where static mixing generally cannot be usefully employed because of low energy of the flow. Another advantage of using the independent mixing rotor 306 is that it may be used to control plasticization and mixing of streams independently from the mass flow rate of extrusion. Preferably, the independent mixing rotor 306 may be operably connected to a dedicated motor 308 providing the rotational power. Alternatively, the independent mixing rotor 306 may be operably connected to the motor 307 or the motor 317 providing the rotational power through a step-up gearbox.

As described above in connection with FIG. 2A, the extruder 300 may comprise temperature control units 309 that may be positioned along barrel 301, barrel 311, mixing chamber 305, and nozzle 310; the temperature control units 309 may be used to maintain a set temperature profile along the polymer processing space.

The extruder 300 may comprise a control valve (not shown) as described above in connection with FIG. 2B. The extruder 300 may comprise a pressure sensor (not shown) as described in connection with FIG. 2A.

A first stream of pelletized or melted base granules and possibly other granules in a downstream direction toward the mixing chamber 305 and further toward the outlet 315 may be established by the screw 302 rotating within the barrel 301. A second stream of pelletized or melted masterbatch granules and possibly other granules in a downstream direction toward the mixing chamber 305 and further toward the outlet 315 may be established by rotation of the screw 312 within the barrel 311. The method further describes establishing a fluid phase of the first stream by melting the base polymer with temperature control units 309 and/or by with the rotating independent mixing rotor 306 providing frictional or shear heating of the first stream; and establishing a fluid phase of the second stream by melting the carrier material with temperature control units 309 and/or with the rotating independent mixing rotor 306 providing frictional or shear heating of the second stream. The fluid phase of the first stream, the fluid phase of the second stream and the foaming agents may be admixed within the mixing chamber 305 by the rotating independent mixing rotor 306 to form a substantially homogeneous mixture of the foaming agents, the base polymer, and the carrier material within the combined stream. The mixture may comprise other components, for example, other raw materials and/or their derivatives. Those of ordinary skill in the art will determine a degree of homogeneity of the mixture to be considered substantial and will operate the independent mixing rotor 306 at a sufficiently high rotational speed for producing such a mixture. The rotational speed of the independent mixing rotor 306 may be higher than 0.3 revolutions per second and may be higher than each of the rotational speeds of the screw 302 and the screw 312 (i.e., the independent mixing rotor 306 operates independently). The upper boundary on the rotational speed of the independent mixing rotor 306 is inherent to an implementation of the extruder 300 and should be understood by those skilled in the art. The rotational speed of the independent mixing rotor 306 may be higher than 0.3 revolutions per second and lower than 120 revolutions per second, preferably may be in a range from 1 revolution per second to 60 revolutions per second, more preferably may be in a range from 1 revolution per second to 25 revolutions per second. Rotational speeds of the independent mixing rotor higher than 60 revolutions per second would require an overly powerful motor 308 which is of little practical interest in context of desktop 3D printing which is the primary focus of this invention. Rotational speeds higher than 25 revolutions per second in some cases may result in excessive viscous heating and/or damage to the base polymer and/or the foaming agent caused by an excessive shear stress that may be generated by such rotational speeds. A mass fraction of the foaming agents in the mixture may be no more than 25 wt %, preferably may be in a range from 2 wt % to 15 wt %. Those skilled in the art may choose the mass fraction for some target density of the polymeric foam based on the values discussed in connection to FIG. 2A.

Temperature control units 309 may heat the mixture to a temperature exceeding the activation temperature of the at least one foaming agent (heating the mixture to a temperature means heating at least a portion of the mixture to the temperature, for example, heating the second stream contained in the mixture to a temperature exceeding the activation temperature of the at least one foaming agent, which can be done by heating the first stream with temperature control units 309 to a temperature substantially higher than the activation temperature of the foaming agent prior to admixing it with the second stream, where a temperature of the second stream prior to admixing may be substantially lower than the temperature of the first stream), therefore activating the at least one foaming agent to form a polymeric foam that is released from the polymer processing space through the outlet 315 of the nozzle 310. Preferably, the activation of the foaming agent does not produce substantial deviations in the discharge pressure which is especially beneficial to three-dimensional printing. This may be achieved by selecting the temperature profile such that most of activation of the foaming agent happens after the mixture is homogenized to a level where the activation of the foaming agent does not produce substantial deviations in the discharge pressure. Alternatively, or in addition, the pressure within the mixing chamber 305 may be increased with the control valve 214 to facilitate later activation of the foaming agent. The later activation of the foaming agent improves homogenization by the time most of the activation of the foaming agent starts to happen and thereby reduces deviations of the discharge pressure. Those of ordinary skill in the art will determine a degree of the pressure deviations to be considered substantial and will set the temperature profile and optionally the position of the control valve 214 which level out these deviations.

The combined stream may be subjected to a pressure drop rate immediately before the outlet 315 of at least 1 MPa/sec (preferably at least 3 MPa/sec) as described above in connection with FIG. 2A and FIG. 2B.

Alternatively, or in addition to producing the polymeric foam within the polymer processing space of the extruder 300, the method may include a step of extruding the mixture containing at least one partially activated and/or non-activated foaming agent from the outlet 315 of the nozzle 310 and a step of activating the foaming agent after deposition by external heating as described above in connection with FIG. 2A and FIG. 2B.

Screw 312 may be used to feed the masterbatch granules into the stream of pelletized or melted base granules. Motor 317 can be connected to a control system (not shown) that may be also connected to the motor 307 to control the feed rate of the masterbatch granules in relationship to the feed rate of the base granules in order to precisely control a mass fraction of the foaming agents in the mixture and therefore control the polymeric foam density.

To facilitate the 3D printing of objects comprising a polymeric foam of variable density, the control system of the 3D printing system may further control the polymeric foam density in accordance with a predefined density map which assigns target densities to segments and/or points of a tool path. The control over the polymeric foam density may be performed by adjusting at least one parameter selected from a group consisting of: the set temperatures of the temperature control units 309, the size of the flow passage of the control valve, the feed rate of the base granules, the feed rate of the masterbatch granules.

Some embodiments may comprise processing a mixture of the masterbatch granules and the base granules instead of the foaming granules or in addition to the foaming granules with extruder 200 discussed in connection with FIG. 2A (Example 8). Some embodiments may comprise providing at least one foaming agent in the form of foaming granules and processing the foaming granules instead of the masterbatch granules or in addition to the masterbatch granules with extruder 300.

The present invention provides, according to one set of embodiments, a method that involves processing raw materials including at least one base polymer provided in the form of a filament, further referred to as base filament, and further including at least one foaming agent provided in the form of a masterbatch filament by a 3D printing system described in connection with FIG. 1. For this set of embodiments, it is preferable to establish a stream of the base filament and a stream of the masterbatch filament by separate filament feeders. One advantage of such embodiments is that filaments remove the need for compression of the feedstock materials and filament feeders generally provide constant pressure. An example of an extruder 329 (consistent with description of extruder 101 in connection with FIG. 1) intended for use in a 3D printing system (as described in connection with FIG. 1) is depicted in FIG. 3B. The extruder 329 may include a filament feed passageway 320 and an inlet 324 configured to receive the base filament 318. The extruder 329 may further include a filament feed passageway 321 having an inlet 325 configured to receive the masterbatch filament 319. The system may further include a mixing chamber 305 fluidly connected with the filament feed passageway 320 and the filament feed passageway 321. The extruder 329 may include a first filament feeder as a first pressure-generating mechanism configured to push the base filament 318 through the filament feed passageway 320 and therefore establish a first stream of solid or melted base filament in a downstream direction from inlet 324 to the mixing chamber 305. The first filament feeder may comprise at least one motor 326 and at least one rotating drive wheel 322 operably connected to the motor 326 as shown in FIG. 3B. Alternatively, or in addition, the first filament feeder may comprise at least one threaded rod as described in connection with FIG. 1. The motor 326 may be connected to the control system of the 3D printing system which may be further configured to control the feed rate of the base filament 318. The extruder 329 may include a second filament feeder as a second pressure-generating mechanism configured to push the masterbatch filament 319 through the filament feed passageway 321 and therefore establish a second stream of solid or melted masterbatch filament in a downstream direction from the inlet 325 to the mixing chamber 305. The second filament feeder may comprise at least one motor 327 and at least one rotating drive wheel 323 operably connected to the motor 327 as shown in FIG. 3B. Alternatively, or in addition, the second filament feeder may comprise at least one threaded rod as described in connection with FIG. 1. The motor 327 may be connected to the control system of the 3D printing system which may be further configured to control the feed rate of the masterbatch filament 319. The streams may be combined in the mixing chamber 305 as shown in FIG. 3B. In other embodiments, they can be combined upstream of mixing chamber 305, for example when the masterbatch filament 319 is first fed into the passageway 320 upstream of mixing chamber 305. The extruder 329 further comprises a nozzle 310 located downstream of the mixing chamber 305, the nozzle 310 including an outlet 315 fluidly connected with the inlets 324 and 325, the outlet 315 configured to release the combined stream from the polymer processing space of the extruder 329. The extruder 329 may further comprise a breaker plate 316 located downstream of the mixing chamber 305 and upstream of the nozzle 310. The breaker plate 316 can be a separate part as shown in FIG. 3B. Alternatively, the breaker plate 316 can make up a single part or assembly unit with the mixing chamber 305 or the nozzle 310.

As described above in connection with FIG. 2A, the extruder 329 comprises at least one independent mixing rotor 306 mounted for rotation within mixing chamber 305. One advantage of using the independent mixing rotor 306 is that it can provide quality distributive and/or dispersive dynamic mixing even at flow rates inherent to desktop 3D printing, such as in a range from 0.2 cm³/min to about 20 cm³/min, where static mixing generally cannot be usefully employed because of low energy of the flow. Another advantage of using the independent mixing rotor 306 is that it may be used to control plasticization and mixing of streams independently from the mass flow rate of extrusion. Preferably, the independent mixing rotor 306 may be operably connected to a dedicated motor 308 providing the rotational power. Alternatively, the independent mixing rotor 306 may be operably connected to the motor 326 or the motor 327 providing the rotational power through a step-up gearbox.

As described above in connection with FIG. 2A, temperature control units 328 may be positioned along the filament feed passageway 320, the filament feed passageway 321, the mixing chamber 305, and the nozzle 310; and may be used to maintain a set temperature profile along the polymer processing space.

The extruder 329 may comprise a control valve (not shown) as described above in connection with FIG. 2B. The extruder 329 may comprise a pressure sensor (not shown) as described in connection with FIG. 2A.

A first stream of the solid or melted base filament in a downstream direction toward the mixing chamber 305 and further toward the outlet 315 may be established by the first filament feeder; and a second stream of solid or melted masterbatch filament in a downstream direction toward the mixing chamber 305 and further toward the outlet 315 may be established by the second filament feeder. The method further describes establishing a fluid phase of the first stream by melting the base polymer with temperature control units 328 and/or with the rotating independent mixing rotor 306 providing frictional or shear heating of the first stream; a step of establishing a fluid phase of the second stream by melting the carrier material with temperature control units 328 and/or with the rotating independent mixing rotor 306 providing frictional or shear heating of the second stream. The fluid phase of the first stream, the fluid phase of the second stream and the foaming agents may be admixed within the mixing chamber 305 by the rotating independent mixing rotor 306 to form a substantially homogeneous mixture of the foaming agents, the base polymer, and the carrier material within the combined stream. The mixture may comprise other components, for example, other raw materials and/or their derivatives. Those of ordinary skill in the art will determine a degree of homogeneity of the mixture to be considered substantial and will operate the independent mixing rotor 306 at a sufficiently high rotational speed for producing such a mixture. The rotational speed of the independent mixing rotor 306 may be higher than 0.3 revolutions per second. The upper boundary on the rotational speed of the independent mixing rotor 306 is inherent to an implementation of the extruder 329 and should be understood by those skilled in the art. The rotational speed of the independent mixing rotor 306 may be higher than 0.3 revolutions per second and lower than 120 revolutions per second, preferably may be in a range from 1 revolution per second to 60 revolutions per second, more preferably may be in a range from 1 revolution per second to 25 revolutions per second. Rotational speeds of the independent mixing rotor higher than 60 revolutions per second would require an overly powerful motor 308 which is of little practical interest in context of desktop 3D printing which is the primary focus of this invention. Rotational speeds higher than 25 revolutions per second in some cases may result in excessive viscous heating and/or damage to the base polymer and/or the foaming agent caused by an excessive shear stress that may be generated by such rotational speeds. A mass fraction of the foaming agents in the mixture may be no more than 25 wt %, preferably may be in a range from 2 wt % to 15 wt %. Those skilled in the art may choose the mass fraction for some target density of the polymeric foam based on the values discussed in connection to FIG. 2A.

Temperature control units 328 may heat the mixture to a temperature exceeding the activation temperature of the at least one foaming agent (heating the mixture to a temperature means heating at least a portion of the mixture to the temperature, for example, heating the second stream contained in the mixture to a temperature exceeding the activation temperature of the at least one foaming agent, which can be done by heating the first stream with temperature control units 328 to a temperature substantially higher than the activation temperature of the foaming agent prior to admixing it with the second stream, where a temperature of the second stream prior to admixing may be substantially lower than the temperature of the first stream), therefore activating the at least one foaming agent to form a polymeric foam that is released from the polymer processing space through the outlet 315 of the nozzle 310. Preferably, the activation of the foaming agent does not produce substantial deviations in the discharge pressure which is especially beneficial to three-dimensional printing. This may be achieved by selecting the temperature profile such that most of the activation of the foaming agent happens after the mixture is homogenized to a level where the activation of the foaming agent does not produce substantial deviations in the discharge pressure. Alternatively, or in addition, the pressure within the mixing chamber 305 may be increased with the control valve 214 to facilitate later activation of the foaming agent. The later activation of the foaming agent improves homogenization by the time most of activation of the foaming agent starts to happen and thereby reduces deviations of the discharge pressure. Those of ordinary skill in the art will determine a degree of pressure deviations to be considered substantial and will set a temperature profile and optionally the position of the control valve 214 which level out these deviations.

The combined stream may be subjected to a pressure drop rate immediately before the outlet 315 of at least 1 MPa/sec (preferably at least 3 MPa/sec) as described above in connection with FIG. 2A and FIG. 2B.

Alternatively, or in addition to producing the polymeric foam within the polymer processing space of the extruder 329, the method may include a step of extruding the mixture containing at least one partially activated and/or non-activated foaming agent from the outlet 315 of the nozzle 310 and a step of activating the foaming agent after deposition by external heating as described above in connection with FIG. 2A and FIG. 2B.

The second filament feeder may be used to feed the masterbatch filament into the stream of solid or melted base filament. Motor 327 can be connected to a control (not shown) that may be also connected to the motor 326 to control the feed rate of the masterbatch filament in relationship to the feed rate of the base filament in order to precisely control a mass fraction of the foaming agents in the mixture and therefore control the polymeric foam density.

To facilitate the 3D printing of objects comprising a polymeric foam of variable density, the control system of the 3D printing system may further control the polymeric foam density in accordance with a predefined density map which assigns target densities to segments and/or points of a tool path. The control over the polymeric foam density may be performed by adjusting at least one parameter selected from a group consisting of: the set temperatures of the temperature control units 328, the size of the flow passage of the control valve, the feed rate of the base filament, the feed rate of the masterbatch filament.

The present invention provides, according to one set of embodiments, a method that involves processing raw materials including a first feedstock material in granular form and including a second feedstock material in filament form by a 3D printing system described in connection with FIG. 1, wherein at least one of the first feedstock material and the second feedstock material comprises at least one base polymer and at least one of the first material and the second material comprises at least one foaming agent. For example, the first material may be foaming granules and the second material may be base filament. As another example, the first material may be base granules and the second material may be masterbatch filament. As another example, the first material may be foaming granules and the second material may be base filament. As another example, the first material may be foaming granules and the second material may be masterbatch filament. As another example, the first material may be masterbatch granules and the second material may be base filament. As discussed in connection with FIG. 2A, it is preferable to use a pressure-generating mechanism capable of positive displacement conveying for establishing a stream of the first feedstock material. For this set of embodiments, an example of an extruder 330 (consistent with description of extruder 101 in connection with FIG. 1) intended for use in a 3D printing system (as described in connection with FIG. 1) is depicted in FIG. 3C. The extruder 330 shown in FIG. 3C uses a single-screw extrusion mechanism with grooved barrel 301 to establish the stream of the first feedstock material, but it should be understood by those skilled in the art that any pressure-generating mechanism selected from a group consisting of: a single-screw extrusion mechanism, a twin-screw extrusion mechanism, a tri-screw extrusion mechanism, a scroll extrusion mechanism, a vane extrusion mechanism, a progressive cavity extrusion mechanism, a ram extrusion mechanism; may be employed instead or in addition as long as it provides positive displacement conveying of the first feedstock material. A pressure-generating mechanism configured to establish the stream of the first feedstock material is further referred to as the first pressure-generating mechanism. The extruder 330 may include a barrel 301 having one or more grooves (not shown) provided in the inner surface of the barrel 301 and having an inlet 303 configured to receive the first material. Mounted for rotation within the barrel 301 may be a screw 302 operably connected to a motor 307. The motor 317 may be connected to the control system of the 3D printing system which may be further configured to control the feed rate of the first feedstock material. The screw 302, the barrel 301 and the motor 317 constitute the first pressure-generating mechanism. The extruder 330 may include a filament feed passageway 321 and an inlet 325 configured to receive the second material. Extruder 330 may further include a filament feeder as a second pressure-generating mechanism configured to establish a stream of the second material in filament form as described in connection with FIGS. 1 and 3B.

As described in connection with FIGS. 2A, 2B, 3A, and 3B; the extruder may comprise a mixing chamber 305, a breaker plate 316, and a nozzle 310 having an outlet 315.

As described above in connection with FIG. 2A, the extruder 330 comprises at least one independent mixing rotor 306 mounted for rotation within mixing chamber 305. Pressure-generating mechanisms providing positive displacement conveying generally cannot at the same time provide sufficient plasticization and mixing for desktop 3D printing of polymeric foams because of low rotational speeds of their rotating members such as the screw 302 inherent to desktop 3D printing. One advantage of using the independent mixing rotor 306 is that it can provide quality distributive and/or dispersive dynamic mixing even at flow rates inherent to desktop 3D printing, such as in a range from 0.2 cm³/min to about 20 cm³/min, where static mixing generally cannot be usefully employed because of low energy of the flow. Another advantage of using the independent mixing rotor 306 is that it may be used to control plasticization and mixing of streams independently from the mass flow rate of extrusion. Preferably, the independent mixing rotor 306 may be operably connected to a dedicated motor 308 providing the rotational power. Alternatively, the independent mixing rotor 306 may be operably connected to the motor 307 or the motor 327 providing the rotational power through a step-up gearbox.

As described in connection with FIGS. 2A, 2B, 3A, and 3B; temperature control units 331 may be positioned along barrel 301, filament feed passageway 321, mixing chamber 305, and nozzle 310; and may be used to maintain a set temperature profile along the polymer processing space.

The extruder 330 may comprise a control valve (not shown) as described above in connection with FIG. 2B. The extruder 330 may comprise a pressure sensor (not shown) as described in connection with FIG. 2A.

A first stream of the solid or melted first material in a downstream direction toward the mixing chamber 305 and further toward the outlet 315 may be established by the first pressure-generating mechanism; and a second stream of solid or melted second material in a downstream direction toward the mixing chamber 305 and further toward the outlet 315 may be established by the filament feeder. The method further describes a step of establishing a fluid phase of the stream of the first material and a fluid phase of the stream of the second material by melting the base polymer, and possibly a carrier material, and possibly a binder system with temperature control units 331 and/or with the rotating independent mixing rotor 306 providing frictional or shear heating of the streams. The fluid phases and the foaming agents may be admixed within the mixing chamber 305 by the rotating independent mixing rotor 306 to form a substantially homogeneous mixture of the foaming agents, the base polymer, and possibly the carrier material, and possibly the binder system within the combined stream. The mixture may comprise other components, for example, other raw materials and/or their derivatives. Those of ordinary skill in the art will determine a degree of homogeneity of the mixture to be considered substantial and will operate the independent mixing rotor 306 at a sufficiently high rotational speed for producing such a mixture. The rotational speed of the independent mixing rotor 306 may be higher than 0.3 revolutions per second and may be higher than the rotational speed of the screw 302 (i.e., the independent mixing rotor 306 operates independently). The upper boundary on the rotational speed of the independent mixing rotor 306 is inherent to an implementation of the extruder 330 and should be understood by those skilled in the art. The rotational speed of the independent mixing rotor 306 may be higher than 0.3 revolutions per second and lower than 120 revolutions per second, preferably may be in a range from 1 revolution per second to 60 revolutions per second, more preferably may be in a range from 1 revolution per second to 25 revolutions per second. Rotational speeds of the independent mixing rotor higher than 60 revolutions per second would require an overly powerful motor 308 which is of little practical interest in context of desktop 3D printing which is the primary focus of this invention. Rotational speeds higher than 25 revolutions per second in some cases may result in excessive viscous heating and/or damage to the base polymer and/or the foaming agent caused by an excessive shear stress that may be generated by such rotational speeds. A mass fraction of the foaming agents in the mixture may be no more than 25 wt %, preferably may be in a range from 2 wt % to 15 wt %. Those skilled in the art may choose the mass fraction for some target density of the polymeric foam based on the values discussed in connection to FIG. 2A.

Temperature control units 331 may heat the mixture to a temperature exceeding the activation temperature of the at least one foaming agent (heating the mixture to a temperature means heating at least a portion of the mixture to the temperature), therefore activating the at least one foaming agent to form a polymeric foam that is released from the polymer processing space from the outlet 315 of the nozzle 310.

Preferably, the activation of the foaming agent does not produce substantial deviations of the discharge pressure which is especially beneficial to three-dimensional printing. This may be achieved by selecting the temperature profile such that most of the activation of the foaming agent happens after the mixture is homogenized to a level where the activation of the foaming agent does not produce substantial deviations in the discharge pressure. Alternatively, or in addition, the pressure within the mixing chamber 305 may be increased with the control valve 214 to facilitate later activation of the foaming agent. The later activation of the foaming agent improves homogenization by the time most of the activation of the foaming agent starts to happen and thereby reduces deviations of the discharge pressure. Those of ordinary skill in the art will determine a degree of pressure deviations to be considered substantial and will set a temperature profile and optionally the position of the control valve 214 which level out these deviations.

The combined stream may be subjected to a pressure drop rate immediately before the outlet 315 of at least 1 MPa/sec (preferably at least 3 MPa/sec) as described above in connection with FIG. 2A and FIG. 2B.

Alternatively, or in addition to producing the polymeric foam within the polymer processing space of the extruder 330, the method may include a step of extruding the mixture containing at least one partially activated and/or non-activated foaming agent from the outlet 315 of the nozzle 310 and a step of activating the foaming agent after deposition by external heating as described above in connection with FIG. 2A and FIG. 2B.

As described in connection with FIGS. 3A and 3B, a mass fraction of the foaming agents in the mixture may be controlled to therefore control the polymeric foam density.

To facilitate the 3D printing of objects comprising a polymeric foam of variable density, the control system of the 3D printing system may further control the polymeric foam density in accordance with a predefined density map which assigns target densities to segments and/or points of a tool path. The control over the polymeric foam density may be performed by adjusting at least one parameter selected from a group consisting of: the set temperatures of the temperature control units 331, the size of the flow passage of the control valve, the feed rate of the first material, the feed rate of the second material.

Some embodiments of the present invention utilize a method of non-planar 3D printing where the line height and the contact pressure may be controlled by a tool path that takes into account the line height and contact pressure differences caused by the tilt of the nozzle relative to the deposition surface. Without limitation, this method may be applied to any extrusion-based 3D printing system having a printhead, a build surface and a positioning system having at least 3 axes, thereby establishing a relative movement between the build surface and the printhead such that the build surface can be positioned in XYZ coordinates of a Cartesian three-dimensional coordinate system attached to the printhead. The coordinate system may be chosen such that the Z axis is perpendicular to the build surface. In some embodiments, for example, when the printhead is tilted relative to the build surface, the Z axis may be chosen to go through the centroid of the nozzle outlet, perpendicular to the nozzle outlet. For the purpose of the description of this method, horizontal refers to a direction parallel to the XY plane, and vertical refers to a direction parallel to the Z axis. The method may include one or more steps of slicing a 3D model of the desired final object into layers comprising at least one non-planar layer. The method may further include calculating nominal tool paths for the non-planar layers. The method may further include calculating a second path of the nozzle by horizontally translating points of the nominal tool paths in order to remove the differences in the line height and the contact pressure, which may be caused by the tilt of the nozzle relative to the deposition surface. The method may also include applying additional translations to the points of the second path. For example, a point of the second path can be shifted vertically if contact between the nozzle and the deposition surface is detected. The method may include a step of resampling one or more points. For example, new points can be added to the resultant tool path to reduce the distance between points. The method further comprises depositing material along the resultant tool path.

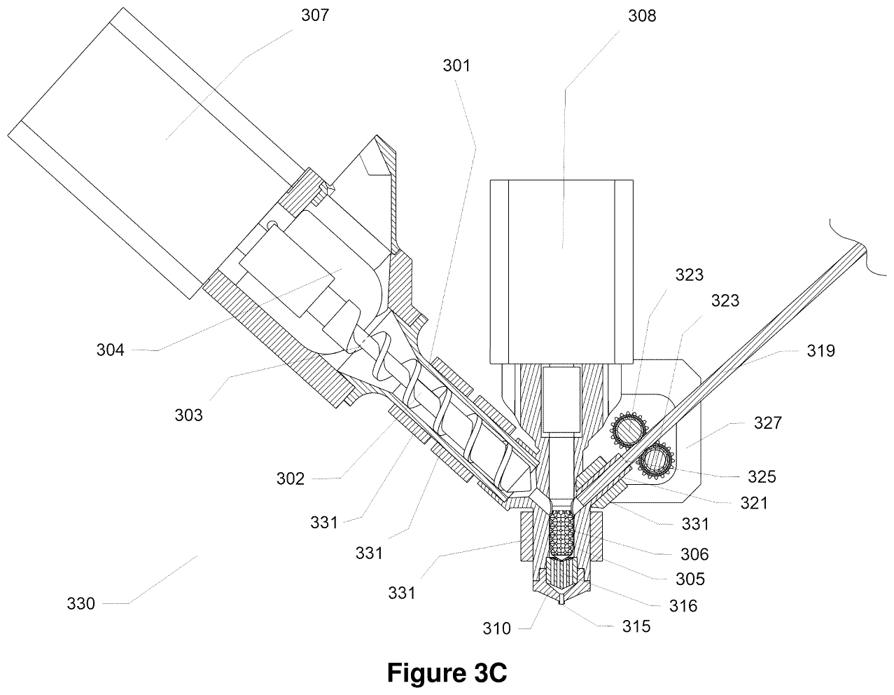

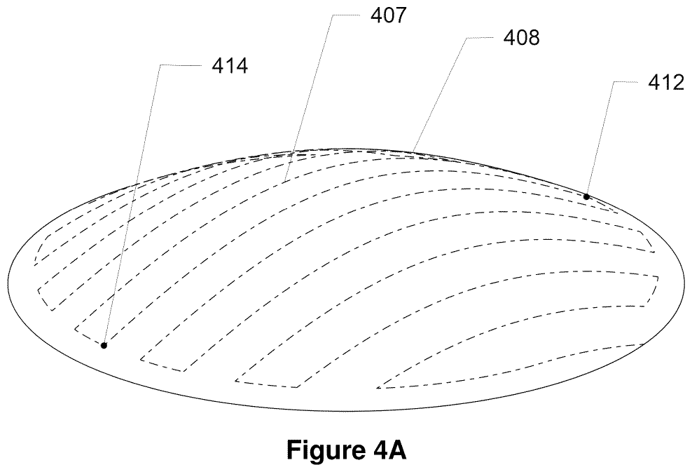

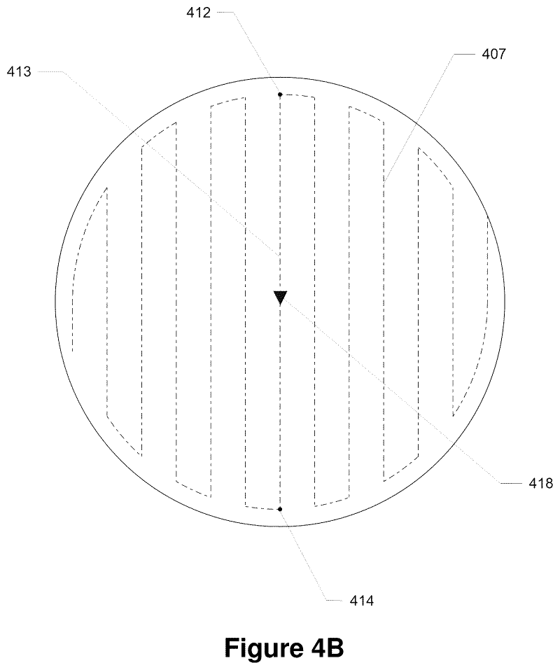

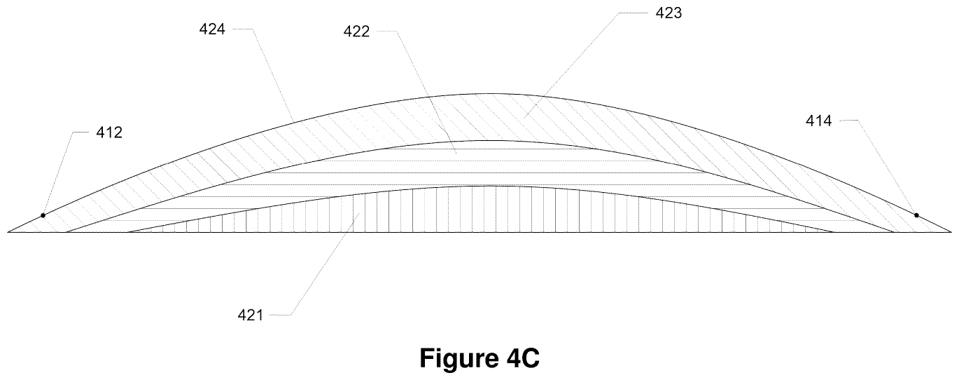

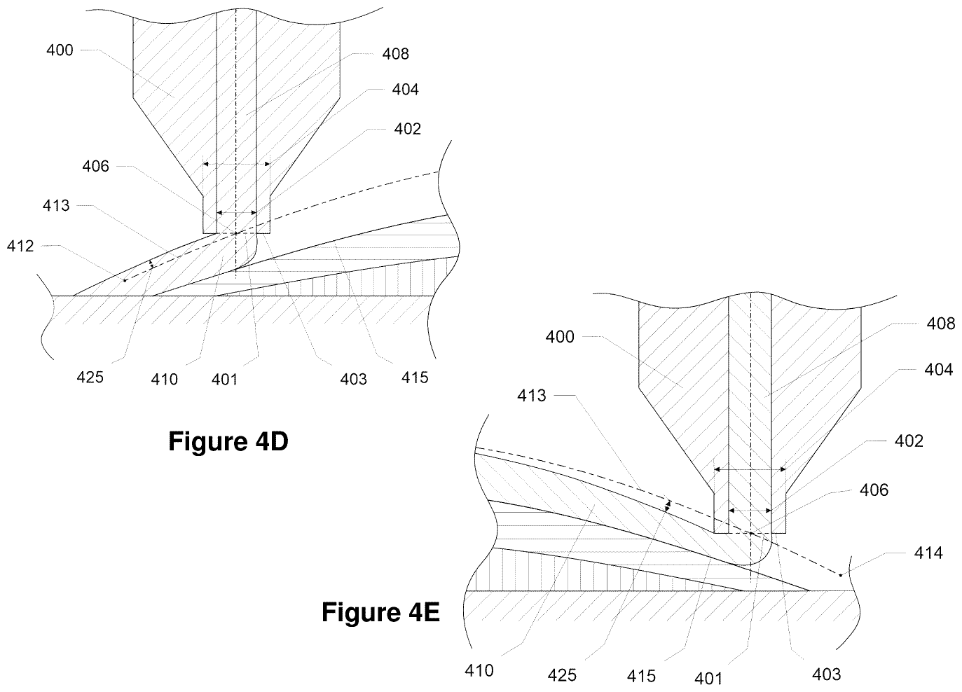

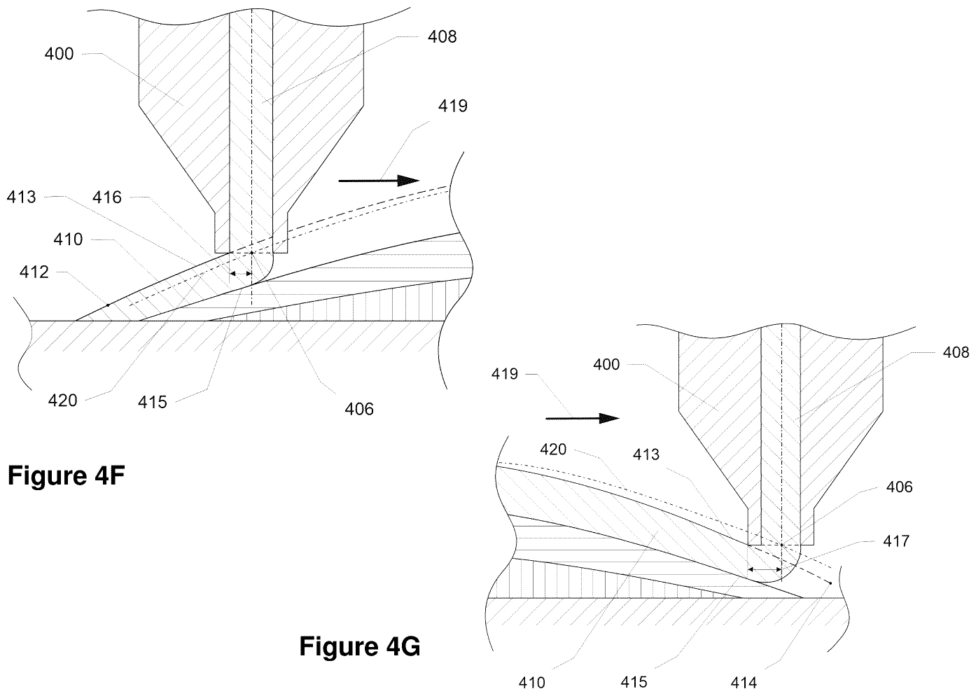

The model 408 shown in various views in FIGS. 4A, 4B, and 4C is sliced into 3 non-planar layers 421, 422, and 423, with layer 423 being the uppermost. An example of a nominal tool path 407 may be calculated for the non-planar layer 423. The nominal path 407 may be located on the upper surface 424 of the layer 423. It may include a subpath 413 between points 412 and 414. The nominal path can be generated, for example, by projecting the non-planar layer on a horizontal plane, calculating a conventional two-dimensional path for it, and projecting the two-dimensional path back onto the upper surface of the non-planar layer to get the nominal path. Arrow 418 shows the traversal direction along the nominal path 407.

FIG. 4D and FIG. 4E show cross-section views of the deposition process for the subpath 413 of the nominal path 407, where the nozzle 400 deposits material 408 on the deposition surface 415 by moving relative thereto. The nozzle 400 has an outlet 401 with the outlet dimension 402, which may be a diameter or a width dimension if the outlet 401 is non-circular. The nozzle 400 has a nozzle tip 403 with the outer dimension 404, which may be greater than the outlet dimension 402. Nozzle tip outer dimension 404 may be an outer diameter if the tip 403 of the nozzle 400 is circular (i.e., if the nozzle 400 has an axisymmetric shape such as a cone or a cylinder). In other embodiments, it may be a width dimension when the tip 403 of the nozzle 400 is non-circular. A reference point 406 is located at the center of the circular outlet 401 of the nozzle 400 and travels along the nominal path 407 in the direction of the arrow 418, along with the motion of the nozzle 400. FIG. 4D shows the part of the deposition process when the nozzle 400 moves uphill. FIG. 4E shows the part of deposition process when the nozzle 400 moves downhill. The tilt of the nozzle 400 in relation to deposition surface 415 may result in the thickness difference 425 between the deposited material 410 and the layer 423.

FIG. 4F and FIG. 4G show cross-sections of the deposition process for the same nozzle as in FIG. 4D and FIG. 4E, but now for the subpath 420 of a new path. The reference point 406 is located at the center of the circular outlet 401 of the nozzle 400 and travels along the nominal path 407 in the direction of the arrow 419, together with the motion of the nozzle 400. A new path may be calculated by translating points of the nominal path onto a horizontal plane. Specifically, the subpath 420 may be calculated by translating a subset of points of the subpath 413 in the direction shown by the arrow 419. Such translation may be done by a distance 416 equal to one-half of the outlet dimension 402 for the section of the subpath 420 where the nozzle 400 moves uphill. The translation may also be done by the distance 417 equal to one-half of the nozzle tip outer dimension 404 elsewhere. FIG. 4F shows the part of the deposition process when the nozzle 400 moves uphill and FIG. 4G shows the part of the deposition process when the nozzle 400 moves downhill. The deposition process along the new path may result in removing the thickness difference between the deposited material 410 and the layer 423 caused by the tilt of the nozzle 400 relative to deposition surface 415. The deposition process shown in FIG. 4F and FIG. 4G results in a deposited material 410 thickness equal to the thickness of the layer 423.

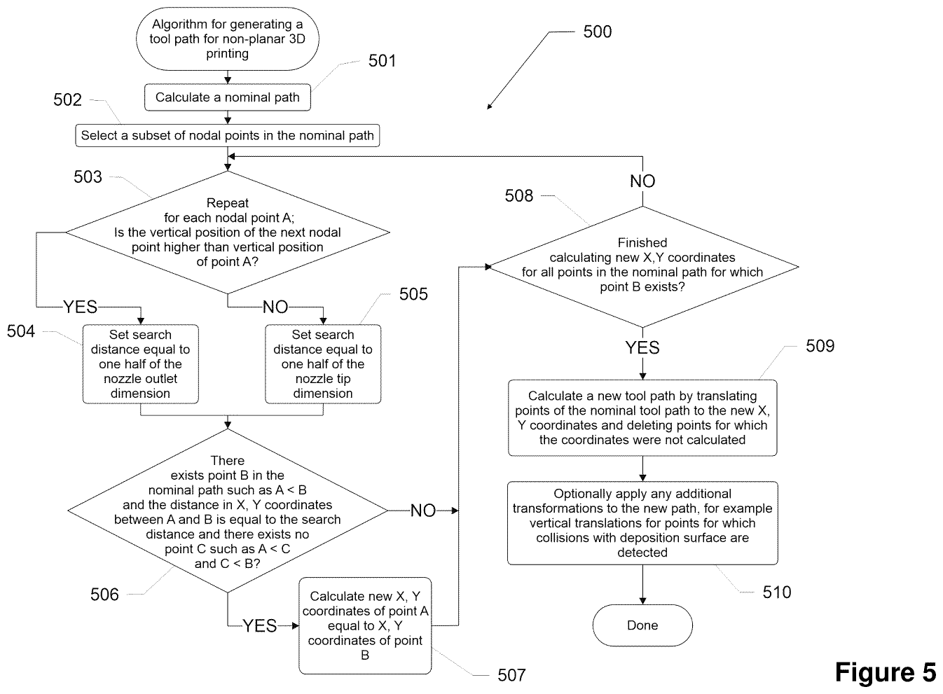

FIG. 5 shows a flowchart 500 of an exemplary algorithm for calculating a new path based on a nominal path. A nominal path is calculated in step 501. The nominal path may include a finite number of discrete points or it may include an infinite number of points represented by mathematical functions such as spline curves, polynomial curves, piecewise math functions, continuous math functions, and combinations thereof. Discrete points may be represented by the 3D Cartesian coordinates, or they may be represented by the 2D Cartesian coordinates with the third dimension represented by other means, for example, by a relative offset to the previous point. Discrete points may be represented by vectors in real or complex coordinate space of any finite dimensionality. For example, points may be represented by vectors in a 4-dimensional real coordinate space, where the first three dimensions are 3D Cartesian coordinates and the fourth dimension is the relative coordinate of extrusion.

Discrete points may have additional symbolic information associated with them, for example, material density or material color. The points along the nominal path may have a linear order (binary relation <between arbitrary different points A and B) that defines which one point, among two different points, is traversed first. For example, the nominal path may be represented by a list of a finite number of discrete points where the linear order is given by the order in the list. If the nominal path consists of a finite number of discrete points, it may include points on segments between consecutive discrete points in the nominal path and extend the definition of the linear order on these new points. In step 502, a subset of nodal points in the nominal path may be selected. For example, if the nominal path is represented by a list of a finite number of discrete points, all the points on the list may be selected in step 502. In repeated decision step 503, it may be decided for each nodal point A, whether or not the next nodal point has a higher vertical position than the nodal point A. In the case of a finite set of nodal points, the next nodal point may be defined by the linear order <as a point AA such as A<AA, and there exists no nodal point AAA such as A<AAA and AAA <AA.

In the case of an infinite set of nodal points, the next nodal point may be defined with a help of a check distance by searching the nodal point AA, such as A<AA, and the distance in a horizontal plane between points A and AA is smaller than the check distance. In this case, one may choose the check distance to be substantially small for higher accuracy of the resultant new path.

In case there is no point next to point A, for example, if point A is the endpoint, any output of step 503 can be chosen because point A will be later filtered out by the algorithm. In case the output of step 503 is TRUE, a search distance may be set equal to one-half of the nozzle outlet dimension. In case the output of step 503 is FALSE, a search distance may be set equal to one-half of the nozzle tip dimension.

In other embodiments, the search distance may be fixed for all points in the nominal path and be equal to one-half of the nozzle tip diameter. The search distance may be adjusted based on the geometrical properties of the nominal path, extrusion rates, deposition speed, desired contact pressure, etc. For each nodal point A, it may be determined in a repeated decision step 504, if there exists a point B in the nominal path located further down the nominal path (A<B) for which distance to point A in the horizontal plane is equal to the search distance and there exists no point C such as A<C and C<B. The distance in the horizontal plane may be calculated as Euclidean distance between projections of points A and B onto the horizontal plane, or it may be any other distance function calculated for points A and B. New X, and Y coordinates of the point A may be calculated in the step 507 to be equal respectively to X, and Y coordinates of the point B. In a repeated decision step 508, it may be determined whether the new X, and Y coordinates have been calculated for all points in the nominal path for which the step 506 outcome is TRUE. In step 509, a new path may be calculated by substituting X, and Y coordinates of the points in the nominal path for which step 506 is TRUE with the new X, and Y coordinates, respectively, and deleting those points in the nominal path for which the step 506 outcome is FALSE.

The linear order of the points in the new path may be equal to the linear order of the corresponding points in the nominal path. Any additional transformations to the points of the new path may be applied in the step 510. For example, if the nozzle positioning at a point of the new path results in a collision between the nozzle and the deposition surface, the point may be moved vertically to avoid this collision.

Some embodiments of the present invention may include a step of controlling the volume of deposited material per unit length of a tool path, further referred to as “deposition rate”. This may be done by controlling the absolute value of velocity, further referred to as “speed”, of the relative movement between the nozzle and the build surface whilst keeping the extrusion volumetric flow rate substantially constant.

In standard methods of extrusion-based 3D printing, the volumetric flow rate is controlled dependent on the thickness and the width of the material deposited along the deposition path further referred respectively to as the “line height” and “line width”. Since it is practically impossible to promptly reduce or increase the volumetric flow rate of the extruded polymeric foam in a controlled manner, these methods are irrelevant to 3D printing of polymeric foams. The disclosed method enables extrusion-based 3D printing of polymeric foams with a variable line height and/or a variable line width.

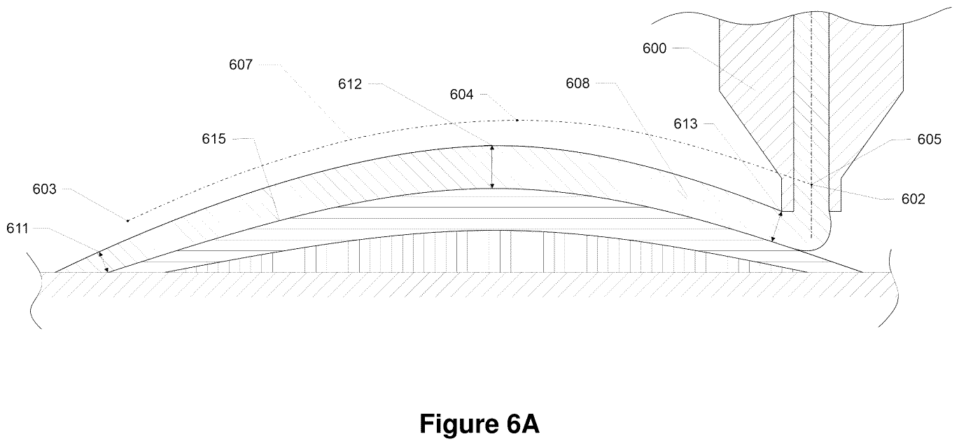

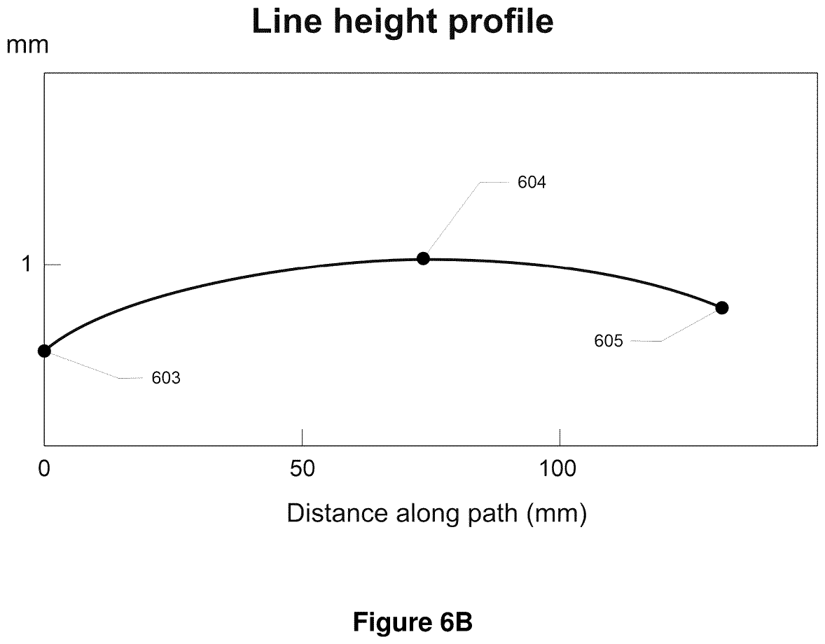

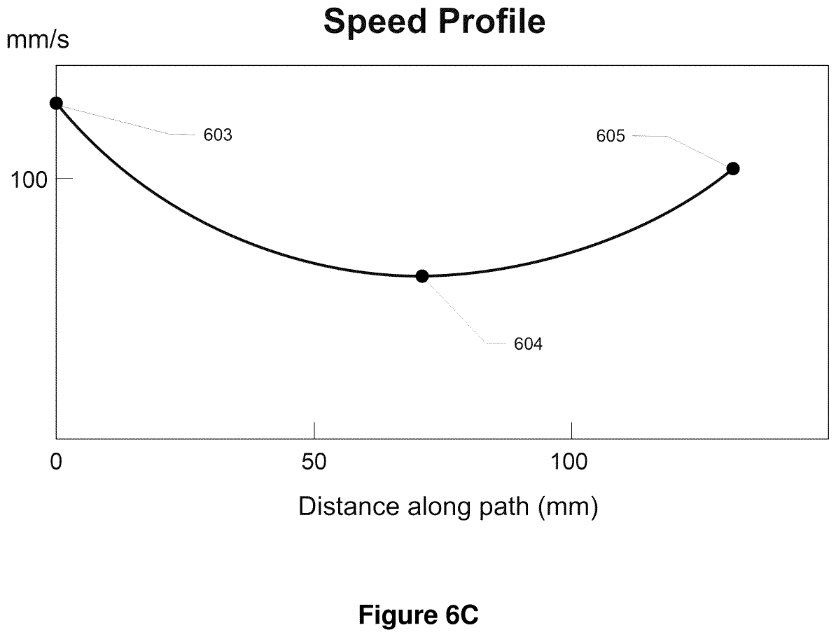

FIG. 6A shows an example of the deposition process where a nozzle 600 deposits the material 608 on a surface 615 while traveling along the deposition surface 615. As mentioned above, either one or both of the nozzle and the surface may move relative to one another. A reference point 602, which is fixed relative to the nozzle 600, may be moved along a tool path 607 with the motion of the nozzle 600, with the tool path 607 having a start point 603 and an end point 605. Position 611 denotes the line height 608 at the point 603 of the path 607. Position 613 is the line height 608 at the point 605 of the path 607. Position 612 denotes the maximum line height corresponding to the point 604 of the tool path 607.

FIG. 6B shows a graph illustrating a change in the line height along the tool path 607 depending on the distance from the point 603 along the tool path 607 for the deposition process shown in FIG. 6A. The extrusion volumetric flow rate and the line width may be kept substantially constant during the deposition process. FIG. 6C shows an example of a speed profile for the deposition process of FIG. 6A with substantially constant extrusion volumetric flow rate and line width. Faster movement along the tool path 607 results in a lower deposition rate and, therefore, smaller line height. Slower movement along the tool path 607 results in a higher deposition rate and, therefore, a larger line height.

Alternatively, in some deposition processes, the line width may vary along the deposition path while the line height is kept substantially constant—resulting in varying deposition rates along the deposition path or there may be processes where a combination of varying line width and varying line height results in varying deposition rates along the deposition path. The speed of the movement of the nozzle relative to the build surface along the deposition path may be accordingly controlled to accommodate for different deposition rates along the path, while the extrusion volumetric flow rate may be kept substantially constant. In particular, the speed may be reduced to increase the deposition rate or, otherwise, increased to reduce the deposition rate as required.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the aspects.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no aspects included in the documents are incorporated by reference herein, and any definitions provided in the documents are not incorporated by reference herein unless expressly included herein.

References to items in the singular should be understood to include items in the plural, and vice versa, unless explicitly stated otherwise or clear from the text. The use of the term “or” in the aspects is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and aspect(s), the words “comprising” (and any form of comprising, such as “comprise” and “comprises”), “having” (and any form of having, such as “have” and “has”), “including” (and any form of including, such as “includes” and “include”), “containing” (and any form of containing, such as “contains” and “contain”) or “constituting” (and any form of constituting, such as “constitutes” and “constitute”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(s), method/process steps or limitation(s)) only.

The term “and combinations thereof” as used herein refers to all permutations and combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The words “about,” “approximately” or the like, when accompanying a numerical value, are to be construed as indicating a deviation as would be appreciated by one of ordinary skill in the art to operate satisfactorily for an intended purpose. In general, but subject to the preceding discussion, a numerical value herein that is modified by a word of approximation such as “about” may vary from the stated value by at least 1, 2, 3, 4, 5, 6, 7, 10, 12, 15, 20 or 25%. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose or the like.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended aspects.

### EXAMPLES

### Example 1, 3D Printing System for Polymeric Foams

A cartesian FGF 3D printer (Unitruder (FZC), UAE) comprising an extruder similar to FIG. 2A was provided. The extruder comprised one single-screw extrusion mechanism and one independent mixing rotor. The single-screw extrusion mechanism comprised a 7/1 L/D screw with a diameter of 10 mm and having a compression ratio of 4:1. The screw was rotatably mounted within a grooved barrel having an inlet configured to receive granules. The extruder was equipped with a hopper configured to contain granules and feed them into the inlet under the action of gravity. The screw was rotated by a Nema 17 60 mm stepper motor through a 27:1 planetary gearbox. The 3/1 L/D independent mixing rotor with a diameter of 6 mm had a pineapple configuration of mixing elements. The independent mixing rotor was rotatably mounted within a mixing chamber and was rotated independently from the screw by a Nema 17 48 mm stepper motor through a 2:1 gear train. The screw comprised the feed stage and transition stage. The extruder comprised a nozzle with a circular outlet, 1 mm in diameter. The extruder comprised a breaker plate between the mixing chamber and the nozzle. The extruder was equipped with 4 temperature control units: temperature control unit 1 at the feed stage of the screw, temperature control unit 2 at the transition stage of the screw, temperature control unit 3 at the independent mixing rotor, and temperature control unit 4 at the nozzle.

### Example 2, Production of Foaming Granules

150 g of TPU pellets (Desmopan 2590A, Covestro AG, Germany) were placed in a drum coater. 300 g of distilled water was placed in a glass beaker, after which the beaker was placed on a magnetic stirrer. 29.7 g of thermally expandable microspheres (Advancell 501 EM, Sekisui Chemical, Japan) were added to the beaker and stirred for 5 minutes. After that, 39.6 g of aqueous polyurethane dispersion with 33 wt % concentration of a solid content (Dispurez 201, Incorez Ltd, England) was added to the beaker and stirred for 1 more minute until a uniform dispersion was formed. The dispersion was applied to the granules manually with a syringe in portions of 5 g every 3 minutes. During the application process, the drum was rotated at a speed of 80 rpm and the granules were heated by a hot air blower a temperature of 50° C. inside the drum. After the end of the application process, the coated granules were removed from the drum coater and kept at room temperature for 12 hours. A mass fraction of the thermally expandable microspheres in the resultant encapsulated foaming granules was 15 wt %. A mass fraction of the binder system in the resultant encapsulated foaming granules was 6.6 wt %.

### Example 3, Desktop 3D Printing with Low-Density TPU Foam from Foaming Granules

Foaming granules of Example 2 were put into the hopper of the extruder of the 3D printing system from Example 1. The temperature control unit 1 was set to maintain a temperature of 100 degrees Celsius. The temperature control unit 2 was set to maintain a temperature of 160 degrees Celsius measured at the end of the single screw extrusion stage. The temperature control unit 3 was set to maintain a temperature of 195 degrees Celsius measured at the middle of the mixing stage. The temperature control unit 4 was set to maintain a temperature of 190 degrees Celsius measured at the nozzle. A rectangular cuboid with dimensions 40×40×10 was 3D printed at a deposition speed of 60 mm/s. Line width was 1.4 mm. Layer height was 0.3 mm. Accordingly, a volumetric flow rate was approximately 1.5 cm³/min. A rotational speed of the screw was approximately 0.02 rps (revolutions per second) producing a mass flow rate of approximately 0.004 g/s. The rotational speed of the screw was too low to provide a sufficient mixing quality. To produce a substantially homogeneous mixture, the independent mixing rotor was rotating at a rotational speed of 2 rps (revolutions per second).

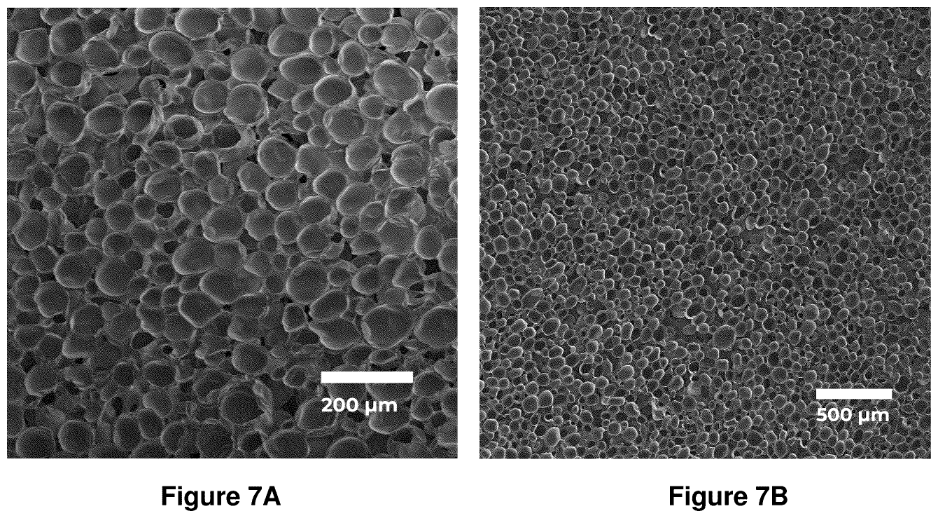

FIGS. 7A and 7B are SEM images of cross-sections of the resulting cuboid. FIG. 7A shows a vertical cross-section of the cuboid. FIG. 7B shows a horizontal cross-section of the cuboid. FIGS. 7A and 7B show a substantially homogeneous closed cell foam with approximately 61 microns average cell size and a maximum cell size of approximately 170 microns. Density of the resulting cuboid was 0.17 g/cc giving a relative density of 0.14, and cell density was approximately 7×10⁶ cells/cc.

### Example 4, Desktop 3D Printing with High-Density TPU Foam from Foaming Granules

Foaming granules comprising a core of base polymer (Desmopan 2590A, Covestro AG, Germany) and a coated shell, the shell substantially encapsulating the core and comprising a binder system (Dispurez 201, Incorez Ltd, England) and expandable microspheres (Advancell 501 EM, Sekisui Chemical, Japan) were produced. A mass fraction of the expandable microspheres in the foaming granules was 2 wt %. A mass fraction of the binder system (Dispurez 201, Incorez Ltd, England) in the foaming granules was 0.9 wt %. The foaming granules were put into the hopper of the extruder of the 3D printing system from Example 1, the extruder was equipped with a nozzle with a circular 1.5 mm outlet instead of the nozzle from Example 1. The temperature control unit 1 was set to maintain a temperature of 120 degrees Celsius. The temperature control unit 2 was set to maintain a temperature of 170 degrees Celsius measured at the end of the single screw extrusion stage. The temperature control unit 3 was set to maintain a temperature of 195 degrees Celsius measured at the middle of the mixing stage. The temperature control unit 4 was set to maintain a temperature of 200 degrees Celsius measured at the nozzle. A rectangular cuboid with dimensions 40×40×10 was printed at a deposition speed of 60 mm/s. Line width was 1.5 mm. Layer height was 0.3 mm. Accordingly, a volumetric flow rate was approximately 1.6 cm³/min. The screw rotational speed was approximately 0.07 rps (revolutions per second) producing a mass flow rate of approximately 0.017 g/s. The rotational speed of the screw was too low to provide a sufficient mixing quality. To produce a substantially homogeneous mixture, the independent mixing rotor was rotating at a rotational speed of 6 rps (revolutions per second).

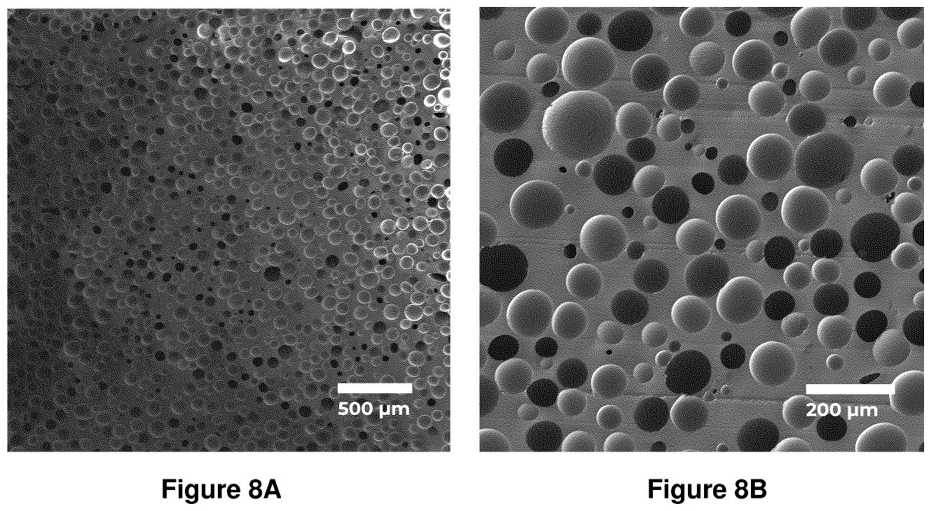

FIGS. 8A and 8B are SEM images of cross-sections of the resulting cuboid. FIG. 8A shows a vertical cross-section of the cuboid. FIG. 8B shows a horizontal cross-section of the cuboid. FIGS. 8A and 8B show a substantially homogeneous closed cell foam with approximately 65 microns average cell size and a maximum cell size of approximately 145 microns. Density of the resulting cuboid was 0.625 g/cc giving a relative density of 0.51, and cell density was approximately 3×10⁶ cells/cc.

### Example 5, Desktop 3D Printing with Low-Density PEBA Foam from Foaming Granules

Foaming granules comprising a core of base polymer (PEBAX 4033, Arkema S.A., France) and a coated shell, the shell substantially encapsulating the core and comprising a binder system (Dispurez 201, Incorez Ltd, England) and expandable microspheres (S2340, Kureha Corporation, Japan) were produced. A mass fraction of the expandable microspheres in the foaming granules was 8 wt %. A mass fraction of the binder system (Dispurez 201, Incorez Ltd, England) in the foaming granules was 3.5 wt %. The foaming granules were put into the hopper of the extruder of the 3D printing system from Example 1. The temperature control unit 1 was set to maintain a temperature of 120 degrees Celsius. The temperature control unit 2 was set to maintain a temperature of 170 degrees Celsius measured at the end of the single screw extrusion stage. The temperature control unit 3 was set to maintain a temperature of 215 degrees Celsius measured at the middle of the mixing stage. The temperature control unit 4 was set to maintain a temperature of 210 degrees Celsius measured at the nozzle. A rectangular cuboid with dimensions 40×40×10 was printed at a deposition speed of 60 mm/s. Line width was 1.4 mm. Layer height was 0.3 mm. Accordingly, a volumetric flow rate was approximately 1.5 cm³/min. A rotational speed of the screw was approximately 0.03 rps (revolutions per second) producing a mass flow rate of approximately 0.006 g/s. The rotational speed of the screw was too low to provide a sufficient mixing quality. To produce a substantially homogeneous mixture, the independent mixing rotor was rotating at a rotational speed of 6 rps (revolutions per second).

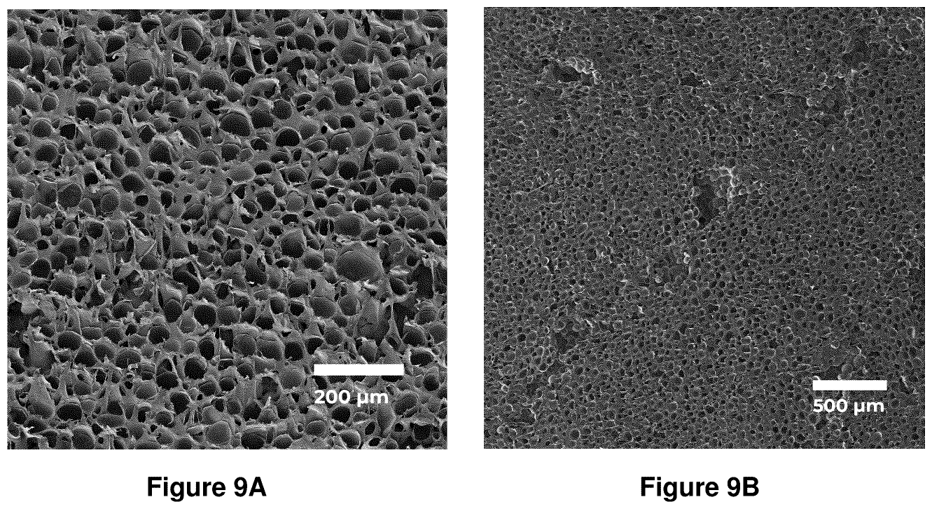

FIGS. 9A and 9B are SEM images of cross-sections of the resulting cuboid. FIG. 9A shows a vertical cross-section of the cuboid. FIG. 9B shows a horizontal cross-section of the cuboid. FIGS. 9A and 9B show a substantially homogeneous closed cell foam with approximately 64 microns average cell size and with a maximum cell size of approximately 110 microns. Density of the resulting cuboid was 0.25 g/cc giving a relative density of 0.25, and cell density was approximately 5×10⁶ cells/cc.

### Example 6, Desktop 3D Printing with Low-Density PLA Foam from Foaming Granules

Foaming granules comprising a core of base polymer (PLA 4043D, NatureWorks LLC, USA) and a coated shell, the shell substantially encapsulating the core and comprising a binder system (Dispurez 201, Incorez Ltd, England) and expandable microspheres (S2340, Kureha Corporation, Japan) were produced. A mass fraction of the expandable microspheres in the foaming granules was 8 wt %. A mass fraction of the binder system (Dispurez 201, Incorez Ltd, England) in the foaming granules was 3.5 wt %. The foaming granules were put into the hopper of the extruder of the 3D printing system of Example 1. The temperature control unit 1 was set to maintain a temperature of 120 degrees Celsius. The temperature control unit 2 was set to maintain a temperature of 180 degrees Celsius measured at the end of the single screw extrusion stage. The temperature control unit 3 was set to maintain a temperature of 210 degrees Celsius measured at the middle of the mixing stage. The temperature control unit 4 was set to maintain a temperature of 205 degrees Celsius measured at the nozzle. A rectangular cuboid with dimensions 40×40×10 was printed at a deposition speed of 60 mm/s. Line width was 1.2 mm. Layer height was 0.3 mm. Accordingly, the volumetric flow rate was approximately 1.3 cm³/min. A rotational speed of the screw was approximately 0.03 rps (revolutions per second) producing a mass flow rate of approximately 0.007 g/s. The rotational speed of the screw was too low to provide a sufficient mixing quality. To produce a substantially homogeneous mixture, the independent mixing rotor was rotating at a rotational speed of 3 rps (revolutions per second).

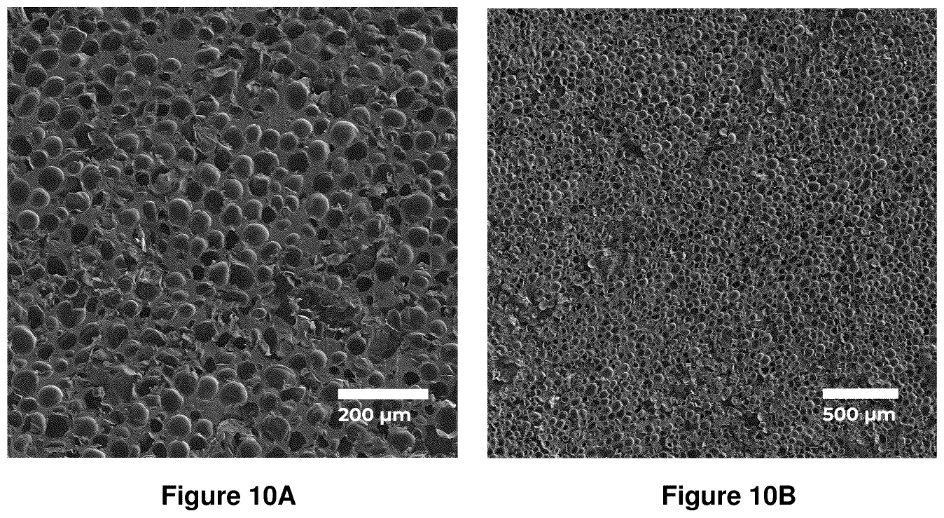

FIGS. 10A and 10B are SEM images of cross-sections of the resulting cuboid. FIG. 10A shows a vertical cross-section of the cuboid. FIG. 10B shows a horizontal cross-section of the cuboid. FIGS. 10A and 10B show a substantially homogeneous closed cell foam with approximately 58 microns average cell size and with a maximum cell size of approximately 90 microns. Density of the resulting cuboid was 0.325 g/cc giving a relative density of 0.26, and cell density was approximately 7×10⁶ cells/cc.

### Example 7, Desktop 3D Printing with TPU Foam from Foaming Granules Comprising a Chemical Blowing Agent

Foaming granules comprising a core of base polymer (Desmopan 2590A, Covestro AG, Germany) and a coated shell, the shell substantially encapsulating the core and comprising a binder system (Dispurez 201, Incorez Ltd, England) and azodicarbonamide as a chemical blowing agent (AC, Qingdao Hairuite Chemical Material Co., LTD, China) were produced. A mass fraction of the chemical blowing agent in the foaming granules was 8 wt %. A mass fraction of the binder system (Dispurez 201, Incorez Ltd, England) in the foaming granules was 3.5 wt %. The foaming granules were put into the hopper of the extruder of the 3D printing system of Example 1. The temperature control unit 1 was set to maintain a temperature of 100 degrees Celsius. The temperature control unit 2 was set to maintain a temperature of 160 degrees Celsius measured at the end of the single screw extrusion stage. The temperature control unit 3 was set to maintain a temperature of 220 degrees Celsius measured at the middle of the mixing stage. The temperature control unit 4 was set to maintain a temperature of 240 degrees Celsius measured at the nozzle. A rectangular cuboid with dimensions 40×40×10 was printed at a deposition speed of 60 mm/s. Line width was 1 mm. Layer height was 0.5 mm. Accordingly, a volumetric flow rate was 1.8 cm³/min. The rotational speed of the screw was approximately 0.08 rps (revolutions per second) producing a mass flow rate of approximately 0.02 g/s. The rotational speed of the screw was too low to provide a sufficient mixing quality. To produce a substantially homogeneous mixture, the independent mixing rotor was rotating at a rotational speed of 3 rps (revolutions per second).

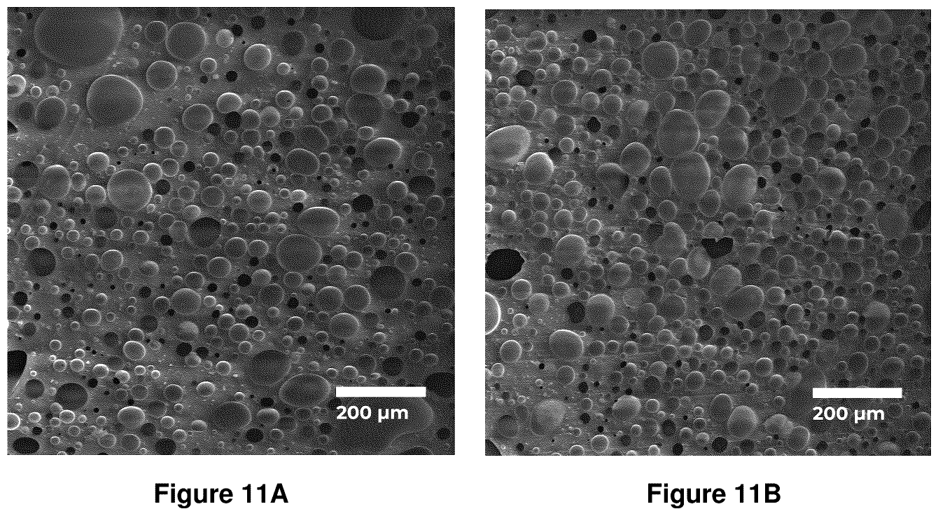

FIGS. 11A and 11B are SEM images of cross-sections of the resulting cuboid. FIG. 11A shows a vertical cross-section of the cuboid. FIG. 11B shows a horizontal cross-section of the cuboid. FIGS. 11A and 11B show a closed cell foam with approximately 40 microns average cell size and with a maximum cell size of approximately 250 microns. Density of the resulting cuboid was 0.68 g/cc giving a relative density of 0.56, and cell density was approximately 1×10⁷ cells/cc.

### Example 8, Desktop 3D Printing with Low-Density TPU Foam from Masterbatch Granules

100 g of base granules (Desmopan 2590A, Covestro AG, Germany) were manually mixed with 20.5 g of masterbatch granules of thermally expandable microspheres (S2340, Kureha Corporation, Japan). The resultant mixture was put into the hopper of the extruder of the 3D printing system of Example 1. The temperature control unit 1 was set to maintain a temperature of 100 degrees Celsius. The temperature control unit 2 was set to maintain a temperature of 175 degrees Celsius measured at the end of the single screw extrusion stage. The temperature control unit 3 was set to maintain a temperature of 190 degrees Celsius measured at the middle of the mixing stage. The temperature control unit 4 was set to maintain a temperature of 205 degrees Celsius measured at the nozzle. A rectangular cuboid with dimensions 40×40×10 was printed at a deposition speed of 60 mm/s. Line width was 1.4 mm. Layer height was 0.3 mm. Accordingly, a volumetric flow rate was approximately 1.5 cm³/min. A rotational speed of the screw was approximately 0.04 rps (revolutions per second) producing a mass flow rate of approximately 0.01 g/s. The rotational speed of the screw was too low to provide a sufficient mixing quality. To produce a substantially homogeneous mixture, the independent mixing rotor was rotating at a rotational speed of 3 rps (revolutions per second).

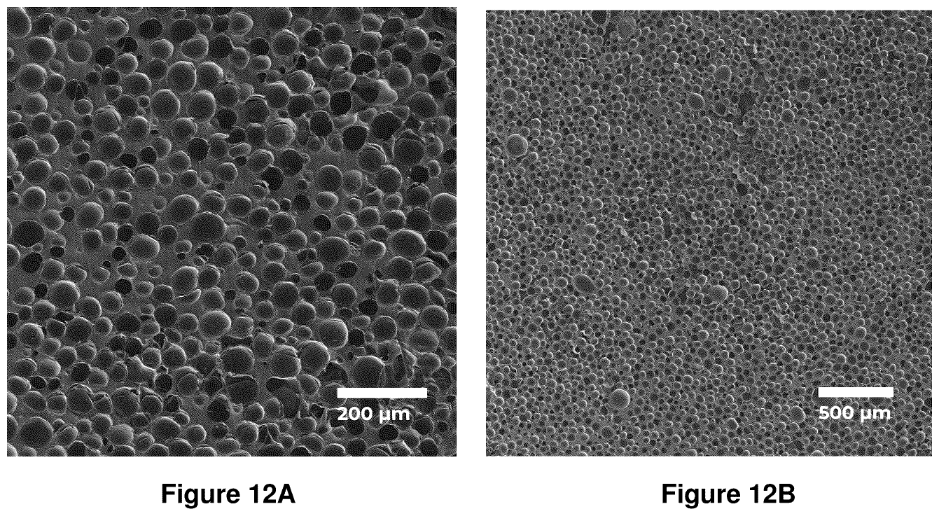

FIGS. 12A and 12B are SEM images of cross-sections of the resulting cuboid. FIG. 12A shows a vertical cross-section of the cuboid. FIG. 12B shows a horizontal cross-section of the cuboid. FIGS. 12A and 12B show a substantially homogeneous closed cell foams with approximately 53 microns average cell size and with a maximum cell size of approximately 170 microns. Density of the resulting cuboid was 0.4 g/cc giving a relative density of 0.33, and cell density was approximately 9×10⁶ cells/cc.

### Example 9 (Prophetic), Desktop 3D Printing with Low-Density TPU Foam from Co-Extruded Foaming Granules

Co-extruded cylindrical granules comprising a core of base polymer (Desmopan 2590A, Covestro AG, Germany) and a shell of dispersion of expandable microspheres (S2340, Kureha Corporation, Japan) in a carrier material (Pearlbond 1160L, Lubrizol, USA) will be produced. A mass fraction of expandable microspheres in the resulted co-extruded granules will be 8 wt %. A mass fraction of the carrier material in the resulted co-extruded granules will be 16 wt %. The co-extruded granules will be put into the hopper of the extruder of the 3D printing system of Example 1, the extruder will be equipped with a nozzle with a circular 1.5 mm outlet instead of the nozzle from Example 1. A rectangular cuboid with dimensions 40×40×10 will be printed at a deposition speed of 60 mm/s. Line width will be approximately 2 mm. Layer height will be 0.7 mm. Accordingly, a volumetric flow rate will be approximately 5 cm³/min. A target density will be 0.48 g/cc. Accordingly, a rotational speed of the screw will be set to produce a mass flow rate of approximately 0.04 g/s. The temperature control units will be set to maintain a temperature profile such that the rectangular cuboid density will be approximately 0.48 g/cc giving a relative density of approximately 0.4. To produce a substantially homogeneous mixture, the independent mixing rotor will be rotating at a rotational speed of 6 rps (revolutions per second).

### Example 10 (Prophetic), Desktop 3D Printing with Low-Density TPU Foam Using Masterbatch Filament

An extruder similar to FIG. 3C will be provided. The extruder will comprise one single-screw extrusion mechanism, one filament feeder and one independent mixing rotor. The single-screw extrusion mechanism and the independent mixing rotor will be the same as in Example 1. The extruder will be equipped with a hopper configured to contain granules and feed them to the inlet of the barrel under the action of gravity. The independent mixing rotor will be rotatably mounted within a mixing chamber having an inlet configured to receive a filament fed by the filament feeder. The extruder will comprise a nozzle with a circular outlet, 1 mm in diameter. The extruder will comprise a breaker plate between the mixing chamber and the nozzle. The extruder will be equipped with 5 temperature control units: temperature control unit 1 at the feed stage of the screw, temperature control unit 2 at the transition stage of the screw, temperature control unit 3 at the independent mixing rotor, temperature control unit 4 at the nozzle, and temperature control unit 5 at the inlet configured to receive a filament.

Masterbatch filament with a diameter of 2.85 mm will be produced containing 40 wt % expandable microspheres (S2340, Kureha Corporation, Japan) and 60 wt % TPU (Pearlbond 1160L, Lubrizol, USA). Base granules (Desmopan 2590A, Covestro AG, Germany) will be gravity-fed from the hopper of the extruder to the inlet of the barrel. A rectangular cuboid with dimensions 40×40×10 will be printed at a deposition speed of 10 mm/s. Line width will be approximately 1.2 mm. Layer height will be 0.3 mm. Accordingly, a volumetric flow rate will be approximately 0.2 cm³/min. A target density will be 0.3 g/cc. Accordingly, a rotational speed of the screw will be set to produce a mass flow rate of approximately 0.002 g/s. Masterbatch filament will be fed into the mixing chamber by the filament feeder at a rate such that the mass fraction of admixed microspheres is maintained at approximately 8 wt %. The temperature control units will be set to maintain a temperature profile such that the rectangular cuboid density will be approximately 0.3 g/cc giving a relative density of approximately 0.25. To produce a substantially homogeneous mixture, the independent mixing rotor will be rotating at a rotational speed of 3 rps (revolutions per second).

### Example 11 (Prophetic), High Flow Desktop 3D Printing with Low-Density TPU Foam

Foaming granules comprising a core of base polymer (Desmopan 2590A, Covestro AG, Germany) and a coated shell, the shell substantially encapsulating the core and comprising a binder system (Dispurez 201, Incorez Ltd, England) and expandable microspheres (Advancell 501 EM, Sekisui Chemical, Japan) will be produced. A mass fraction of the expandable microspheres in the foaming granules will be 8 wt %. A mass fraction of the binder system (Dispurez 201, Incorez Ltd, England) in the foaming granules will be 3.5 wt %. Extruder will be the same as in Example 1 except for a more powerful Nema 23 stepper motor rotating the screw through a 27:1 planetary gearbox, further except for the independent mixing rotor which will be replaced with a 3/1 L/D independent mixing rotor with a diameter of 8 mm and with pin configuration of mixing elements, further except for a more powerful Nema 34 BLDC motor rotating the independent mixing rotor directly with 1:1 reduction ratio, and further except for the nozzle which will be replaced with a nozzle with a circular 2.5 mm outlet. The foaming granules will be put into the hopper of the extruder. A rectangular cuboid with dimensions 62×62×18 will be printed at a deposition speed of approximately 60 mm/s. Line width will be approximately 3.1 mm. Layer height will be 1.8 mm. Accordingly, a volumetric flow rate will be 20 cm³/min. A target density will be 0.3 g/cc. Accordingly, a rotational speed of the screw will be set to produce a mass flow rate of approximately 0.12 g/s. The temperature control units will be set to maintain a temperature profile such that the rectangular cuboid density will be approximately 0.35 g/cc giving a relative density of approximately 0.29. To produce a substantially homogeneous mixture, the independent mixing rotor will be rotating at a rotational speed of 60 rps (revolutions per second).

### Example 12, Activation of a Foaming Agent by External Heating

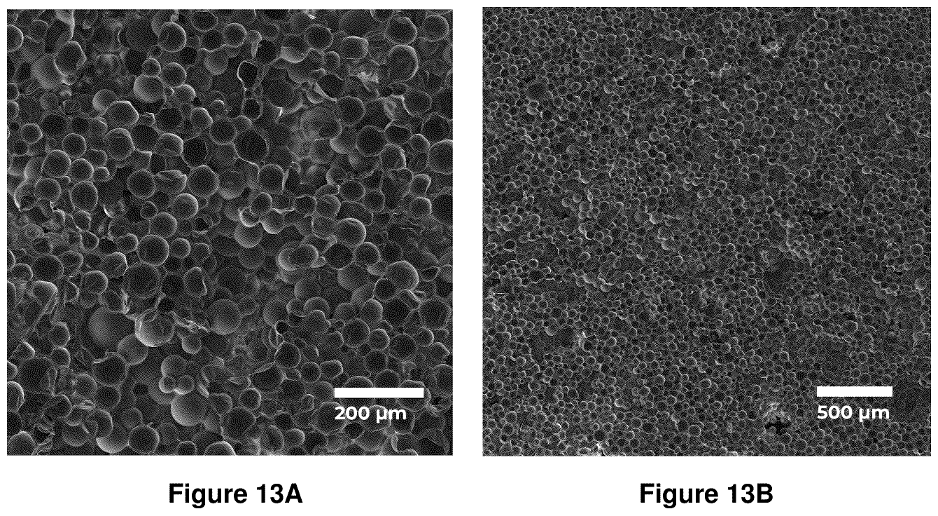

Foaming granules comprising a core of base polymer (Desmopan 33085AU, Covestro AG, Germany) and a coated shell, the shell substantially encapsulating the core and comprising a binder system (Dispurez 201, Incorez Ltd, England) and expandable microspheres (S2640, Kureha Corporation, Japan) were produced. A mass fraction of the expandable microspheres in the foaming granules was 8 wt %. A mass fraction of the binder system (Dispurez 201, Incorez Ltd, England) in the foaming granules was 3.5 wt %. The foaming granules were gravity-fed from the hopper of the screw to the extruder of Example 1. The temperature control unit 1 was set to maintain a temperature of 130 degrees Celsius. The temperature control unit 2 was set to maintain a temperature of 180 degrees Celsius measured at the end of the single screw extrusion stage. The temperature control unit 3 was set to maintain a temperature of 215 degrees Celsius measured at the middle of the mixing stage. The temperature control unit 4 was set to maintain a temperature of 210 degrees Celsius measured at the nozzle. A rectangular cuboid with dimensions 40×40×10 was printed at a deposition speed of 15 mm/s. Line width was 1.3 mm. Layer height was 0.3 mm. Accordingly, a volumetric flow rate was approximately 0.35 cm³/min. The rotational speed of the screw was approximately 0.02 rps (revolutions per second) producing a mass flow rate of approximately 0.005 g/s. The rotational speed of the screw was too low to provide a sufficient mixing quality. To produce a substantially homogeneous mixture, the independent mixing rotor was rotating at a rotational speed of 3 rps (revolutions per second). Density of the as-printed cuboid was approximately 0.9 g/cc. After 3D printing cuboid was placed in an oven at 235 degrees Celsius for 2 minutes. FIGS. 13A and 13B are SEM images of cross-sections of the resulting cuboid.

FIG. 13A shows a vertical cross-section of the cuboid. FIG. 13B shows a horizontal cross-section of the cuboid. FIGS. 13A and 13B show closed cell foam with approximately 53 microns average size with a maximum cell size of approximately 130 microns. Density of the resulting cuboid was 0.4 g/cc giving a relative density of 0.31 and the ratio of volumetric expansion of 2.9. Cell density was approximately 9×10⁶ cells/cc.

### Example 13, Excessive Concentration of a Foaming Agent

Foaming granules comprising a core of base polymer (Desmopan 2590A, Covestro AG, Germany) and a coated shell, the shell substantially encapsulating the core and comprising a binder system (Dispurez 201, Incorez Ltd, England) and expandable microspheres (Advancell 501 EM, Sekisui Chemical, Japan) were produced. A mass fraction of the expandable microspheres in the foaming granules was 25 wt %. A mass fraction of the binder system (Dispurez 201, Incorez Ltd, England) in the foaming granules was 11 wt %. The foaming granules were put into the hopper of the extruder of the 3D printing system from Example 1, the extruder was equipped with a nozzle with a circular 1.5 mm outlet instead of the nozzle from Example 1. The temperature control unit 1 was set to maintain a temperature of 120 degrees Celsius. The temperature control unit 2 was set to maintain a temperature of 165 degrees Celsius measured at the end of the single screw extrusion stage. The temperature control unit 3 was set to maintain a temperature of 165 degrees Celsius measured at the middle of the mixing stage. The temperature control unit 4 was set to maintain a temperature of 180 degrees Celsius measured at the nozzle. A rectangular cuboid with dimensions 40×40×10 was printed at a deposition speed of 45 mm/s. Line width was 2 mm. Layer height was 0.5 mm. Accordingly, a volumetric flow rate was approximately 2.7 cm³/min. The rotational speed of the screw was approximately 0.02 rps (revolutions per second) producing a mass flow rate of approximately 0.005 g/s. The rotational speed of the screw was too low to provide a sufficient mixing quality. To produce a substantially homogeneous mixture, the independent mixing rotor was rotating at a rotational speed of 1 rps (revolutions per second).

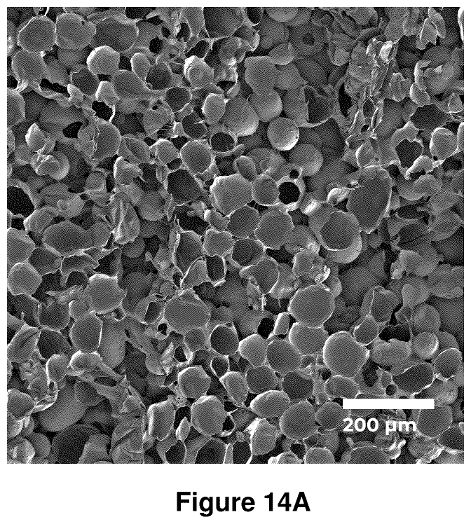

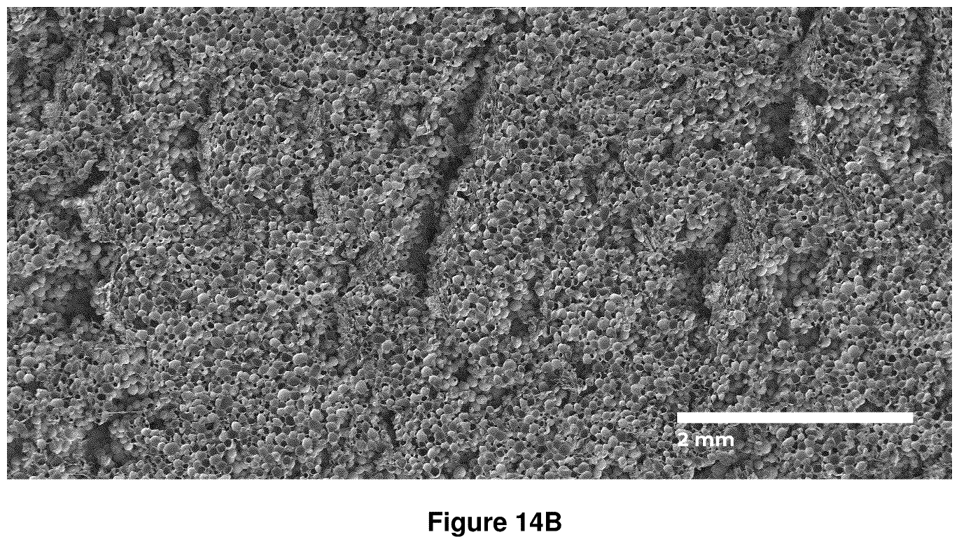

The printing process caused lots of ruptures due to very low strength of the deposition material. FIGS. 14A and 14B are SEM images of cross-sections of the resulting cuboid. FIG. 14A shows a vertical cross-section of the cuboid. FIG. 14B shows a horizontal cross-section of the cuboid. FIGS. 14A and 14B show a closed cell foam with ruptures and collapsed cells. The average cell size was 60 microns and a maximum cell size was approximately 200 microns. Density of the resulting cuboid was 0.11 g/cc giving a relative density of 0.09, and cell density was approximately 8×10⁶ cells/cc.

### Example 14, Insufficient Mixing Due to Low Rotational Speed of the Independent Mixing Rotor

Coated Granules Comprising a Core of Base Polymer (Desmopan EC33085AU, Covestro AG, Germany) and a coated shell, the shell substantially encapsulating the core and comprising a binder system (Dispurez 201, Incorez Ltd, England) and expandable microspheres (Advancell 501 EM, Sekisui Chemical, Japan) were produced. A mass fraction of the expandable microspheres in the coated granules was 8 wt %. A mass fraction of the binder system (Dispurez 201, Incorez Ltd, England) in the foaming granules was 3.5 wt %. The coated granules were gravity-fed from the hopper of the screw to the extruder of Example 1. The temperature control unit 1 was set to maintain a temperature of 100 degrees Celsius. The temperature control unit 2 was set to maintain a temperature of 180 degrees Celsius measured at the end of the single screw extrusion stage. The temperature control unit 3 was set to maintain a temperature of 205 degrees Celsius measured at the middle of the mixing stage. The temperature control unit 4 was set to maintain a temperature of 220 degrees Celsius measured at the nozzle. A rectangular cuboid with dimensions 40×40×10 was printed at a deposition speed of 22.5 mm/s. Line width was 1.2 mm. Layer height was 0.5 mm. Accordingly, a volumetric flow rate was 0.81 cm³/min. The rotational speed of the screw was approximately 0.02 rps (revolutions per second) producing a mass flow rate of approximately 0.006 g/s. The rotational speed of the screw was too low to provide a sufficient mixing quality. The independent mixing rotor was rotating at a rotational speed of 0.3 rps (revolutions per second) which was not enough to produce a substantially homogeneous mixture.

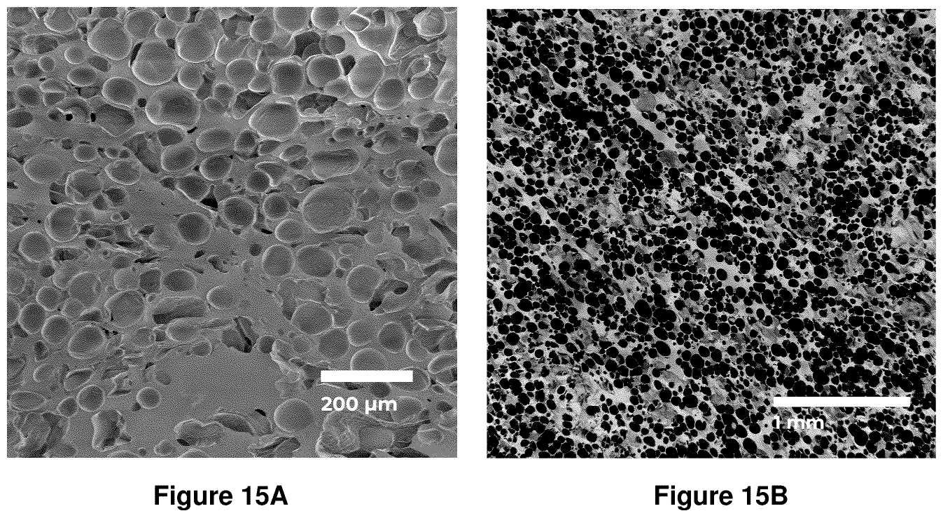

FIGS. 15A and 15B are SEM images of cross-sections of the resulting cuboid. FIG. 15A shows a vertical cross-section of the cuboid. FIG. 15B shows a horizontal cross-section of the cuboid. FIGS. 15A and 15B show a non-homogeneous closed cell foam with approximately 52 microns average cell size and with a maximum cell size of approximately 150 microns. Density of the resulting cuboid was 0.42 g/cc giving a relative density of 0.33, and cell density was approximately 9×10⁶ cells/cc.

### Example 15, 3D Printed Footwear Article from Low-Density TPU Foam

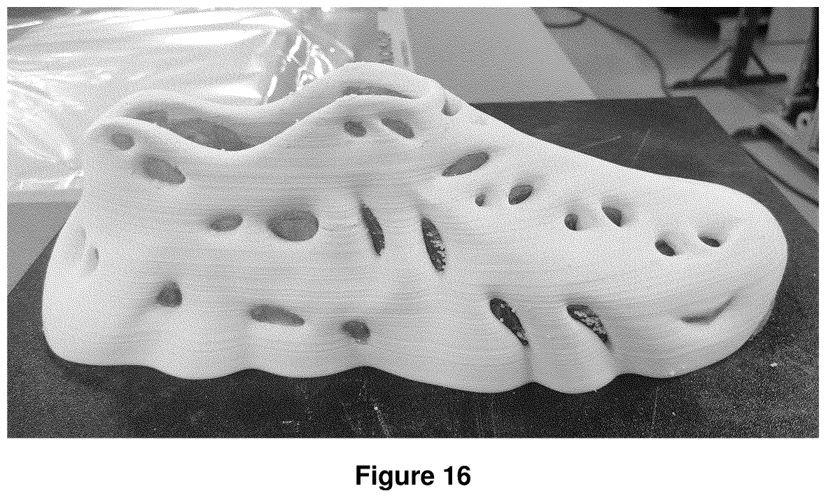

A footwear article—a single material shoe from TPU foam—was produced by FGF 3D printing from the coated granules using the system of FIG. 1 having the extruder of Example 1 and also a secondary granular extruder for depositing a support material (PVA). The coated granules comprised a core of base polymer (Desmopan 2590A, Covestro AG, Germany) and a coated shell, the shell substantially encapsulating the core and comprising a binder system (Dispurez 201, Incorez Ltd, England) and expandable microspheres (S2340, Kureha Corporation, Japan). A mass fraction of the expandable microspheres in the coated granules was 8 wt %. A mass fraction of the binder system (Dispurez 201, Incorez Ltd, England) in the foaming granules was 3.5 wt %. The deposition speed of the TPU foam was 45 mm/s. The line width was 1.4 mm. The layer height was 0.3 mm. Density of the footwear article was approximately 0.32 g/cc giving a relative density of approximately 0.26. FIG. 16 shows the footwear article.

What is claimed is:

1. A method for additive manufacturing of a three-dimensional object by sequentially depositing a plurality of layers, the method comprising:
providing at least one base polymer and at least one foaming agent, in the form of at least one feedstock material;
admixing the at least one base polymer and the at least one foaming agent by a rotating independent mixing rotor of an extruder to form a mixture comprising the at least one base polymer and the at least one foaming agent within a polymer processing space of the extruder;
activating the at least one foaming agent by heating the mixture within the polymer processing space of the extruder to a temperature exceeding the activation temperature of the foaming agent, thereby producing a polymeric foam; and
extruding the polymeric foam through an outlet of the extruder and depositing the extruded polymeric foam on a deposition surface to form a layer of the three-dimensional object;
wherein the independent mixing rotor operates independently and the rotational speed of the independent mixing rotor is higher than 0.3 revolutions per second;
wherein the at least one foaming agent that is activated is selected from a group consisting of: thermally expandable microspheres, chemical blowing agent; and
provided in the form of the at least one feedstock material selected from a group consisting of: foaming granules, masterbatch granules, and masterbatch filament.

2. The method as in claim 1, wherein the base polymer is selected from a group consisting of: thermoplastic polyurethane, thermoplastic polyether block amide.

3. The method as in claim 1, wherein the rotational speed of the independent mixing rotor is lower than 120 revolutions per second.

4. The method as in claim 1, wherein the at least one selected foaming agent that is activated is thermally expandable microspheres.

5. The method as in claim 4, wherein a mass fraction of the expandable microspheres in the mixture is no more than 25 wt %.

6. The method as in claim 1, wherein the at least one selected foaming agent that is activated is a chemical blowing agent emitting gas at decomposition temperature.

7. The method as in claim 1, wherein the independent mixing rotor is rotatably mounted within a mixing chamber.

8. The method as in claim 7, wherein at least one stream of the at least one feedstock material in a downstream direction towards the mixing chamber is established by at least one pressure-generating mechanism of the extruder.

9. The method as in claim 8, wherein a fluid phase of the at least one stream comprising the base polymer is established by melting the base polymer with temperature controls units thermally coupled to the polymer processing space of the extruder.

10. The method as in claim 9, wherein the at least one foaming agent is admixed with the fluid phase by the rotating independent mixing rotor within the mixing chamber to form a stream of the mixture.

11. The method as in claim 1, wherein the at least one selected foaming agent that is activated is provided in the form of the foaming granules comprising a core and a shell at least partially encapsulating the core.

12. The method as in claim 11, wherein the core comprises the at least one base polymer and the shell comprises a carrier material and the foaming agent dispersed in the carrier material.

13. The method as in claim 11, wherein the core comprises the at least one base polymer and the shell comprises the foaming agent in the form of solid particles and further comprises a binder system binding the particles to the core.

14. The method as in claim 1, wherein the masterbatch granules and the at least one feedstock material comprising the at least one base polymer are fed into separate inlets of the extruder, the at least one selected foaming agent that is activated is provided in the form of the masterbatch granules.

15. The method as in claim 1, wherein the masterbatch filament and the at least one feedstock material comprising the at least one base polymer are fed into separate inlets of the extruder, the at least one selected foaming agent that is activated is provided in the form of the masterbatch filament.

16. The method as in claim 1, wherein a relative density of the deposited polymeric foam is in a range from 0.09 to 0.56.

17. A method for additive manufacturing of an expanded three-dimensional object comprising a polymeric foam, the method comprising:
providing at least one base polymer and at least one foaming agent, in the form of at least one feedstock material;
admixing the at least one base polymer and the at least one foaming agent by a rotating independent mixing rotor of an extruder to form a mixture comprising the at least one base polymer and the at least one foaming agent within a polymer processing space of the extruder;
extruding the mixture through an outlet of the extruder and depositing the extruded mixture on a deposition surface to form a layer of an as-printed three-dimensional object;
sequentially depositing a plurality of layers to form the as-printed three-dimensional object; and
heating the as-printed three-dimensional object to activate the at least one foaming agent contained therein to volumetrically expand the as-printed three-dimensional object and form the polymeric foam therein, thereby producing the expanded three-dimensional object;
wherein the independent mixing rotor operates independently and the rotational speed of the independent mixing rotor is higher than 0.3 revolutions per second;
wherein the at least one foaming agent that is activated is selected from a group consisting of: thermally expandable microspheres, chemical blowing agent; and provided in the form of the at least one feedstock material selected from a group consisting of: foaming granules, masterbatch granules, and masterbatch filament.

18. The method as in claim 17, wherein the base polymer is selected from a group consisting of: thermoplastic polyurethane, thermoplastic polyamide, thermoplastic polyester, thermoplastic polyether block amide, a copolymer of at least one of these polymers.

19. The method as in claim 17, wherein the rotational speed of the independent mixing rotor is lower than 120 revolutions per second.

20. The method as in claim 17, where a ratio of the volumetric expansion is in a range from 1 to 8.
